(19) United States
(12) Patent Application Publication
(10) Pub. No.: US 2005/0227218 A1
(43) Pub. Date: Oct. 13, 2005

(54) Learning system based on metadata framework and indexed, distributed and fragmented content

(76) Inventors: Dinesh Mehta, Los Altos, CA (US); Narender Oruganti, Fremont, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/075,136

(22) Filed: Mar. 7, 2005

Related U.S. Application Data
(60) Provisional application No. 60/550,767, filed on Mar. 6, 2004.

(51) Int. Cl. G09B 3/00

(52) U.S. Cl. 434/350; 434/362

(57) ABSTRACT

A system and a method are disclosed for an system that includes a computer with a display unit running the client application software with attached plurality of capture devices for recording audio, video and snapshot (video or computer display monitor) content. A computer keyboard or a tablet is used to control the recording or snapshot of the dynamic classroom content. The client computer may be placed in a classroom and is connected via a network (Internet or LAN/WAN) to a server computer for publishing or remotely storing a “primitive” data session. The client software allows the authorized student or instructor to add additional static content, edit the consolidated content and publish the “primitive” or “organized” data session, which results in enhanced, collaborative content development.

### CROSS REFERENCE TO RELATED APPLICATIONS

This application claims priority under 35 USC § 119(e) to U.S. Provisional Patent Application No. 60/550,767, titled “Personalized Learning System Integrating Static, Dynamic and Collaborative Content”, filed Mar. 6, 2004, the contents of which are herein incorporated by reference.

### BACKGROUND OF THE INVENTION

1. Field of the Invention

The present invention relates to the field of learning, and more particularly, to integration of live classroom, computer based training, collaborative and any other environment where the content is created dynamically in a student-teacher environment. The present invention also relates to a personalized learning environment to accelerate learning, enable long term retention and provide for instant and easy recall based on indexes built during continuous review, annotation and association of content.

2. Description of the Related Art

The process of learning in a classroom, training session or a business meeting has historically involved listening to the instructor and group discussions, following the audio, video, textual (whiteboard or handout) material and taking handwritten notes or logging key points into a laptop or a digital personal device. The task of note taking takes attention away from the classroom activities. Follow-up study outside the classroom includes reviewing handouts and notes and studying recommended reference material.

An evolution of this process involves use of capture devices such as cameras, microphones, electronic whiteboards and computers to record the classroom content on digital media for later replay. Despite these advances, the adoption of these technologies as an effective tool for learning is still limited for reasons that, inter alia, include: (1) the digitally recorded storage is sequential in nature and playing back what a user is interested in reviewing requires tedious searching of the content; (2) there is a lack of an economical and easy to use solution that leverages these new technologies and provides a structured yet flexible infrastructure to build a custom learning environment that allows quick and efficient indexing of content captured in real time; (3) a lack of systems that parallel a human memory process of attention and selection, encoding, storing and recalling of information to create an effective learning environment.

Existing solutions lack dynamic user defined grouping mechanism for the content, thus restricting its usefulness to fixed or predefined indices. The user cannot group, associate, label and recall content from different time periods from a plurality of recorded content or from a single instance of recorded content. For example, if the user wanted connect an audio segment in the beginning to a segment later on in the recording which elaborated on what was said in the earlier segment, the user has only one choice make a second copy of the entire recording and delete all other content except what is needed.

### SUMMARY OF THE INVENTION

The present invention includes a system and a method for a comprehensive learning system that integrates capture of classroom instructional content (dynamic and static) with “any” other content accessible via a computer to provide a personalized environment that makes learning easy and effective. This system can be used in any environment such as schools, universities and corporations. For ease of discussion and understanding, the system disclosed herein also may be referred to as Eduti or EdUti.

In one embodiment, the system includes an instructor computer with a display unit running the client application software with attached plurality of capture devices for recording audio, video and snapshot (video or computer display monitor) content. The computer keyboard or a special tablet is used to control the recording or snapshot of the dynamic classroom content. This client computer is placed in the classroom and is connected via a network (Internet or LAN/WAN) to the server computer described below for publishing or remotely storing the “primitive” data session. Further, the client software allows the authorized student or instructor to add additional static content, edit the consolidated content and publish the “primitive” or “organized” data session.

Also includes, is a server computer with a display unit running the server application software that is used for storing the remote or published “primitive” and other user content. This computer makes any of the content available only to authorized users, and it is used for the administration of the clients (users of the system), software application, and all the connected instructor/student computers.

An embodiment of the present invention may include a plurality of user computers with a display unit running the client software with network (Internet or LAN/WAN) connections to the server computer to access and/or download any authorized “primitive” or other user content and to other user computers to collaborate on any authorized content. The user computers can optionally have audio and video capture devices to append additional user-defined content. The client software permits the student user to append, group, associate, annotate and collaborate on the “primitive” content.

In one embodiment, the present invention also includes software modules (or components) for use with the system. Components of the software include Login and ToolBox, Administration and Access, Multimedia and Computer data Capture, Session Navigator, Session Composer, Communicate and Collaborate and a suite of Productivity Tools such as Attach and Relate (Meta-Data), Search and Review and PlayList.

The Login and ToolBox is a module that executes on the client computers that serve instructors and students. Login and ToolBox enables the users to have a secure access to the applications and the content as well as to the rest of the user community that is authorized to use this system. User identifiers, passwords and groups that are initially set by a System Administrator, protect the entry to the system. This application also queries the system to authenticate the user with a specific computer and it also provides only those applications that the user is authorized for.

The Administration and Access is a module that enables an institution to setup an organizational specific hierarchical environment consisting of teachers, students, administrators, storage and computing resources and security. This module provides the functionality for an institution to create users, user profiles (students, teachers, administrators, etc.), named user groups based on any criteria (subject matter, products, processes, student hierarchy, etc.), named computer groups based on any criteria (classrooms, laboratories, subject matter, etc.) and application user groups. This module also provides the capability to set access and share control throughout the object categories (users, user groups, computers, computer groups and applications). A student may belong to more than one user group. A group may also be part of another group, e.g. a 9^{th} grade Science student may be part of group of students that are taking a college level course. The institution has the flexibility to create any structure that represents their organization and the user community in that organization. This access is made available to all the Eduti applications via Administration and Access API so that the specific application can make its specific data available based on the structure and access control set by the Administration and Access module.

Multimedia and Computer Data Capture is a module that enables automatic and intelligent capture of whiteboard, computer screen or any application screen on the computer, audio, video and other multimedia content created or discussed in the classroom for the purpose of subsequent access, update, search, annotation, recall and collaboration. The content is captured and stored in a way that enables rapid access to any small section of the content, permits annotation and allows building relationship among various sections of the content.

The Capture module is an application that interfaces with all the Eduti (system) applications to enable the user to automatically store the captured content in a pre-defined hierarchical context set by the user, or to accept and replay content that was previously stored and found by the user via Search and Review. Regardless of how the user gets to the content (navigation, search, attachment review, PlayList etc.), a simple double click or drag and drop allows the user to replay the content (or any of its fragments) just as it was initially consumed. The user can set the fragmentation criteria to any desired granularity (up to 1 second) which enables the used to annotate any part of the linear content that the user believes to be of interest in the future. Each fragment is individually identifiable to the creator and location so that the receiving users during collaboration can fetch it from any peer or central location.

All the simultaneously captured content is threaded and indexed by the Capture module in such a way that a replay makes the multitude of content available just as it was originally captured. For example during a replay of an audio, a snapshot of a whiteboard will appear during the discussion of the subject matter on the board, the screens on the computer will appear during the discussion that described the content on the computer screen. The Capture module also provides the capability for the user to fast forward, rewind, go to specific anchor points previously defined by the user, pause and replay the specified content at the user's discretion.

The Session Navigator is a module that provides the administrator, the students and the teachers with the ability to create a hierarchy of content containers called the sessions. A Session can contain any captured data along with all the attachments and grouping that a user might want to apply to organize and annotate the content for future review and recall. A Session also carries information that provides the user with the ability to navigate to its peers, parent and children Session nodes.

In one embodiment, an institution uses the sessions and the session hierarchy to represent the structure of its organization and the natural grouping of the content or the processes that get created dynamically. Consider a school with 9^{th}, 10^{th}, 11^{th}, and 12^{th} grade. The institution may want to create 4 session nodes named as with 9^{th}, 10^{th}, 11^{th}, and 12^{th} Under each node they may want to create further session nodes, each one of the representing a subject: 9^{th} Math, 9^{th} Physics, 9^{th} English etc. The content for each one of the categories can then be targeted to the specific node. A session may not have any content at all. It may simply be a placeholder in the hierarchy, 9^{th} for example is simply a placeholder for all the subject nodes, which in turn will hold the content.

It is noted that the institution has complete flexibility in the way they want to represent the hierarchy of container sessions. Similarly each student can be given a session node and then the student has the flexibility to create further hierarchy within his or her main session node. A complete environment can be created this way, where a user community can, create, review, annotate, public or private content, in public or private session environments.

The Session Navigator also provides the capability for the user community to share their content at the primitive level. For example, a user may have organized a number of objects, audio, video, snapshots, clips, URLs, desktop documents, etc., that the user considers to be the study material for a final exam. The user now has the ability to share this content with the peers as the user sees fit using the access control in the Session Navigator. Any collaborative additions can further be added by any of the users who share this content, essentially annotating and further developing the content, for a even richer future review and recall.

The Session Composer is a module that provides the student and teachers with the ability to efficiently organize the captured and other desktop content. Further, it provides the ability to decompose, reorganize, group and relate one or more content in any way. This enables the teachers and students to build a personalized learning environment similar to how different humans learn in order to accelerate learning and maximize retention and recall.

The Session Composer is essentially a tool that provides the user with ability to place the captured content from scratch or to edit and decompose previously captured content. The user has complete flexibility to cut, copy, paste group, annotate, and relate content from one or more sessions that the user has access to. The user also has the ability to either create a fresh copy of any object or simply maintain a reference to an object from any other session. This way all the users looking at a reference to an object can be assured that they are always looking at the most current update of the object.

As an example, if a user's session contains a reference to some training content of a process, all the changes made by the owner of this content will always be available to this user. If there is a change made to the process and the owner's session is updated with this change, then all sessions that refer to this content will automatically see this change in their own environment. A teacher can constantly add to the content in their own session and all the sessions of all students who have been given access to this teacher's content will always reflect the latest state. Homework, answers to the questions, clarifications of subject matter, auxiliary content in terms of references, web pages, documents etc. can be made available to all the students just by simply adding them to a session that all the students have access to and refer to. Students can further annotate this content by adding their own attachments, relationships and annotations (text/audio/video/documents/programs etc.) without having to create a duplicate of the original content.

The Session Composer module is completely interoperable with all the other Eduti (system) applications in that all the objects created and contained in the Session can be executed by simply double clicking on them. Multimedia objects get executed in the Capture application. Relationship details can be seen in the Attach and Relate module, all the desktop objects execute in their own application environment, Web based content or applications will execute in the default browser on the desktop.

The Communicate and Collaborate module provides content aware communications between and among students, teachers, parents and administrator and is based on popular instant messaging technology. The power of this module lies in its ability to intelligently embed classroom and any other desktop content captured using the Eduti suite of applications, in the instant messages. Additionally, the architectural features, such as peer to peer communications and recognition of common data, enable the use of bandwidth very efficiently.

The Communicate and Collaborate module provides the users with ability to have peer to peer as well as group communications. The tool recognizes the static groups of users created by the Admin and Access, and makes it available to all the users to quickly create sub-groups based on the criteria set by the institutions. The users also have the ability to create their own private groups for the purpose of communicating text as well as text embedded with any Eduti or desktop objects. All the desktop objects get encapsulated with the meta-data objects in Eduti, which as a result generates the capability of completely describing the object to the receiving entity.

Since each object in the domain of Eduti (the system in accordance with the present invention) can be uniquely identifiable, each client has the capability to check if received object or any part of it already exists in his or her own domain. If such is the case, then that object, in part or in full, is simply accessed locally, making bandwidth use very efficient. Even if the object is required to be fetched, a quick analysis is made to determine if less bandwidth would be required to fetch the object from one of the peers on the network. This process dramatically reduces the load on the remote server and communication becomes very efficient.

As an example, consider a couple of students who underwent the same training and have access to the same content at the teacher's session. They now want to discuss a material that was created in the classroom. Using the Communicate and Collaborate application one student embeds an audio fragment and a clip of the board that this student has a question on. When the other student receives this content embedded message, all that this student gets is a message with a number of content identifiers that uniquely identify the embedded content. At this point the receiving end recognizes that the content being referred to is already on the receiving machine and therefore there is no need to request this content either from the remote server or from the peer. Each student can review the material by simply executing it in the Communicate and Collaborate environment and the embedded objects get executed in their own environments (Multimedia Capture in this case).

It is noted that objects received via Communicate and Collaborate can further be saved in Sessions, annotated, organized, searched, etc. as any other object in the system.

Productivity Tools is a suite of modules that includes a set of productivity utilities such as Search and Review, Attach and Relate (Metadata), Playlist and Help modules. The Search and Review module provides the users with the ability to access any content, with or without a personalized annotation or tag, quickly and intuitively. The Attach and Relate module provides the capability to implicitly organize content by associating user-defined keywords and building of user defined relationships based on these keywords. Any of the content encapsulated in the Eduti applications can be organized in named Playlists to sequence and execute the content in a user-defined order.

Search and Review is a module that provides the user with the ability to create intuitive query templates using “What”, “Where” and “How” placeholders. The user is provided with all the possible object types and their attributes in the “What” placeholder. Simple selection allows the user to pick the object/s and attributes that the user wants to find. The “Where” section allows the user to define a domain where the search is expected to be conducted. This includes a database domain, i.e. the users local repository, other user's repositories to which this user has access to (the user is presented with only those users to which this user has access to), and the remote database where all the published content resides. The “How” section provides the user with logical pruning criteria, which the user can use to define various permutations and combination to base the search on.

Using this mechanism of the Search and Review Module, a user can pre-define a number of query templates and then use them later by simply picking a template and populating it with data via simple drag and drop operations and text entry. Using this mechanism, the user can very quickly perform searches, for example, find Sessions containing “Differential Equations”, find objects relating to Differential Equations and Physics”, find all “Attachments” relating to “Thermodynamics”, find all “Relationships” to “Asian Art”, find “Math Homework” for Session “Week23”, or the like. In general, students can build any query using simple button clicks without having to understand the underlying structure of database structure and relationship attributes. The template building process automatically makes the illogical choices unavailable such that the resulting query from the user selections is always a valid query.

The Attach and Relate is a module (application) that provides the users with the ability to annotate any content that is encapsulated and stored in the context of Eduti applications. A user can simply drag and drop any desktop document or content on any object stored in a Session. The Attach and Relate application automatically determines the type of data being attached and creates an implicit binding between the source and the target object. With this mechanism a user can associate multiple heterogeneous objects (different types of objects) with any object in a session. By doing this a user can later recall a content that was consumed in a classroom and also view all the related content by simply navigating through a list of attachments.

As an example, let us say that a user consumed some physics content related to “Forces” in a Physics class. The audio, video, whiteboard snapshots and screenshots are already available to this user in the session. Using “Attach and Relate”, the user attaches documents that relate to homework with one or more objects in this session. Also, at some later time, while reviewing this content, the user navigates through the Internet and identifies a number of related content on some web pages. Simple drag and drop would allow the user to attach links to all these web pages with one or more objects in the session.

Thereafter, when the user visits this content in the Session, identified through navigation or through “Search and Review”, the user will fined all the related content in one place. The user may also have found the attached content by using “Search and Review”. Simple filters would give the user an access to all the objects that this attachment is attached to. One attachment could be attached to many objects or many attachments could be attached to one object. The user may find his or her way to an object or to an attachment by using the “Search and Review”.

The “Attach and Relate” module also provides a capability for a user to create ad hoc relationships by creating his own keywords and then attach one or more “relates” and “relating to” objects along with the keyword. This provides a very powerful mechanism for users to continue to create annotations and relationships and then later find what they are looking for by searching “whatever” that comes to mind. By using this mechanism, users can relate anything to anything and then find what they are looking for by searching for content relating to an object, a keyword or a phrase, or a keyword or a phrase in a relationship. The user also has the ability to directly annotating an object by associating a text or an audio message with any object. This allows the user to not only review notes attached to an object but it also provides the capability for a user to review any audio annotations with the objects stored in the session.

PlayList is a module that is another organization tool to provide the capability for the user to sequence and control the replay of any content. The content placed in the PlayList can be linear as well as non-linear. A user can, for example, create a list of an audio/video/snapshot object, followed by a Microsoft Word file followed by a number of users own audio annotations, followed by a number of text annotations. This is simply a list of objects. The user can control the execution of these objects (which do not have to be part of the same session) by setting the controls such that objects either execute in a sequence, or such that some of the objects execute in parallel with other objects in the list, or such that objects execute in some overlapped manner.

As an example, a user can set the control in a PlayList where a document executes in synchronization with some audio in the list and gives the control to the user to close it after the audio is complete. Another element (possibly audio) in the PlayList could be set to execute once the user closes the document. There may be another object (possibly another document) set to execute simultaneously with the second audio. The user has complete flexibility to create a sequence and execution order of objects that, when combined and executed together, creates a meaningful review content for the user. Such playlists can be named and also attached as annotations to any session or object in the session.

It is noted that in a preferred embodiment, all the modules described herein are configured to be tightly coupled. This advantageously allows for their seamless interoperability.

The present invention includes a number of benefits and advantages. For example, the present invention is configured to allow building of a comprehensive learning environment. Instructors and students are provided with a comprehensive tool to build an efficient and effective learning environment. In particular, the present invention includes tools for the capture of dynamic and static content in one integrated application, as well as composition of consolidated content with powerful editing tools to add, delete, append, group, associate and annotate content. Using these tools, an instructor can build a customized and enriched classroom session. A student user can access, organize and replay the published content and build a custom learning environment. Using the powerful functionality in the system, a student user can add, group, associate and create custom sessions for easy recall and effective learning. A student user can collaborate with other student users or the instructor by sharing custom content (existing or new) to enhance and expand the learning experience. These collaborative sessions can be selectively captured, annotated and linked to existing content for future recall.

The present invention also advantageously allows for selecting (or choosing) only the minimum level of detail necessary. For example, a system may be configured to provide a user (student or instructor) an ability to pick only the fragment (s) of the recorded audio or video content. This selected fragment (s) can then be optionally grouped or associated with other content, annotated and stored for later recall and replay. This feature is made possible because of the structure provided by our system-fragmenting and storing content in small “Bites”.

The present invention benefically allows for creating a powerful learning environment. Using the meta-data framework, a user can build a hierarchical super-structure of attachments and relationships (meta-data) on top of the primitive data. These structures allow a user to use multiple groupings, annotations and associations across all the content. For example, a student user can associate and custom annotate the content from a math class like “Linear Equations” to content in a Physics class on “Newton's laws of motion”. This way, the student user can review these topics while studying either of the two subjects.

The present invention also beneficially allows for creating a system that parallels human memory processes. For example, by allowing user to build a custom learning environment, learning is made easy and natural. A human memory process involves attention and selection, encoding, storing and recalling of information. By providing the ability to parallel this natural process, a student user can make learning very effective. Some key recommended tasks to enhance long term memory include, recalling the classroom content; adding custom audio, images, text annotations, and other content; linking, grouping and associating various content; collaborating with peers and instructor and building custom indices to the content for easy recall All these tasks add up to building a natural learning environment.

The present invention includes benefits such as allowing building of an efficient collaborative environment through removal of redundant data by using unique global identification system for the content, communicating content among student users involves transmitting only the incremental data identifiers. This makes collaboration very efficient and effective. This solution takes advantage of the fact that communicating parties either already posses a copy of the original content, or that the content can be fetched from a central storage place, or from any one or more peers that have the content based on similar structure via peer to peer communication.

The present invention beneficially makes searching natural and quick by allowing users (student or instructor) to build multiple meta-data superstructures and by using dynamic indexing, users can quickly search and locate content. In addition, the present invention advantageously makes learning portable by allowing users to save their custom sessions on remote servers, the student user can save the content on any digital media: a remote storage that can be accessed via the Internet or on any portable media such as a CD-ROM. The student user can play back these saved sessions using a computer or an audio CD-Player for audio sections of the session. Thus it is possible for the student user to learn while travelling or during an exercise activity like jogging. Further, by providing access to student users over the network, it is possible for a student user to review any previous or missed class sessions.

The present invention also beneficially builds a library of historical content. As the content is available on a digital storage media, a school or a university or a corporation can build a library of classes or training sessions and make it available for future use. Since the content is captured, stored, organized and annotated in fragments, the users have the ability to go back to previously captured content and augment any parts that may have become obsolete. This is particularly helpful in business logic and processes where parts of the logic require a change because of evolving nature of the product. The trainers and the trainees can use this tool very effectively to identify and learn any changes in the content that they would have created or consumed previously.

The present invention advantageously builds a simple and affordable infrastructure. As the system uses simple off-the-shelf equipment like a camera (CCTV or Digital) and a microphone along with our software, it is easy and economical to widely deploy the solution. Automatic screen captures embedded with the audio and whiteboard snapshots provide the capability to capture every aspect of computer based training without incurring any additional costs.

The present invention is also advantageously customizes content for selected groups. An instructor can customize content by appending and grouping appropriate content for selected groups of student users. For example, for weaker students, the instructor may add tutorials and special assignments and group them with the original classroom content and save it as a separate session or make them available to all students.

The present invention also eliminates duplicate content. Users can build multiple groups, associations, indexes and sessions on a single copy of the primitive data. There is no duplication of content resulting in very efficient use of storage resources. This is accomplished by using the meta-data framework and by the use of unique global identification of the stored “Bites” of audio and video content.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. (“FIG.”) 1 describes a typical hardware configuration for running a system (Eduti or EdUti) in accordance with the present invention. The Figure includes an embodiment of a computer architecture of a client with attached peripherals and the external connectivity to the server subsystem and to the network attached storage devices.

FIG. 2 describes the software subsystems of the EdUti system and their inter-connectivity.

FIG. 3 describes the EdUti system architecture. It illustrates the logical relationship among all the EdUti subsystems.

FIG. 4 shows the Architecture and Interface of the Login and ToolBox subsystem. It describes the Login and ToolBox subsystem start up, operation and interaction with other EdUti subsystems.

FIGS. 5, 6, 7, 8 and 9 describe the commands for Login and ToolBox subsystem and its interaction with other subsystems. The Login and ToolBox subsystem commands enable starting up and closing of all EdUti subsystems and services, setting up and administration of EdUti system and hardware resources, enables connectivity, login and authentication of users and provides monitoring capabilities for all EdUti subsystems and services.

FIG. 10 shows the Architecture and Interface of the Capture subsystem. It describes the Capture subsystem start up, operation and interaction with other EdUti subsystems.

FIGS. 11, 12, 13, 14 15 and 16 describe the commands for the Capture subsystem. The Capture subsystem commands enable setup, configuration, control, execution and monitoring of all multimedia devices including audio, video and Electronic Board and, setup, configuration and management of captured content including drag and drop multimedia content from the desktop, internet or other EdUti subsystems.

FIG. 17 shows the Architecture and Interface of the Compose subsystem. It describes the Compose subsystem start up, operation and interaction with other EdUti subsystems.

FIGS. 18, 19, 20, 21, 22 and 23 describe the commands for the Compose subsystem. The Compose subsystem commands enable creation, storing, representing, displaying, editing, organizing, executing and navigation and review of multimedia content including drag and drop content from the desktop, internet or other EdUti subsystems.

FIG. 24 shows the Architecture and Interface of the PlayList subsystem. It describes the PlayList subsystem start up, operation and interaction with other EdUti subsystems.

FIGS. 25, 26, 27, 28, 29 and 30 describe the commands for the PlayList subsystem. The PlayList subsystem commands enable setup, creation, storing, editing, displaying and execution of PlayLists containing all EdUti subsystem content only or a combination EdUti subsystems content and drag and drop content from the desktop and internet content.

FIG. 31 shows the Architecture and Interface of the Admin and Access subsystem. It describes the Admin and Access subsystem start up, operation and interaction with other EdUti subsystems.

FIGS. 32, 33, 34, 35 and 36 describe the commands for the Admin and Access subsystem. The Admin and Access subsystem commands enable setup, creation, editing and storage of user, user groups, machine and machine groups and provide access control based on the profiles created for users and machines.

FIG. 37 shows the Architecture and Interface of the Attach and Relate subsystem. It describes the Attach and Relate subsystem start up, operation and interaction with other EdUti subsystems.

FIGS. 38, 39, 40, 41, 42 and 43 describe the commands for the Attach and Relate subsystem. The Attach and Relate subsystem commands enable creation, editing, displaying, storage and execution of attachments, keywords, relationships and relationship instances for all EdUti content and drag and drop content from the desktop and the Internet.

FIG. 44 shows the Architecture and Interface of the Search and Review subsystem. It describes the Search and Review subsystem start up, operation and interaction with other EdUti subsystems.

FIGS. 45, 46, 47, 48, 49 and 50 describe the commands for the Search and Review subsystem. The Search and Review subsystem commands enable setup, creation, editing, storage, display and execution of queries and their results. Additionally, these commands also enable drag and drop of EdUti objects and objects resulting from queries into a new or existing queries.

FIGS. 51 and 52 show the Architecture and Interface of the Communicate and Collaborate subsystem. It describes the Communicate and Collaborate subsystem start up, operation and interaction with other EdUti subsystems.

FIG. 53 shows the Architecture and Interface of the Client of Communicate and Collaborate subsystem. It describes the Client subsystem start up, operation and interaction with other EdUti subsystems.

FIGS. 54, 55, 56, 57, 58 and 59 describe the commands for Communicate and Collaborate subsystems.

The FIG. 60 describes the Communicate and Collaborate Server Commands and Fulfillment.

The FIG. 61 shows the Architecture and Interface of the Session Navigator subsystem. It describes the Session Navigator subsystem start up, operation and interaction with other EdUti subsystems.

The FIGS. 62, 63, 64, 65, 66 and 67 describe the commands for the Session Navigator subsystem. The Session Navigator subsystem commands enable setup, creation, deletion and manipulation of Sessions that provide the mechanism to organize, relate and recall the content.

### DETAILED DESCRIPTION OF THE PREFERRED EMBODIMENTS

The Figures (“FIG.”) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The following is a detailed description of the hardware configuration, architecture, applications, processes, work flow and user interfaces of the modules that make the EdUti system or suite of applications.

Hardware Configuration

FIG. 1 describes the hardware required for running the EdUti software. The basic hardware required is similar to a traditional personal computer as illustrated in the section (1.40), along with external subsystems as denoted by section (1.42). The personal computer component as denoted by (1.40) consists of a Bus (1.26) that connects internal components and external devices. The internal components include a Processor (1.20), Internal Memory (1.14) and Internal Storage (1.18). The external components include Device Display (1.12), Pointing Device (1.16), Keyboard (1.22), Modem or Network Interface (1.24), Control Tablet (1.28), Audio Devices (1.30), Video Devices (1.32) and E-Board Devices (1.34).

A classroom presentation, discussion or personal dialog is captured using an Audio (1.30) and Video (1.32) and Display (1.12) devices using, either the Keyboard (1.22) or a Pointing Device (1.16) or the Control Tablet (1.28). The personal computer components like the Processor (1.20) and Internal Memory (1.14) working in conjunction process and store the captured content in the Internal Storage (1.18). The EdUti software along with operating system software of the personal computer enables this process of capture and storage.

The captured content can then be transferred to subsystems in section (1.42) that includes the Server Sub-System (1.36) and Network Storage (1.38) using a Modem or Network Interface Device (1.24). The Server Subsystem is similar to a personal computer (1.40). The Network Storage (1.38) is a storage device that can store data and is accessible over a network like a LAN/WAN or Internet.

The transferred or additional content on Server Sub-System (1.36) can be communicated back to the personal computer (1.40).

Client and Server Subsystems

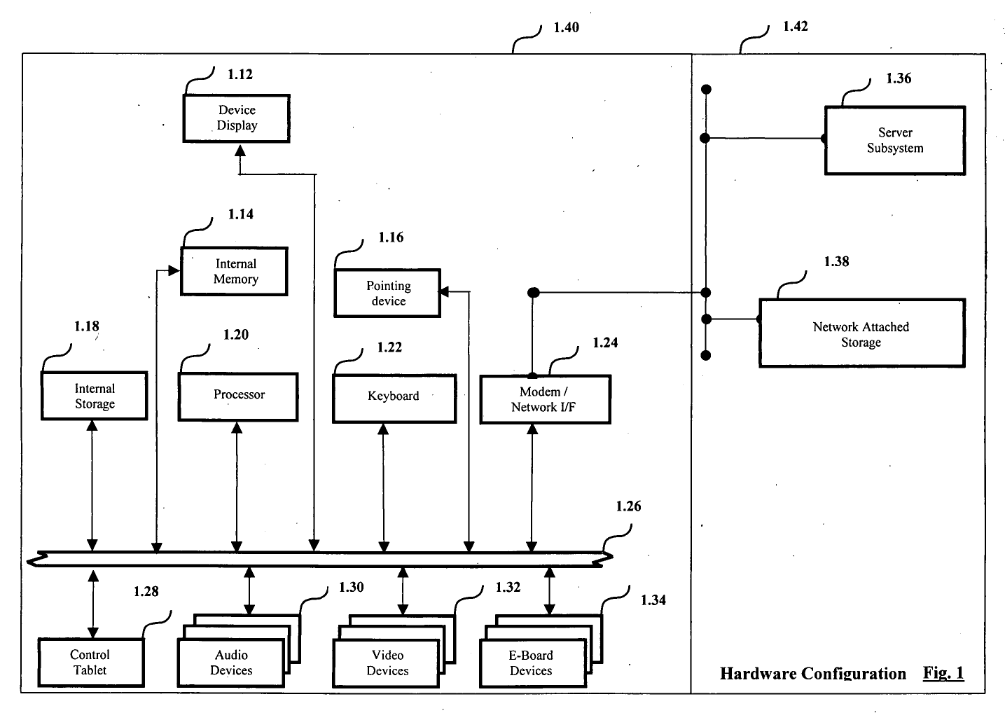

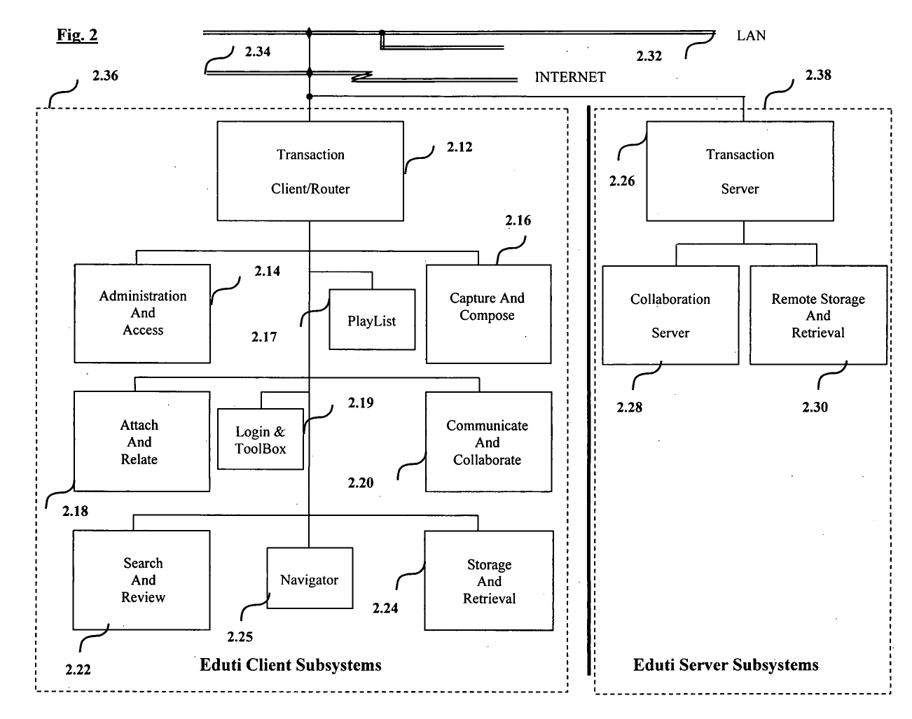

FIG. 2 describes an EdUti Client and Server software Components. EdUti Client Sub-System denoted as (2.36) consists of Transaction Client and Router (2.12), Administration and Access module (2.14), Capture and Compose module (2.16), Playlist module (2.17), Attach and Relate module (2.18), Login an ToolBox module (2.19), Communicate and Collaborate module (2.20), Search and Review module (2.22), Storage and Retrieval module (2.24) and Session Navigator (2.25). The EdUti Server Sub-System denoted by (2.38) consists of Transaction Server (2.26), Communicate and Collaborate Server (2.28) and Remote Storage and Retrieval System (2.30). The Client and Server Sub-Systems are inter-connected by either a LAN (2.32) or the Internet (2.34).

The Transaction Client and the Router (2.12) acts as a gateway for communication between all the applications on the Client Sub-system (2.36) and it also communicates with the Transaction Server (2.26) for all communication between the Communicate and Collaborate Server (2.28) and the Remote Storage and Retrieval system (2.30). The communication between the Client and the Server software components are enabled seamlessly over a LAN/WAN network (2.32) and the Internet (2.34).

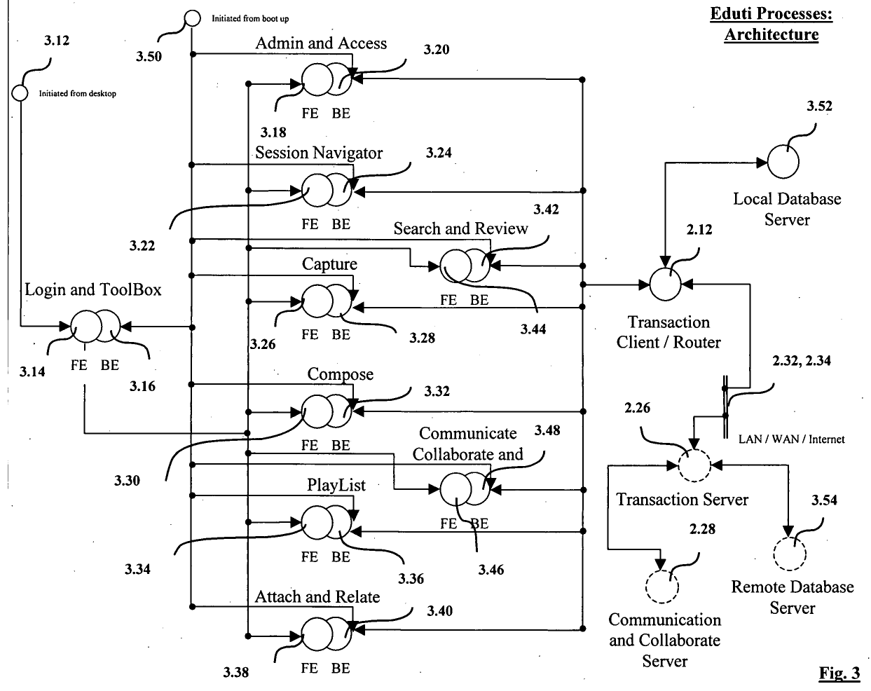

Eduti Process Architecture (FIG. 3)

FIG. 3 describes the client server architecture of the entire suite of EdUti applications, including a process breakdown of the applications that operate within the client subsystems. Each application is made up of Front End modules and Back End modules (3.14, 3.16, 3.18, 3.20, 3.22, 3.24, 3.26, 3.28, 3.30, 3.32, 3.34, 3.36, 3.38, 3.40, 3.42, 3.44, 3.46, 3.48). The Front-End modules (3.14, 3.18, 3.22, 3.26, 3.30, 3.34, 3.38, 3.42, 3.46) address the user interface functionality of the application and the Back end modules (3.16, 3.20, 3.24, 3.28, 3.28, 3.32, 3.36, 3.40, 3.44, 3.48) address the business logic of the respective application. The Front-End modules and the Back End modules of each application communicate with each other via inter-process communication API that is shared by all the modules. The objects within the domain of each application are communicated across by serializing and de-serializing them using XML. A common Object API across all the applications allows all the applications to create, decipher and use all aspects of each object, regardless of whether the object is in the application's domain or not. Each application, using this common Object API, is able to determine the object's identifier, type, owner, parent, peer, executing application, and the transient owner.

Each application's Back End process is started at the system's boot time as a Service (3.50). This Service remains idle until called upon for an operation. The Front End of the Login and ToolBox application (3.14), which is an authentication gateway for the users, is started from the Desktop (3.12). Every other application's Front End is subsequently started by the ToolBox (3.16) of the Login and ToolBox application.

It is only the Back End of each application that communicates with each other. The only exception to this is a communication between the applications via Drag and Drop operations. In this case the Front Ends of the target and the source applications communicate with each other, gather the pertinent information and then pass this information on to their respective Back Ends. From this point on only the Back Ends communicate with each other and inform their Front Ends of any data and state that needs to be displayed to the user.

The Back Ends of each application communicate with each other via the Transaction Client/Router (2.12). Since each object can be identified via the object API, the Transaction Client/Router simply determines the responsible application for the object on which an operation is requested, and then routes the request to the Back End of the application identified by the object. This makes communication very efficient and provides a universal communication mechanism for any application to communicate with any other application.

The Transaction Client/Router is also responsible for communicating with the Local Database Server (3.52) and the remote Transaction Server (2.26). The Local Database Server is responsible for all the local storage and retrieval operations. The remote Transaction Server is responsible for handling all communications to the remote application server subsystem. It handles and routes “requests to and responses from” the Remote Database Server (3.54) and the Communication and Collaborate Server (2.28). The remote Transaction Server, the Communication and Collaborate Server, and the Remote Database Server run on a machine that can be identified by static IP address. In such a case the Transaction Client/Router can communicate with the Transaction Server, regardless of whether the computers on a LAN/WAN/Internet (2.32, 2.34).

The object identifiers are structured in such a way that they are guaranteed to be unique as well as uniquely identifiable to “a user and a machine” on the network. The Transaction Clients and the Transaction Server constantly communicate to determine the location and the fastest route to fetch a reference object required in any communication.

Login and ToolBox

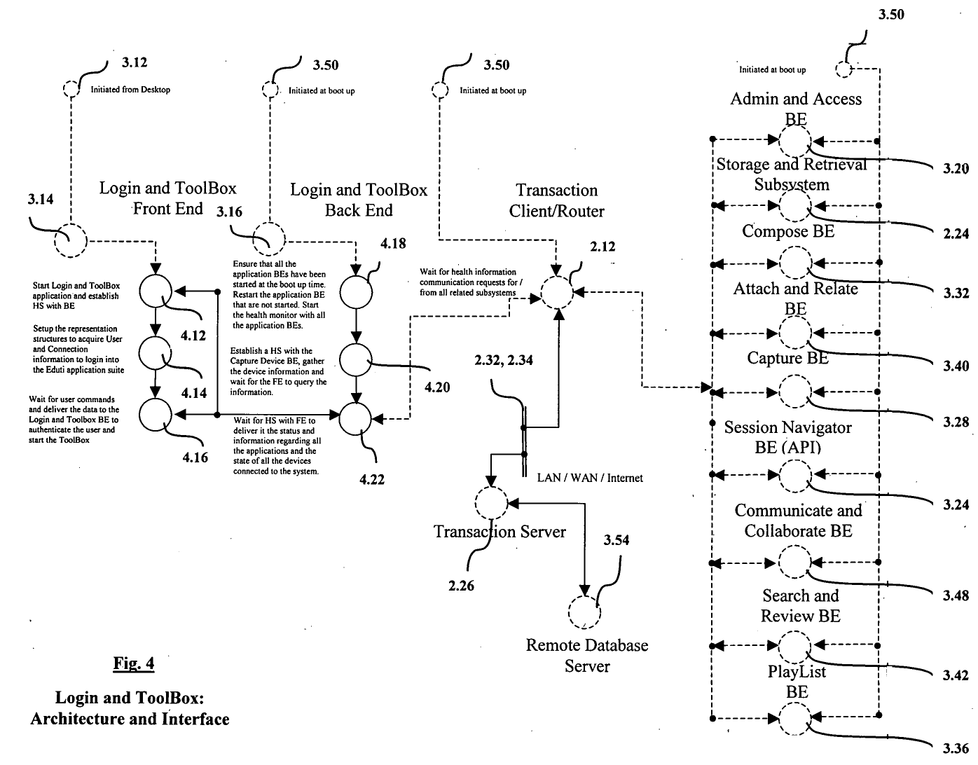

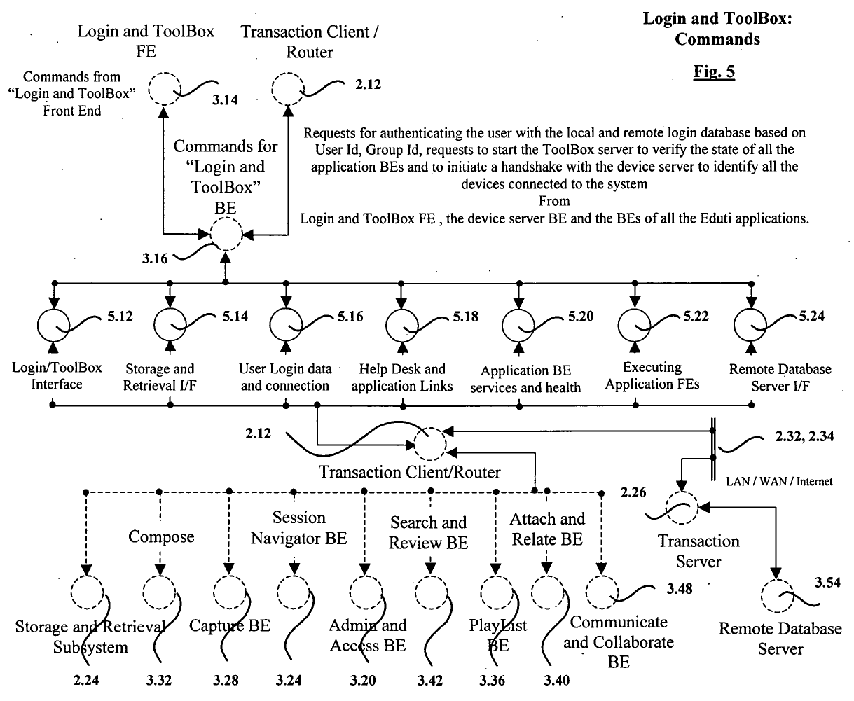

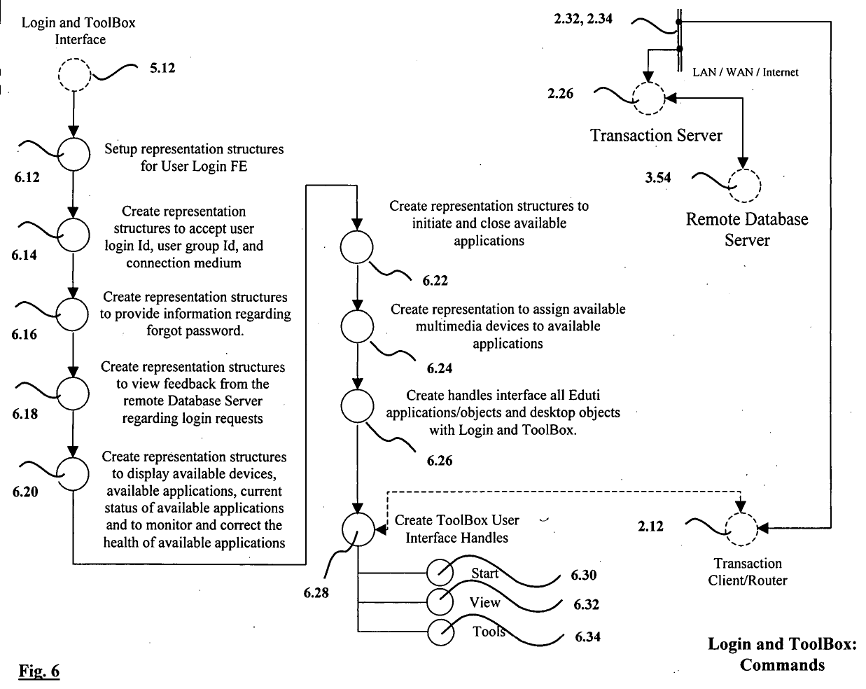

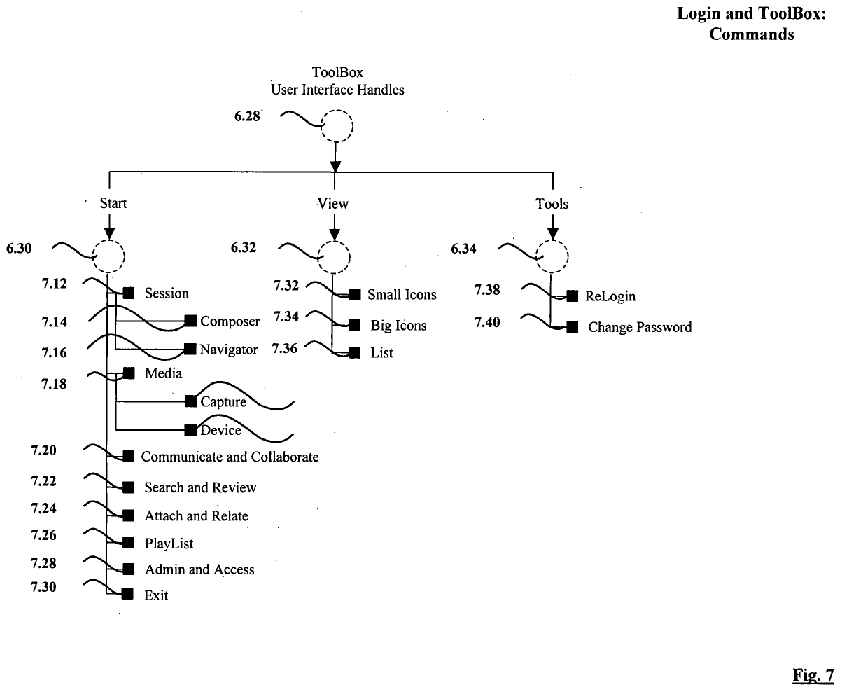

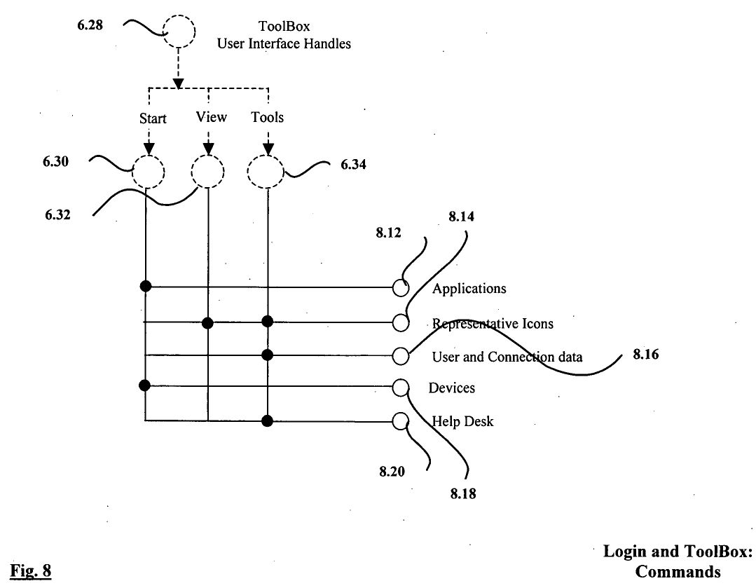

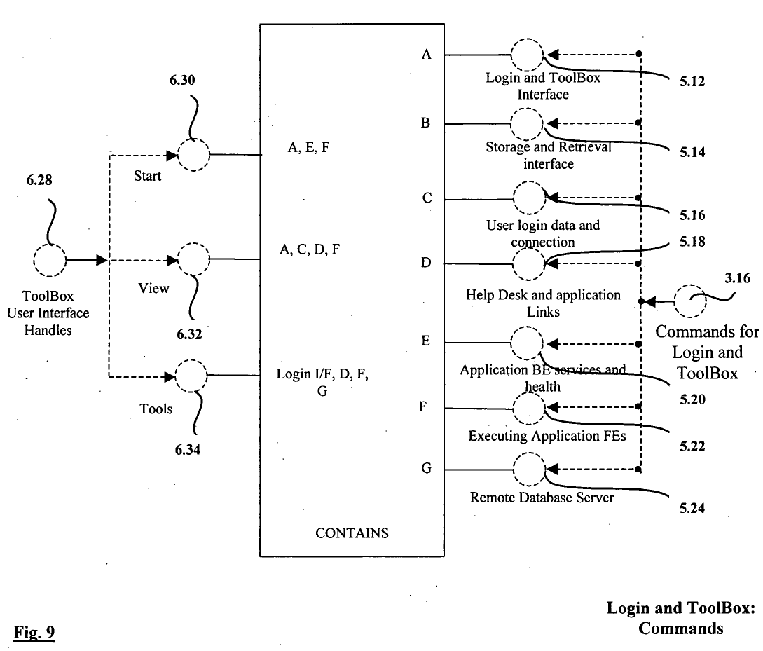

FIGS. 4 through 9 describe the client server architecture and the functional implementation of the Login and ToolBox application. These figures also describe the commands and the operational flow of the functionality of the Login and ToolBox application. The Login and ToolBox applications and their respective modules are logically broken into client side modules and server side modules. The client side modules address the user interface functionality of the Login and ToolBox application and the server side modules address the business logic of the Login and ToolBox application.

The Login and ToolBox application Front End (the client side modules) is started from the desktop. The Back End of the Login and ToolBox application (the server side modules) is started at the bootup time of the client PC along with the back ends of all other applications that comprise the Eduti suite of applications.

The Front-End modules of the Login and ToolBox application, at the beginning establish a handshake with the Back-End modules of the Login and ToolBox application. Following this process these modules set up all the user interface representation structures to acquire information required to authenticate a valid user within a community of users setup by the administrator using the “Admin and Access” application. Part of this Front End functionality is to set up user information representation structures to gather connection related data including transport medium (modem, dsl, etc), the user group identifiers that this user wants to be a part of while connecting, and whether the user intends to Login to the remote server or to the local server.

Once the user interface is up and running, displaying the user interface widgets required to collect the Login information, the Front-End modules waits in a steady state for the user to enter the required data and to initiate a Login with the remote or the local server. Once the user initiates the Login, the Front-End modules begin the process of communicating the user data to the Back-End of the Login and ToolBox application and wait for any responses from these modules.

The Back-End of the Login and ToolBox application, at its startup, first checks to ensure that the Back-Ends of all the other applications that comprise the Eduti suite have been started and that they are in a valid state. If any of the Back-End processes of any application seems out of order, the Login and ToolBox application Back-End makes an attempt to restart that specific Back-End before coming into a steady state for itself. The Login and ToolBox application Back-End then establishes a handshake with the Capture Device application Back-End to gather the properties of the devices that are connected to the Eduti client PC. It then waits for the ToolBox application Front-End to request such information after a successful Login by the user.

Finally the Login and ToolBox application Back-End waits for a handshake request from the Login and ToolBox Front-End to deliver it the status, device information and other user related information. The Login and ToolBox application Back-End also waits for any commands that are delivered to it from the Transaction Client/Router. Following each such request or command, either by the Login and ToolBox Front-End or by the Transaction Client/Router, it attempts to fullfill such request and then goes back into a wait state for subsequent request or command.

The Login and ToolBox application Back-End communicates with the following applications via the Transaction Client/Router: Admin and Access Back-End to fetch and save data related to the users, machines, applications and other such resources; The Storage and Retrieval Subsystem to gather the persistent data either on the local client machine or on the remote database on the Storage Server; The Compose application Back-End to deliver it user and access attributes; The Attach and Relate application Back-End to deliver it user and access attributes; The Capture application Back-End to deliver it user and access attributes; The Session Navigator application Back-End to deliver it user and access attributes; The Communicate and Collaborate application Back-End to deliver it user and access attributes; The Search and Review application Back-End to deliver it user and access attributes; The Playlist application Back-End to deliver it user and access attributes.

The Login and ToolBox application Back-End also communicates with the Remote Database Server via the Transaction Client/Router and the Transaction Server. This communication is to accomplish the functionality where the user logs into the remote database and all or part of the functional objects and their respective data reside on the Remote Server. The commands delivered by the Login and ToolBox application Front-End and the commands executed by the Login and ToolBox application Back-End are categorized as described below.

Login/ToolBox Interface: These commands are to build the entire user interface related representation structures, the layout and the distribution of user interface widgets for user input and feedback. The include menubars and its components, user data, user group and connection related information, the device status and configuration links, the application icons to enable their respective execution and status and user feedback.

Storage and Retrieval Interface: These commands are to store and retrieve user profile (user login group, password and identification data), initial and changes to the information regarding the devices that are connected to the Client PC and their relationship with the applications authorized to the logged in user.

User Login Data and Connection: These commands are related to acquiring, packetizing (serializing) and delivering the user login and connection related data to the Login and ToolBox application Back-End.

Help Desk and Application Links: These commands are related to setting up Internet links to Eduti Help Desk and Eduti application specific Web pages.

Application Backend Services and Health: These commands are setup in the Login and ToolBox application Back-End to monitor the health and status of the Back-Ends of all the Eduti applications that are running on the Client PC. A handshake and trigger mechanism is maintained between all the Eduti application Back-Ends with the Login and ToolBox application Back-End. If such a handshake is broken or the health of any of the Eduti application is noted to be in trouble, the Login and ToolBox application Back-End takes a corrective action, including shuting and restarting the respective application Back-End.

Execution of Application Front-Ends (User Interfaces): These commands are set up to execute specific application Front-Ends based on the application icons that are displayed in the Login and ToolBox application Front-End. These commands also interface with the functionality that monitors the health of each application and display the appropriate status with the respective application icon. Each application can be started and shutdown using these commands. The Login and ToolBox application Front-End and Back-End commands maintain an interface with each application and allow them to be shutdown only if the status of each of the applciation permits it to do so.

Remote Database Server Interface: Commands are set up in the Login and ToolBox application Back-End to interface with either the local database on the user's Client PC or with the remote database on the remote server. Based on the login criteria, the Login and ToolBox application Front-End requests an interface with either the local database or with the remite database. The Remote Database Server I/F commands and responses are communicated to and received from the Remote Database Server via the Transaction Client/Router and the Transaction Server.

The primary commands in the Login and ToolBox application Front-End, grouped in the menubar and in the popu menu window, are start, view and tools. Each is further described below.

Start/Session: The Start commands are primarily to execute and terminate specific applications in the Eduti suite of applications. The applications grouped under “Start/Session” are Session Composer and the “Session Navigator”. The user is able to start and stop the session Composer and the Session Navigator from here. The user can also perform the same operation from the respective application Icons in the Login and ToolBox application window.

The Session Composer is an application that provides the user with an ability to receive, organize, annotate, group, relate and execute multimedia and desktop objects that have been captured either using the Capture application or desktop objects from the user's or any peer user's desktop.

The Session Navigator is an application that provides the user with an ability to create and navigate the session hierarchy. The session hierarchy is made up of sessions organized in any hierarchy determined by this user, the administrator or any other user in the system. In addition to navigation and creation of Sessions, the user can also annotate each or a group of sessions, relate sessions according to any criteria determined by the user and execute the sessions to view and edit the contents contained in them.

Start/Media: The Media item in the start menu encapsulates the Capture and the Device applications. The user may start the Capture application or the Device application from here. The Device application provides the user with the functionality to identify all the multimedia devices (e.g. audio, video, touch tablets.) connected to the computer. It enables the user to set and change any attributes related to the devices. The device application also provides the user with the functionality to relate and associate any of the devices with any of the applications in the Eduti suite that make use of a multimedia device. For example a user may select one of many cameras attached to the Client PC as a video source to the Capture application. The user may associate another camera with the Communicate and Collaborate application to be used during a dialog with another user.

The Capture application provides the user with the functionality to every aspect of content that is created dynamically in a classromm session. The user can capture audio, video, whiteboard snapshots, a flow of operations on a computer etc. This can be done individually on together synchronized with time.

Start/Search and Review: The Search and Review application provide the user with an ability to search any of the multimedia or desktop obects saved in a Session. This session may be stored in the user's local database or in the user's remote database or in any database of another user who has given a read privilege to this user. In addition to multimedia and desktop objects, this application can be used to search annotations, relationships, sessions, playlists in order to finally find the object that the user may be looking for.

Start/Attach and Relate: The user may start the Attach and Relate application from here. The purpose of the Attach snd Relate application is to provide the user with an ability to annotate any object that is captured, organized and saved in a Session. The attachment operation refers to associating any object with an object that is to be annotated. The associated object could be any object (including an annotation) created in the Eduti application or any object that is on the desktop. The associated object could also be any text or an audio comment made by the user. This provides a mechanism for a user to attach comments, multimedia or desktop object with an object that he wants to annotate with the purpose of being able to find that object at a later stage by searching for “whatever comes to mind” regarding that object.

The user may also create relationships between one or more objects based on keywords or descriptions created by the user. This provides additional ability to search and look for an object based on relationship with another object. This functionality provides the capability to save, associate and relate objects in a similar manner as humans do in order to be able to recall them at a later stage. There are no restrictions in terms of which objects can be annotated or related. This process over a period of time can lead to a rich set of associations and relationships making subsequent recall and retention efficient and very effective.

Start/PlayList: The Start PlayList comand initiates the Front-End of the PlayList application. The PlayList application provides the user with the ability to further organize any set of fragments of multimedia and desktop objects captured in Sessions in order to replay them in any order, sequence and relationship set by the user. This allows the user to pick and organise fragments of any content from any session or desktop and set controls in such a way that these contents can be replayed in an order and sequence set by the user. Using this tool the user can simply drag and drop pieces of content and organise and replay them as and when the user sees fit in order to enhance the user's ability to retain and recall content that the users feels is important to remember. The user may create any number of such playlists and use them as attachments to any content or its fragment. These playlists as well as the objects they are attached to can also be searched using the Search and Review application.

Start/Admin and Access: The Start Admin and Access command initiates the Front-End of the Admin and Access application. This application is primarily used by an administrator to initially setup the environment of users (including teachers, students, subject matter, breakdown and association or sessions as they relate to contained content and time), applications, machines and devices as resources, access and content privileges. Once the initial setup is done and the accesses and privileges are assigned, the users of the Eduti suite of applications can subsequently enhance and edit this environment based on their access and privileges.

Exit: The Exit command provides the functionality to safely exit out of the Eduti suite of applications. This command interacts with all the open applications via the Transaction Client/Router and commands them to gracefully shutdown. If there are any applications that have data in a state that needs further input from the user, they inform the Login and ToolBox Back-End of such a state and the ToolBox application informs the user to take an appropriate action before shutting the Eduti application suite.

View/Small Icons, Big Icons, List: The View commands provide the users with the functionality to select the criteria by which the users can view the available applications in the Login and ToolBox user interface. The users may choose to view the sessions as Icons (small or big) or the users may choose to view the applications as a list.

Tools/ReLogin: The Tools/Relogin provides a shortcut functionality for the user to relogin into the EdUti Network. A user has the flexibility to log into the network as a plain user or as a user that is part of a user group with specific access and privileges. The Relogin provides a fast way for the user to shut the existing applications and relogin with the same or possibly a different user identifier within another user group.

Tools/Change Password: The Tools/Change Password provides the user with the functionality to change the password associated with the user identifier on the Remote Server. Once the changed password is accepted of the Remote Server, it is then synchronized with the Local Server on the Client PC. This allows the user to log into the local machine and use the Eduti applications, with the same (changed) password, without having to connect to the remote machine on the network.

The primary objects that the Login and ToolBox application operates on are as follows: Applications, Representative Icons, User and Connection Data, Multimedia devices, and Help Desk objects. The Start Menu functionality operates on the Applications represented by the Iocns, and on the Devices represented by their specific Icons in the ToolBox user interface of the Login and ToolBox application. The user may click on a specific application Icon to start the Front-End of that application or the user may start a specific application by selecting that application from the Start Menu Item.

The View Menu functionality operates primarily to describe the available applications and the conencted devices in the form of large or small representative Icons. The Tools Menu functionality is provided to start Eduti utilities, to allow the users to be able to describe the way they would prefer to be connected to the Internet and the Remote Transaction Server, the Remote Collaboration Server and the Remote Database Server of the Eduti applications. The Tools Menu also interacts with the Help Desk Links to provide the users with a mechanism to obtain help in using the Eduti applications as well as access to turorials that help the users to get proficient specific functionality of the Eduti applications.

The Start Menu functionality addresses the “Login and ToolBox Interface” to all the applications, maintains the health and status of the Back-Ends of all the Eduti Applications and provides the functionality to execute the Front-Ends (user interfaces) of all the Eduti applications.

The View Menu functionality addresses the user interface widgets for all the objects including User Login Data, Connection related data, the Help desk and Application link widgets and user interface widgets that display the current execution status of all the applications in the ToolBox window.

Capture Application

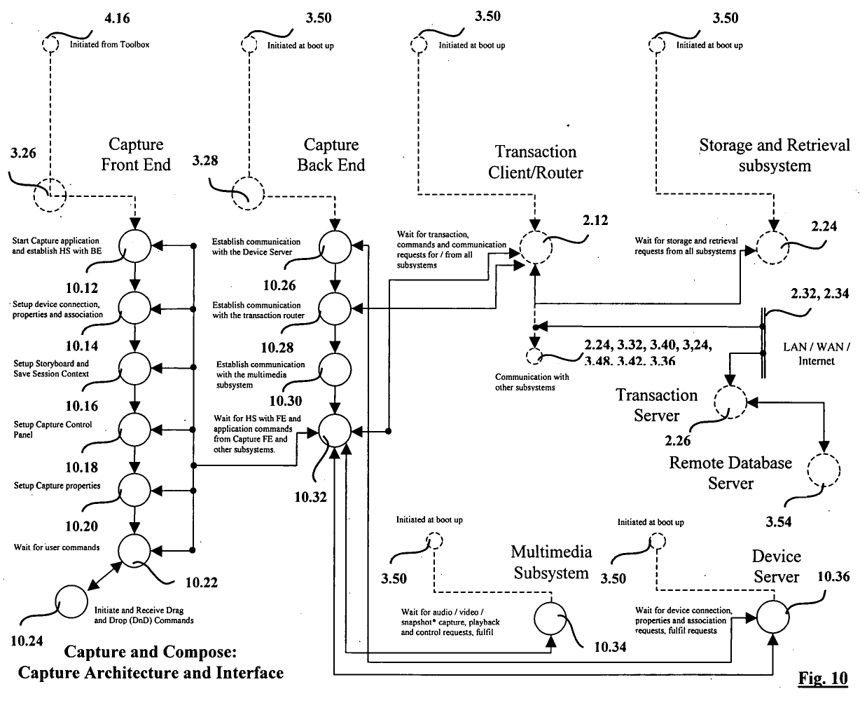

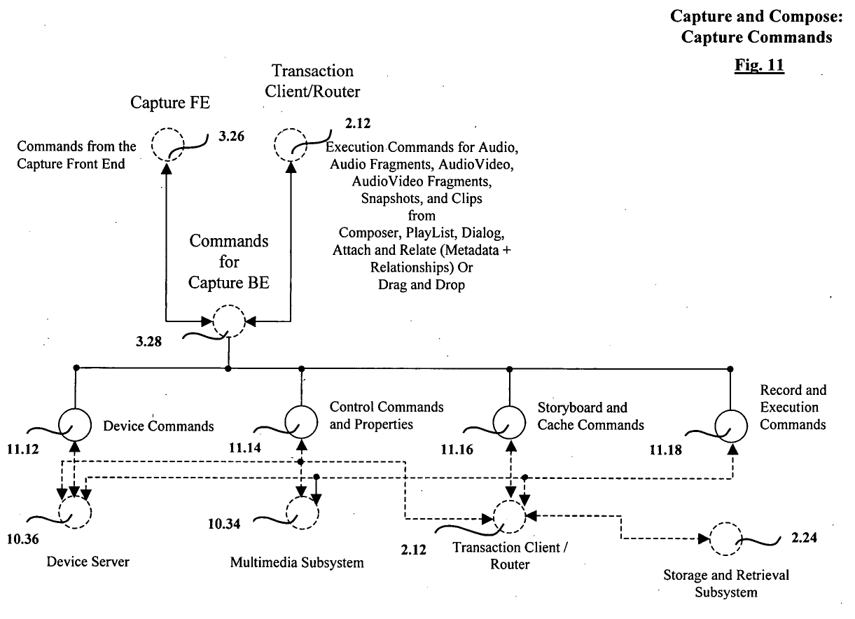

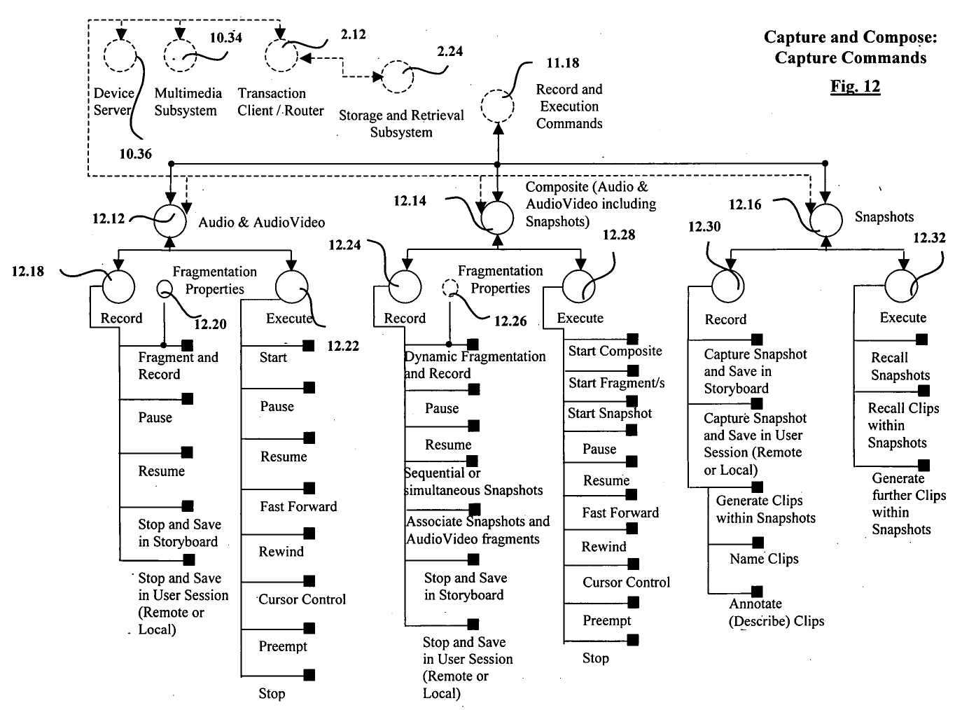

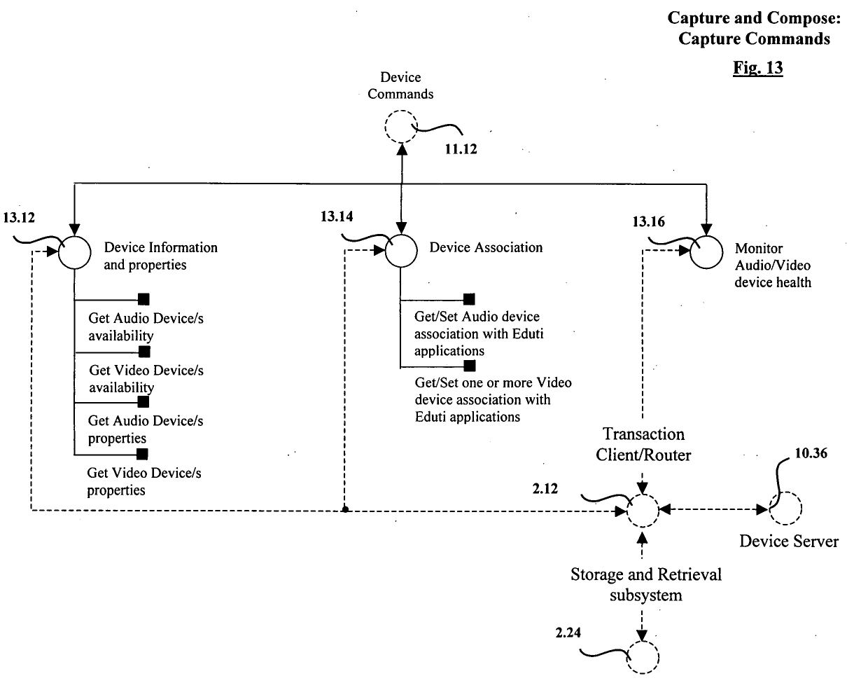

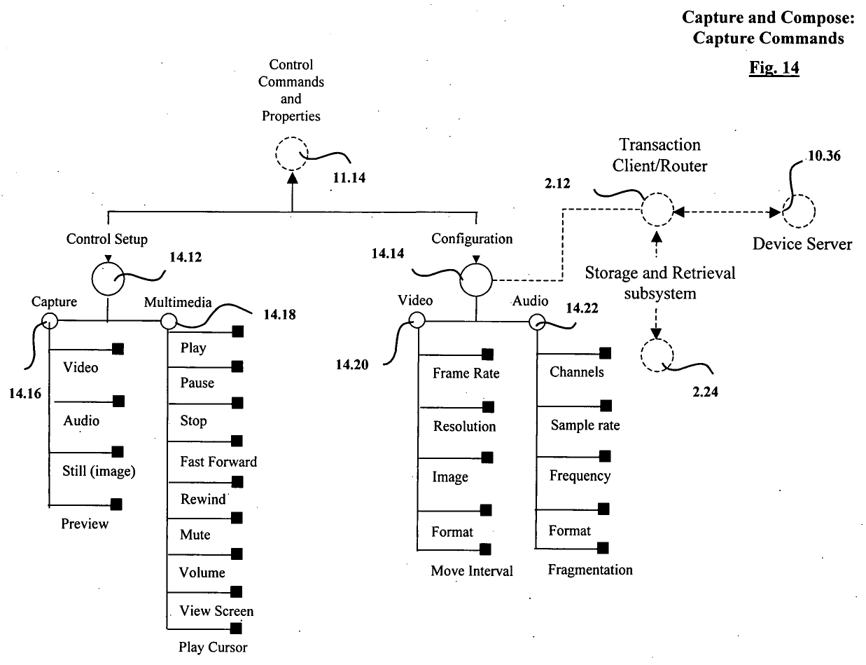

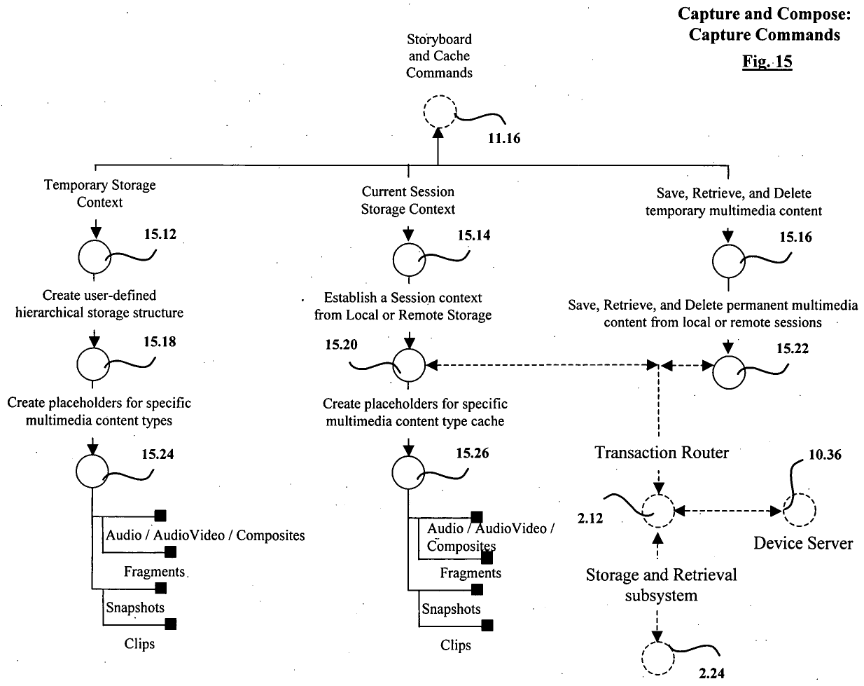

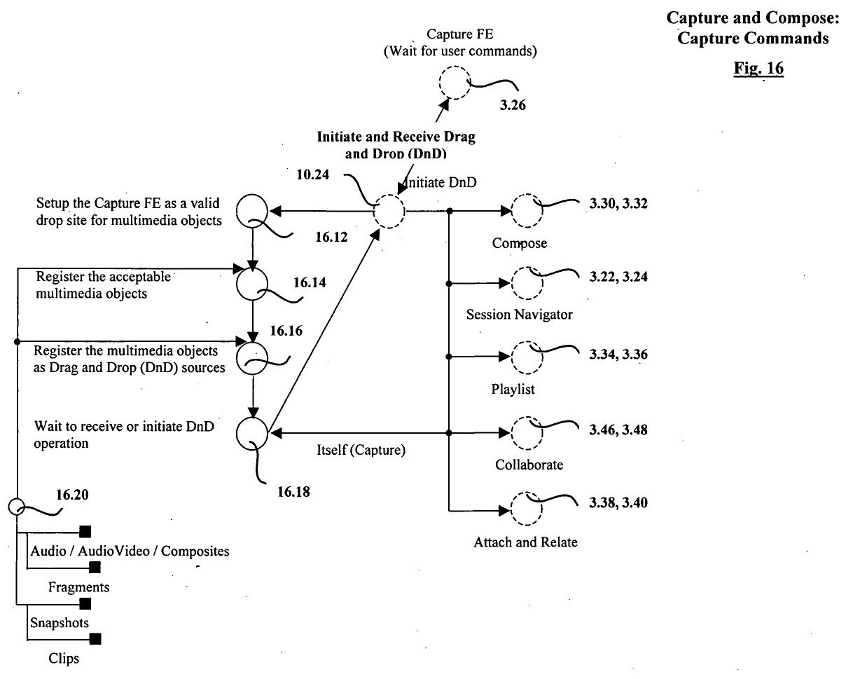

FIGS. 10 through 16 describe the client server architecture and the functional implementation of the Capture application. These figures also describe the commands and the operational flow of the functionality of the Capture application. The Capture application and their respective modules are also logically broken into client side modules and server side modules. The client side modules address the user interface functionality of the Capture application and the server side modules address the business logic of the Capture application.

The Capture application Front End (the client side modules) is started from the desktop. The Back End of the Capture application (the server side modules) is started at the bootup time of the client PC along with the back ends of all other applications that comprise the Eduti suite of applications.

The Front-End modules of the Capture application, at the beginning establish a handshake with the Back-End modules of the Capture application. Following this process these modules set up all the user interface representation structures that provide the users with information regarding the devices that are connected to the Client PC, particularly the ones that have been associated with the Capture application. The user interface representation structures are also setup here to create widgets that display the content acquired by multimedia devices (audio, video, whiteboard snapshots, computer screen snapshots, etc.) that are associated with the Capture application.

During this process user interface widgets are also created to display and control the properties of all the devices that interface with the Capture application. User interface representation structures are also created to display and describe various aspects of the content in the domain of the Capture application. This content may be as a result of an oggoing capture process, or this content may be one that was captured previuosly, or this content may be have been cached in the Capture application as a result of review operation performed by the user. The description of content, its multimedia components, and the synchronous relationship between the multimedia components are all encapsulated in the Storyboard user interface widget of the Capture application.

Once the user interface structures for the multimedia content display and contol widgets in the Capture application have been created, the Capture application sets up user interface widgets for multimedia device connection, the multimedia device properties, and application association with these devices.

Following the above mentioned functionality, the Capture application sets up the StoryBoard widget and a widget that allows the user to save the acquired content and relationship between its multimedia components in a Session Context. The user may save the acquired content and the relationship between its multimedia components in a temporary storage (StoryBoard) or the user may choose to save it in previously created Session in order to be able to access and recall it at some later stage. This provides the user with a flexibility to either save the content temporarily, edit it and then save it in a Session or save the the multimedia content directly in a Session and then edit it at some later time.

After creating the user interface structures for the StoryBoard, the Capture Front-End modules create the user interface representation structures for the Capture Control Panel. This Control Panel provides the users with the functionality to control the acquisition and review of multimedia based on properties set up for acquisition and replay of the multimedia content.

The representation structures of the Capture Control widget provides the functionality for the user to control the mechanism by which the components of the multimedia content are synchronized and fragmented. These properties are set based on the user's criteria for subsequent access of entire multimedia content or any fragment of the multimedia content. Finally representation structures are created to register valid user interface objects that can be considered as drag and drop source objects or drag and drop destination objects for the Capture application Front-End module.

Once all the Capture application user interface components are built and a handshake is established with the Capture Back-End modules, the Capture Front-End goes into a steady state waiting for any requests from the user. The Capture application's Front-End may also get a request from the Capture Back-End to display the data resulting from a request from the Capture Front-End or from any other application's Back-End.

The Back-End process of the Capture application, at its startup, first establishes a communication handshake with the Device Server Back-End. The responsibility to communicate with all the devices and to receive all the data and status from the multimedia devices is delegated to the Device Server Back-End.

Following the handshake with the Device Server Back-End, the Capture application Back-End establishes a communication handshake with the Transaction Client/Router process. All applications, through their Back-End modules, communicate via the Transaction Client/Router process. All the objects in the Eduti system have the functionality to describe themselves. Whenever the Transaction Client/Router process gets a message regarding an object, it is able to query the object to determine the target application that can address the object. Based on this information the Transaction Client/Router routes the request, the object/s and the data to the appropriate application. Similarly the Transaction Client/Router process also delivers the status or returning data back to the requestor.

Next, the Back-End process of the Capture application establishes a communication with the multimedia sub-system. The responsibility to create and execute multimedia objects, the data and formats associated with the multimedia objects, and the control parameters associated with the creation, execution and synchronization the multimedia components of the multimedia objects, are delegated to the multimedia sub-system of the Back-End process of the Capture application.

Finally the Capture application Back-End waits for a handshake request from the Capture Front-End to receive requests from it and to deliver it the status, data associated with the multimedia content, for the purpose of acquisition and execution. The Capture application Back-End also waits for any commands that are delivered to it from the Transaction Client/Router. If the the Capture application Back-End receives a request via the Transaction Client/Router to execute a multimedia content from another application, (and at that time if it has not already established a handshake with the Capture application Front-End), it first starts up the Capture application Front-End and then delivers it the content for execution. Following each such request or command, either by the Capture Front-End or by the Transaction Client/Router, it attempts to fullfill such request and then goes back into a wait state for subsequent requests or commands.

Capture application Back-End sends all the communications to the Storage and Retrieval subsystem, or to the Remote Database Server via the LAN/WAN/Internet, through the Transaction Client/Router.

The commands delivered by the Capture Application Front-End, by the Transaction Client/Router for the Capture Application Back-End and the commands executed by the Capture application Back-End are categorized as follows: Device Commands, Control Commands and Properties, StoryBoard and Cache Commands, and Record and Execution Commands. Each is further described below.

The Device commands are communicated directly to the Device Server subsystem of the Capture Application Back-End. The Control Commands and Properties are communicated directly to the Multimedia subsystem of the Capture Application Back-End. All the communications by either the Device Server subsystem or by the Multimedia subsystem of the Capture Application Back-End for data in the Storage and Retrieval subsystem are done through the Transaction Client/Router.

The commands and data requests delivered to the Capture application Back-End from the Transaction Client/Router are regarding execution of following multimedia objects: Audio, Audio Fragments, AudioVideo, AudioVideo Fragments, Snapshots, and Clips from the Composer application, the PlayList application, the Dialog application, the Attach and Relate (Metadata+Relationships) application or via Drag and Drop operations.

The Record and Execution Commands can be operated on the following objects: Audio & AudioVideo, Composite (Audio & AudioVideo including Snapshots), and Snapshots. Each one of these objects can be recorded or executed. Audio, AudioVideo and Composite objects are linear objects in that they exist and can be executed over a period of time. Fragmentation properties can be set on each one of these objects such that during a recording phase these objects are captured and stored in sizes (time slices) determined by the user. The user may set the Fragmentation properties such that the linear object is broken and stored in 1-second fragments or in 2-second, 3-second, 4-second or in n-second fragments. This provides the user with a capability to annotate linear multimedia objects up to a granularity of 1 second. Using this functionality, the user can annotate smallest segments of multimedia content in order to be able to search, recall, relate and review any portion of multimedia content captured using the Capture application.

In the Record functionality on the Audio & AudioVideo objects, the Capture application provides the capability to, for example, Fragment and Record Audio and Audio combined with Video, down to 1 second fragment granularity, Pause and Resume during the recording, Stop and Save the fragmented Audio & AudioVideo object in the StoryBoard, and Stop and Save the fragmented Audio & AudioVideo object in a User Session located in Local or Remote storage. In the Execute functionality on the Audio & AudioVideo objects, the Capture application provides the capability to, for example, Start executing the fragment and recorded Audio and Audio combined with Video, Pause the execution of the fragmented and recorded Audio and Audio combined with Video, Resume the paused execution of fragmented and recorded Audio and Audio combined with Video, Fast forward the executing/paused or stopped fragmented and recorded Audio and Audio combined with Video, Rewind the executing/paused or stopped fragmented and recorded Audio and Audio combined with Video, Cause the Fast forward or Rewind operation to be controlled by sliding bar, Preempt an execution with that of another Audio & AudioVideo object, and Stop the execution the fragmented and recorded Audio and Audio combined with Video.

A Composite object is defined to be an AudioVideo object that contains Snapshots embedded in it. Consider and Audio or and AudioVideo being recorded with certain fragmentation properties. During the recording of a Composite object, the Capture application provides the functionality to embed snapshots of a whiteboard or a computer screen or that of a specific window (including menubars, popups or any presentation that appears as encapsulated in a user interface window) on a client PC, within the AudioVideo at the specific time in the recording when the snapshot was taken. During the recording of a Composite object, the user may simply hit a designated button to take the snapshot of a whiteboard being viewed by a video or a still camera device. The user may also click a designated key on the keyboard of the Client PC to take a snapshot of the computer screen. The user may also simply set the properties in the Capture application Front-End in order to automatically take a snapshot of the computer screen when a new window (including menus/popups) is displayed on the desktop or when change occurs in any window on the computer screen. The multimedia components (audio and video) are synchronized and stored with the snapshots with respect to time.

The Record functionality on the Composite object is essentially the same as that of the Audio & AudioVideo objects except it provides the capability to embed the snapshots within the Audio & AudioVideo with respect to time.

In addition to the Execute functionlaity on the Audio & AudioVideo objects, the Execute functionality on the Composite object displays the snapshots exactly at the same relative time after the start of AudioVideo when the original snapshot was taken. This provides the ability to capture the entire dynamic content that gets created in a classroom in such a way that the multimedia components that make up the captured content can be accessed to their smallest granularity. The components also maintain relationship with each other with with respect to time.

Compose Application

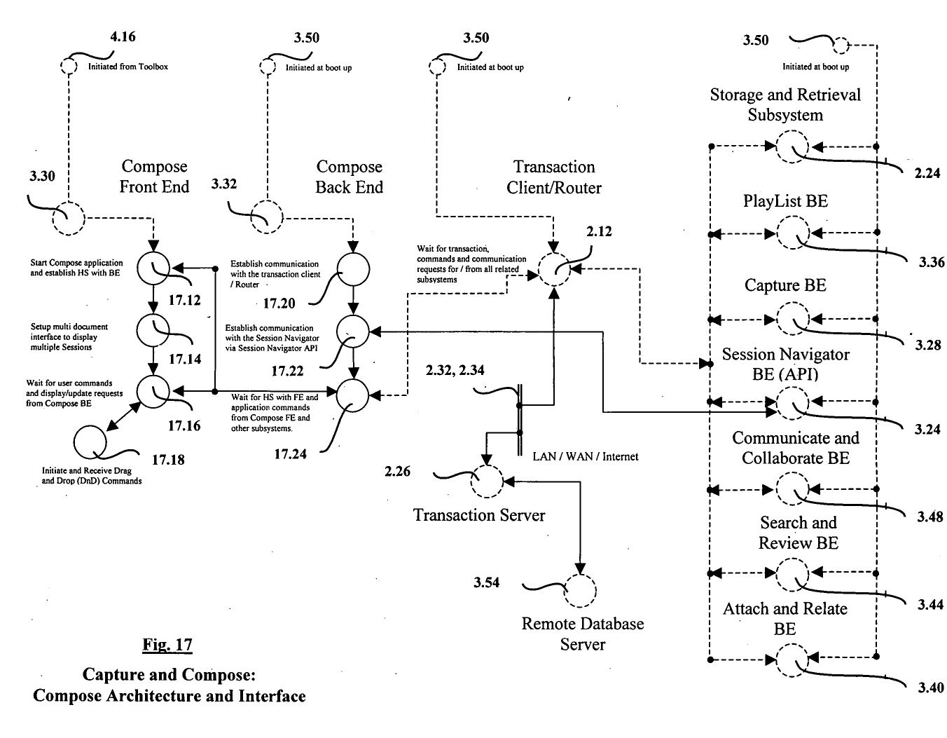

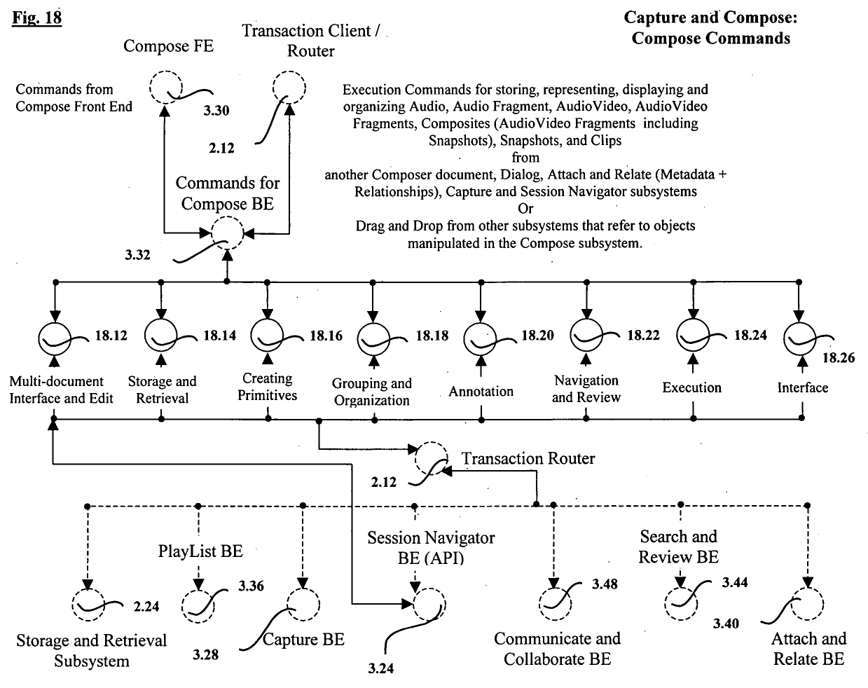

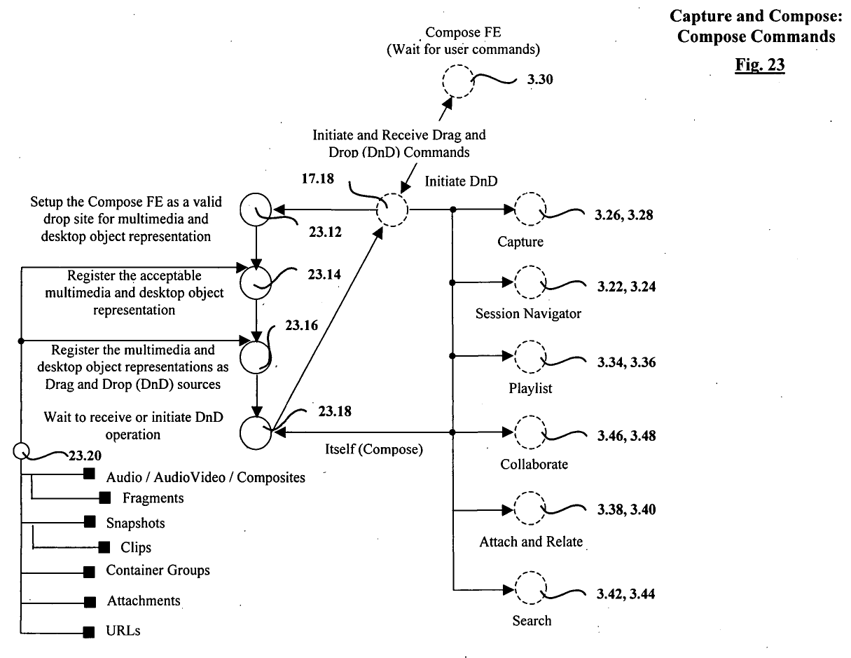

FIGS. 17 through 23 describe the client server architecture and the functional implementation of the Compose application. These figures also describe the commands and the operational flow of the functionality of the Compose application. The Compose application Front End (the client side modules) is started from the desktop (FIG. 17). The Back End of the Compose application (the client side modules) is started at the bootup time of the client PC along with the back ends of all other applications that comprise the EdUti suite of applications.

The Front-End modules of the Compose application, at the beginning establish a handshake with the Back-End modules of the Compose application. Following this process these modules set up the multi document interface that provide the users with the information and ability to create, retrieve, view, edit, organize, hierarchically group, setup implicit and explicit relationships between any of the EdUti and desktop objects and save captured session (s).

Subsequently, representation structures are created to register valid user interface objects that can be considered as drag and drop source objects or drag and drop destination objects for the Compose application Front-End module. Once all the Compose application user interface components are built and a handshake is established with the Compose Back-End modules, the Compose Front-End goes into a steady state waiting for any requests from the user. The Compose application's Front-End may also get a request from the Compose Back-End to display the data resulting from a request from the Compose Front-End or from any other application's Back-End.

The Back-End process of the Compose application, at its startup, first establishes a communication handshake with the Transaction Client/Router process. All applications, through their Back-End modules, communicate via the Transaction Client/Router process. All the objects in the EdUti system have the functionality to describe themselves. Each object is unique throughout the system, whether these objects reside in the current client space or whether they are included by fetching them from another client's space or whether they are fetched from the remote database. Whenever the Transaction Client/Router process gets a message regarding an object, it is able to query the object to determine the target application that can address the object. Based on this information the Transaction Client/Router routes the request, the object/s and the data to the appropriate application. Similarly the Transaction Client/Router process also delivers the status or returning data back to the requestor.

Next, the Back-End process of the Compose application establishes a communication with the Session Navigator application via the Session Navigator API. The Session Navigator application allows the user to view, create, organize, save, copy and delete EdUti sessions.

Finally the Compose application Back-End waits for a handshake request from the Compose Front-End to receive requests from it and to deliver it the EdUti session (s) content, for the purpose of acquisition and execution. The Compose application Back-End also waits for any commands that are delivered to it from the Transaction Client/Router. If the Compose application Back-End receives a request via the Transaction Client/Router to execute a multimedia content from another application, (and at that time if it has not already established a handshake with the Compose application Front-End), it first starts up the Compose application Front-End and then delivers it the content for execution. Following each such request or command, either by the Compose Front-End or by the Transaction Client/Router, it attempts to fulfill such requests and goes back into a wait state for subsequent requests or commands.

Compose Application Back-End sends all the communications to the Storage and Retrieval subsystem, or to the Remote Database Server via the LAN/WAN/Internet, through the Transaction Client/Router. The commands delivered by the Compose Application Front-End (FIG. 18), by the Transaction Client/Router for the Compose Application Back-End and the commands executed by the Compose application Back-End are categorized as follows: Multi-document Interface and Edit, Storage and Retrieval, Creating Primitives, Grouping and Organization, Annotation, Navigation and Review, Execution, and Interface.

The Multi-document Interface and Edit commands are either communicated to the Transaction Client Router or the Session Navigator Backend. The Transaction Router than routes the commands to the appropriate application backend for execution or to the Storage and Retrieval Subsystem. All other commands including Storage and Retrieval, Creating Primitives, Grouping and Organization, Annotation, Navigation and Review, Execution and Interface are routed through the Transaction Client/Router to the appropriate application backend or to the Storage and Retrieval Subsystem.

The commands and data requests delivered to the Compose application Back-End from the Transaction Client/Router are regarding storing, representing, displaying and organizing of the following multimedia objects: Audio, Audio Fragments, AudioVideo, AudioVideo Fragments, Composites (AudioVideo Fragments including Snapshots), Snapshots, and Clips from another Composer document, the Communicate and Collaborate application, the Attach and Relate (Metadata+Relationships) application, the Capture application and the Session Navigator subsystems or via Drag and Drop operations. The Sessions captured in the E-Book, including “Voice note or Conversation recordings with the time stamped objects (EdUti+Desktop)” can be organized as any other object in the Compose application.

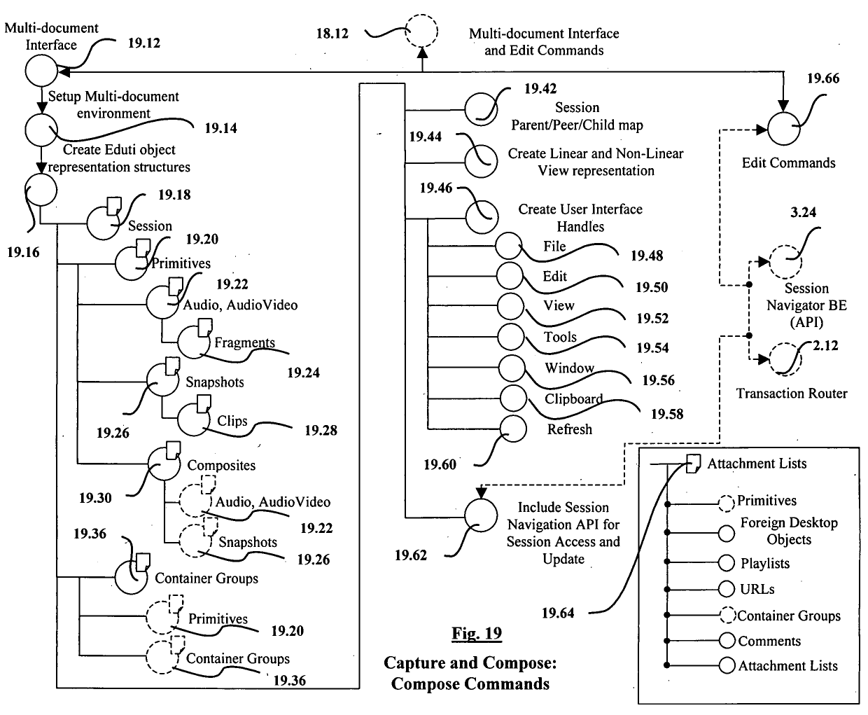

The Multi-document Interface commands (FIG. 19) are broken into two sets of commands: Multi-document Interface and Edit Commands. The Multi-document Interface creates EdUti Object representation structures for: the EdUti Session and Container Groups, the Session Parent/Peer/Child relationships, the Linear and Non-Linear Object View representations, and User Interface Handles and Session Navigation API for the EdUti Sessions created within the Compose application and then later accessed for Session Access and Update within the Session Navigator application.

The EdUti Session includes Primitives such as Audio, AudioVideo, Fragments with attachments lists, Snaphots and Clips with attachment lists, Composite objects with Audio, AudioVideo and Snapshots with optional attachment lists, and E-Books with all the objects and representations contained within the E-Books. The “attachment lists” can optionally include primitives, Foreign Desktop Objects, Playlists, URLs, Container Groups, Comments and additional Attachment Lists. The Container Groups can optionally include Primitives with attachment lists and Containers with attachment lists.

The Session Object itself can be related to other sessions and other EdUti objects as peers, parents or child which is displayed in a two dimensional map. Linear objects that include time relationship such as voice annotation and non-linear objects like documents are represented as calibrated lines or as icons respectively. The User Interface Handles are created for user operations pertaining to File, Edit, View, Tools, Window, Clipboard and Refresh. Finally, Session Navigation API commands allow users to access and update Sessions via the Transaction Router or the Session Navigator Backend. All the Edit Command operations are routed through the Transaction Client Router and the Session hierarchy manipulations are communicated by a direct API exported by the Session Navigator.

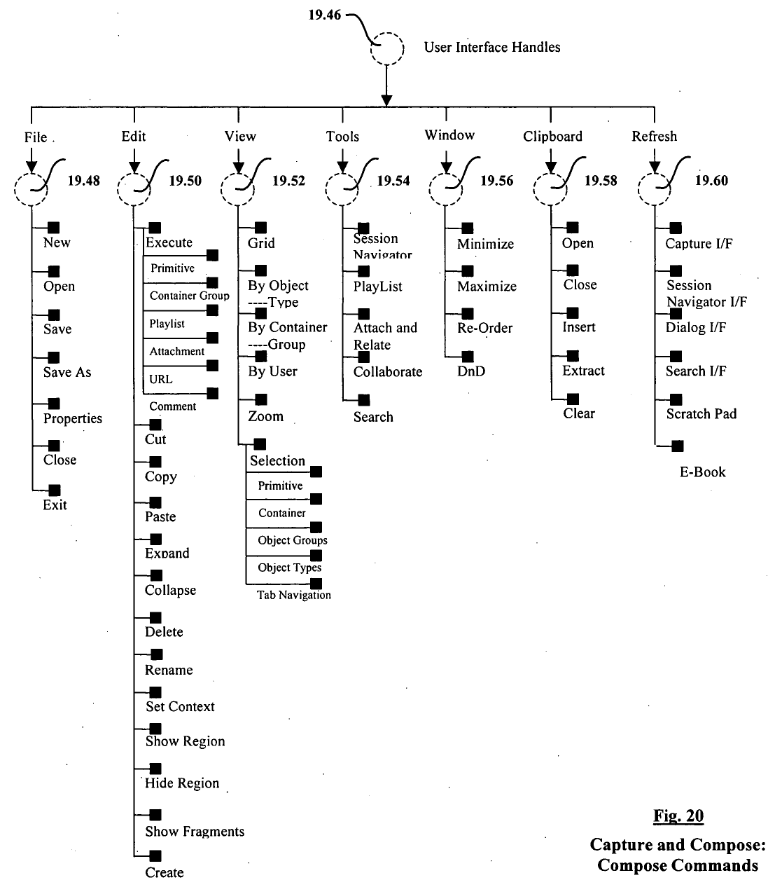

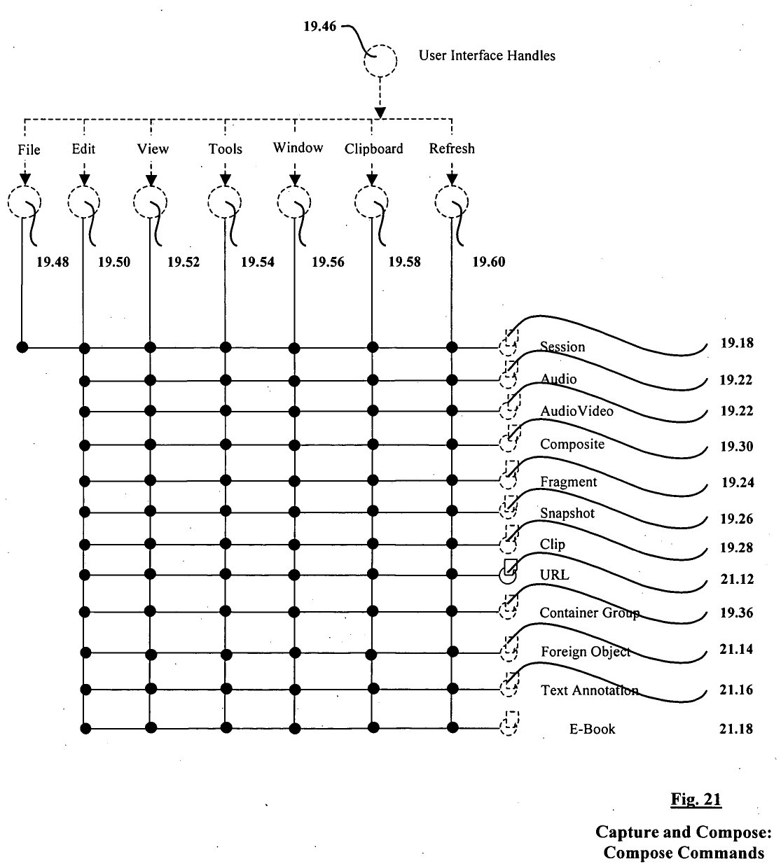

The File/User Interface Handles (FIG. 20) include New, Open, Save, Save As, Properties, Close and Exit. These operations enable user to perform tasks related to creating new sessions, opening pre-existing sessions that were created either by the Compose application or by the Session Navigator application, and saving the sessions that have been updated. All the objects created in the sessions, including the session object themselves have a unique identifier with the information regarding ownership and current place of residence. This way, even when the sessions are moved or published, the only information that is changed is the place of their residence. During a communication the session or any of its contained object can be fetched from either the remote server or from any of the peers that have the current copy of one or more components of the set of objects.

The Edit User Interface Handles include Execute, Cut, Copy, Paste, Expand, Collapse, Delete, Rename, Set Context, Show Region, Hide Region, Show Fragments and Create. These operations allow manipulation of the EdUti objects or their display. The user is able to look at only the relevant piece of information without having to render all the peer relationship or data contained in the hierarchy. The Execute command handles include Primitive, Container Group, Playlist, Attachment, URL and Comment. Since each object is able to completely identify itself, it also knows about the applications and the context it can be executed in. Objects such as Audio, Video, Fragments, E-Book, etc. that may have a representation in multiple contexts request the user for further information regarding the context that the user wants to execute the object in. For example, a Video clip or a fragment that was found during a Search operation can be view in a Composition context to view all the relationships/data associated with it or this video clip can simply be executed. Depending on the context chosen by the user, the Transaction Client Router will route the execution command along with the Object Id. to either the Compose application or to the Capture application.

The View Interface Handles include Grid, By Object Type, By Container Group, By User, Zoom and Selection. These operations enable the user to organize the EdUti objects for viewing and for further manipulation. The Selection command handles include Primitive, Container, Object Groups, Object Types and Tab Navigation.

The Tools Interface Handles include Session Navigator, PlayList, Attach and Relate, Collaborate and Search. These operations allow a user to switch from the Compose application to other applications. The purpose of these commands is two fold: One is to provide a quick handle to the applications, second, which is more important, is to set a context before firing the chosen application. The user may want to look for a relationship to a Group of objects that were organized in the Compose application or create a new relationship with this Group. The user may want to send the Group identifier to another user who he/she is collaborating with using the Communicate and Collaborate group.

The Window Interface Handles include Minimize, Maximize, Re-Order and DnD (drag and drop). These operations allow the user to manipulate the viewing window and allow dragging dropping of objects from the desktop or other EdUti sessions. All the applications do not have to understand all the objects. Since each object derives from the same common base each application is able to understand and identify the basic nature of the object. For all other purposes the objects are sent to the Transaction Client Router that determines the most appropriate target application for the current context.

The Clipboard Interface Handles include Open, Close, Insert, Extract and Clear. These operations allow user to manage intermediate copies of the objects created during the editing and manipulation of EdUti or Desktop Objects. Finally, the Refresh Interface Handles manage the communication with other EdUti applications that include Capture, Session Navigator, Communicate and Collaborate, Search, Scratch Pad and the E-Book. These operations allow user to interface with the other EdUti applications by first establishing a context and then delivering the command and data information via the Transaction Client Router.

FIG. 21 shows the relationships between the User Interface Handles and the EdUti Objects in a matrix form. It describes which operations (User Interface Handles) are permitted on different EdUti objects. The File operations can only be performed on the Session object. All other operations including Edit, View, Tools, Window, Clipboard and Refresh can be performed on all EdUti objects including Session, Audio, AudioVideo, Composite, Fragment, Snapshot, Clip, URL, Container Group, Foreign Object, the E-Book and Text Annotation.

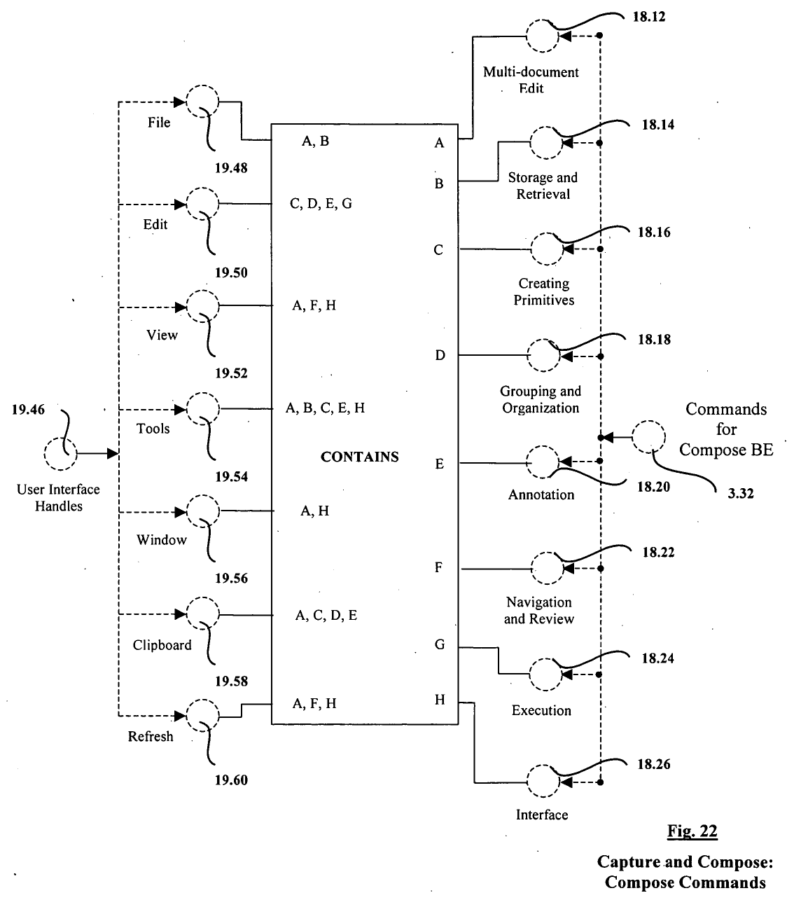

FIG. 22 maps the User Interface Handles and Compose Commands. It describes which operations such as File, Edit, View, Tools, Window, Clipboard and Refresh are applicable to commands like Multi-document Edit, Storage and Retrieval, Creating primitives, Grouping and Organization, Annotation, Navigation and Review, Execution and Interface. These commands are labeled A through H.

The File operations can only be performed on A and B commands. The Edit operations can only be performed on C, D, E and G commands. The View operations can only be performed on A, F and H commands. The Tools operations can only be performed on A, B, C, E and H. The Window operations can only be performed on A and H. The Clipboard operations can only be performed on A, C, D and E. Finally, the Refresh operations can only be performed on A, F and H.

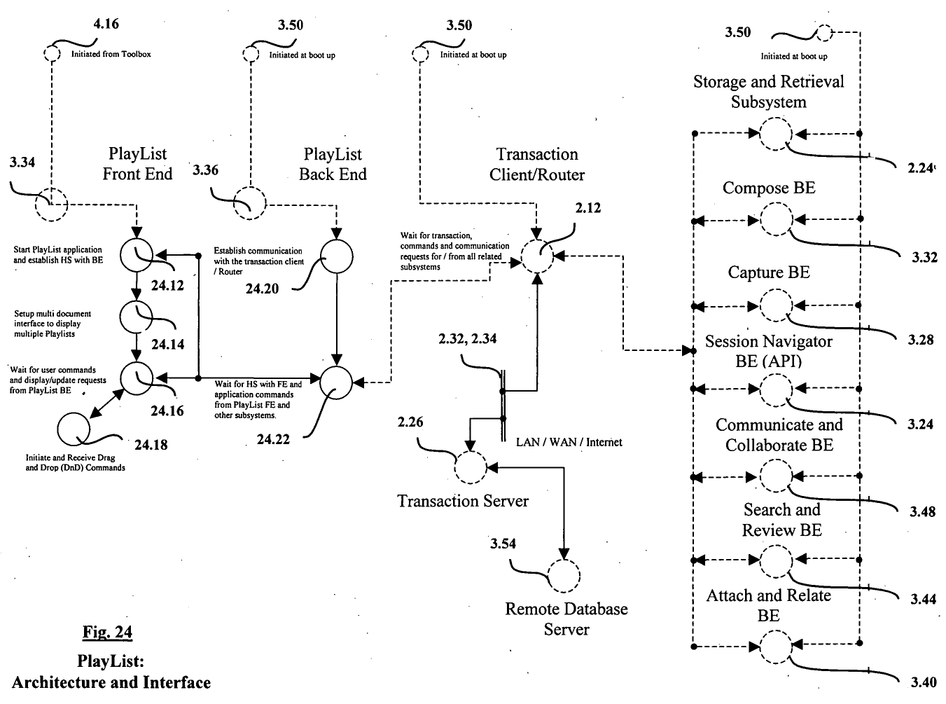

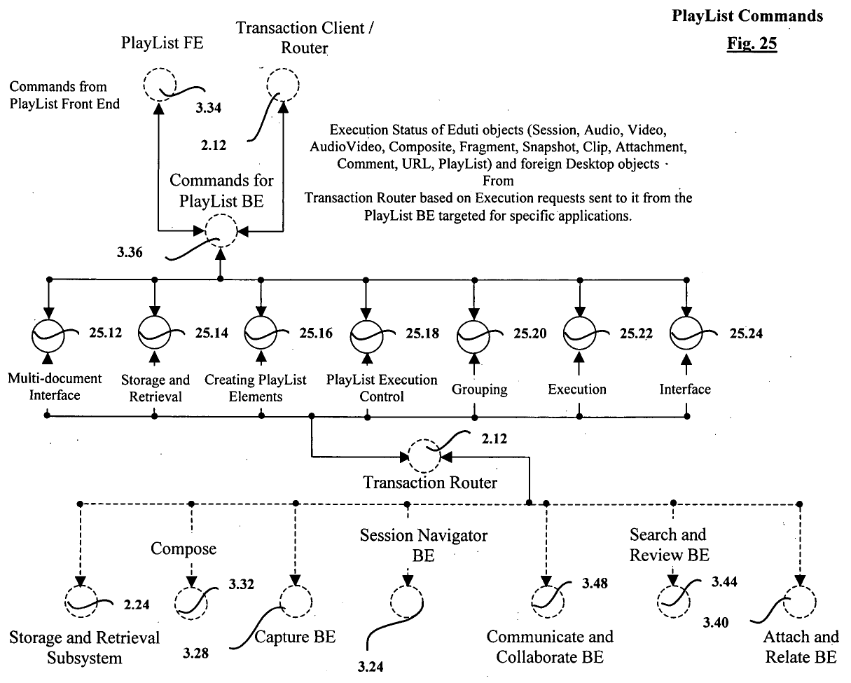

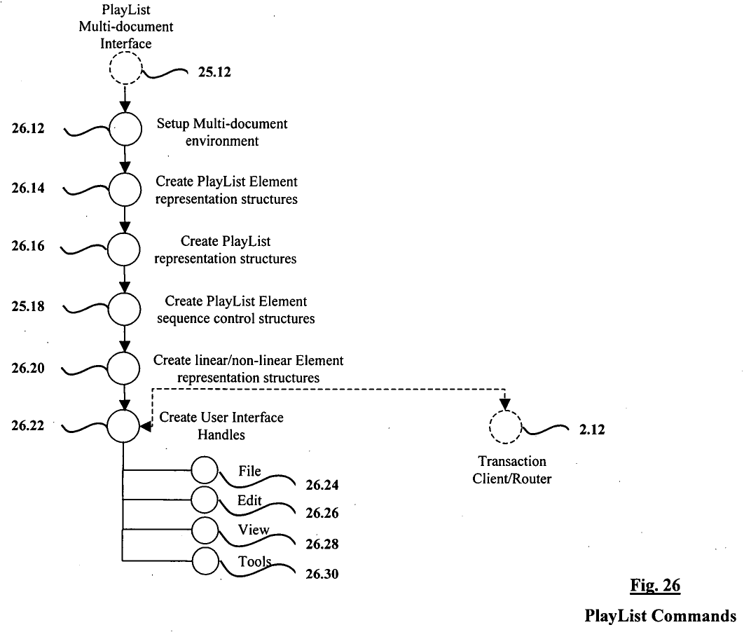

In FIG. 24 the Compose Front-end after setting itself up to receive the Drag and Drop (DnD) commands, waits for user to drag and drop EdUti or Desktop objects on its surface area. The Initiate Drag and Drop (DnD) commands deliver the Compose Front-end with EdUti multimedia and desktop object representations, registers the acceptable multimedia and desktop object representation, registers the multimedia and desktop object representations as Drag and Drop (DnD) sources and waits to initiate or receive DnD operations. The multimedia objects can be of several types including Audio/AudioVideo/Composite or their fragments, Snapshots including Clips, Container Groups, Attachments, E-Book and its components and URLs. The user can drap and drop objects among any opened sessions in the Composer or to and from other applications such as Capture, Session Navigator, PlayList, Collaborate, Attach and Relate, E-Book and Search.

Playlist Application

FIGS. 24 through 30 describe the client server architecture and the functional implementation of the PlayList application. These figures also describe the commands and the operational flow of the functionality of the PlayList application. The PlayList application Front End (the client side modules) is started from the ToolBox (FIG. 24). The Back End of the PlayList application (the client side modules) is started at the bootup time of the client PC along with the back ends of all other applications that comprise the EdUti suite of applications.

The Front-End modules of the PlayList application, at the beginning establish a handshake with the Back-End modules of the PlayList application. Following this process these modules set up the multi document interface that provide the users with the information and ability to create, retrieve, view, edit and save PlayList (s). Subsequently, representation structures are created to register valid user interface objects that can be considered as drag and drop source objects or drag and drop destination objects for the PlayList application Front-End module.

Once all the PlayList application user interface components are built and a handshake is established with the PlayList Back-End modules, the PlayList Front-End goes into a steady state waiting for any requests from the user. The PlayList application's Front-End may also get a request from the PlayList Back-End to start the PlayList application or to display the data resulting from a request from the PlayList Front-End or from any other application's Back-End.

The Back-End process of the PlayList application, at its startup, first establishes a communication handshake with the Transaction Client/Router process. All applications, through their Back-End modules, communicate via the Transaction Client/Router process. All the objects in the EdUti system have the functionality to describe themselves. Whenever the Transaction Client/Router process gets a message regarding an object, it is able to query the object to determine the target application that can address the object. Based on this information the Transaction Client/Router routes the request, the object/s and the data to the appropriate application. Similarly the Transaction Client/Router process also delivers the status or returning data back to the requestor.

Finally the PlayList application Back-End waits for a handshake request from the PlayList Front-End to receive requests from it and to deliver it PlayList's content, for the purpose of acquisition and execution. The PlayList application Back-End also waits for any commands that are delivered to it from the Transaction Client/Router. If the the PlayList application Back-End receives a request via the Transaction Client/Router to execute a PlayList (the command, the Playlist identifier) from another application, (and if at that time if it has not already established a handshake with the PlayList application Front-End), it first starts up the PlayList application Front-End and then delivers it the content (command & Playlist ID) for execution. Following each such request or command, either by the PlayList Front-End or by the Transaction Client/Router, it attempts to fulfill such request and goes back into a wait state for subsequent requests or commands.

PlayList application Back-End also sends all the communications to the Storage and Retrieval subsystem, or to the Remote Database Server via the LAN/WAN/Internet, through the Transaction Client/Router. The commands delivered by the PlayList Application Front-End (FIG. 25), by the Transaction Client/Router for the PlayList Application Back-End and the commands executed by the PlayList application Back-End are categorized as follows: Multi-document Interface, Storage and Retrieval, Creating PlayList Elements, PlayList Execution Control, Grouping, Execution, and Interface. All commands including Multi-document Interface, Storage and Retrieval, Creating PlayList Elements, PlayList Execution Control, Grouping, Execution and Interface are routed through the Transaction Router to the appropriate application backend or to the Storage and Retrieval Subsystem.

The commands and data requests delivered to the PlayList application Back-End from the Transaction Client/Router are regarding execution status of the following EdUti objects: Session, Audio, Video, AudioVideo, AudioVideo, Composite, Fragment, Snapshot, Clip, Attachment, Comment, URL, PlayList, E-Book, specific pages in the E-Book or Objects created in the E-Book and Foreign Desktop objects from the Transaction Router based on Execution requests sent to it from the PlayList BE targeted for specific applications.

The Multi-document Interface as shown in FIG. 26, sets up the Multi-document environment by creating PlayList Element representation structures, creating PlayList representation structures, creating PlayList Element sequence control structures, creating linear/non-linear Element representation structure and finally creating User Interface Handles. The Playlist is a mechanism that provides the users with the ability to sequence Linear as well as Non-Linear Content and execute such content by the Linear as well as Non-Linear controls set by the user.

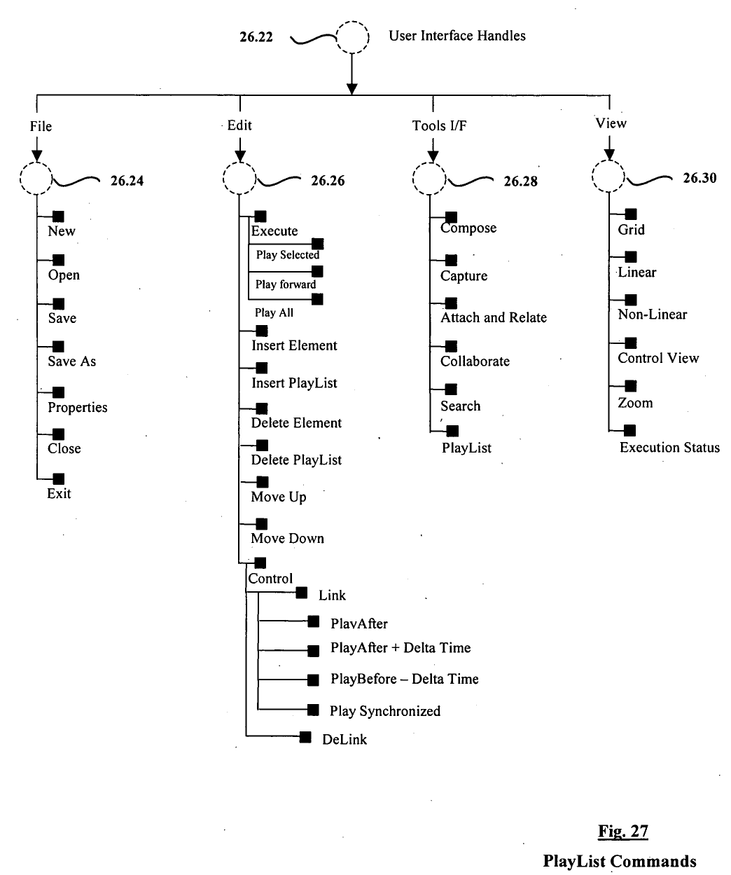

The User Handle Interface communicates to the appropriate application to send and receive execution commands and execution status information via the Transaction Client Router. The User Interface Handles sets up user commands categorized in File, Edit, View and Tools operations. The FIG. 27 describes the details of the User Interface Handles for File, Edit, Tools Interface (I/F) and View operations. The File User Interface Handles include New, Open, Save, Save As, Properties, Close and Exit. These operations enable user to perform opening and saving tasks on the PlayList elements and also to set up default characteristics of the way the user expects the PlayList elements to be executed.

The Edit User Interface Handles include Execute, Insert Elements, Insert PlayList, Delete Element, Delete PlayList, Move Up, Move Down (within one or more embedded Playlists) and Control. The Execute user interface handle includes controls such as Play Selected, Play Forward and Play All operations. The Control user interface handle includes Link and DeLink operations. These are the controls available to the user that provide the capability to simply link various elements in the PlayList (linear as well as non-linear elements) to control the execution sequence as well as the duration of the execution of each element. The Link operations further include PlayAfter, PlayAfter+Delta Time, PlayBefore−Delta Time and Play Synchronized operations. All these handles offer the user the ability to organize and re-organize the EdUti objects for a customized replay at the user's request.

The Tools Interface Handles include Compose, Capture, Attach and Relate, Collaborate, Search and PlayList. These operations allow a user to interact between the applications, create and associate playlists between objects and relationships and seamlessly navigate from the PlayList application to other applications. The View Interface Handles include Grid, Linear, Non-Linear, Control View, Zoom and Execution Status. These operations provide the user with the capability to view the playlist from various angles (in the context of the nature of the contained element).

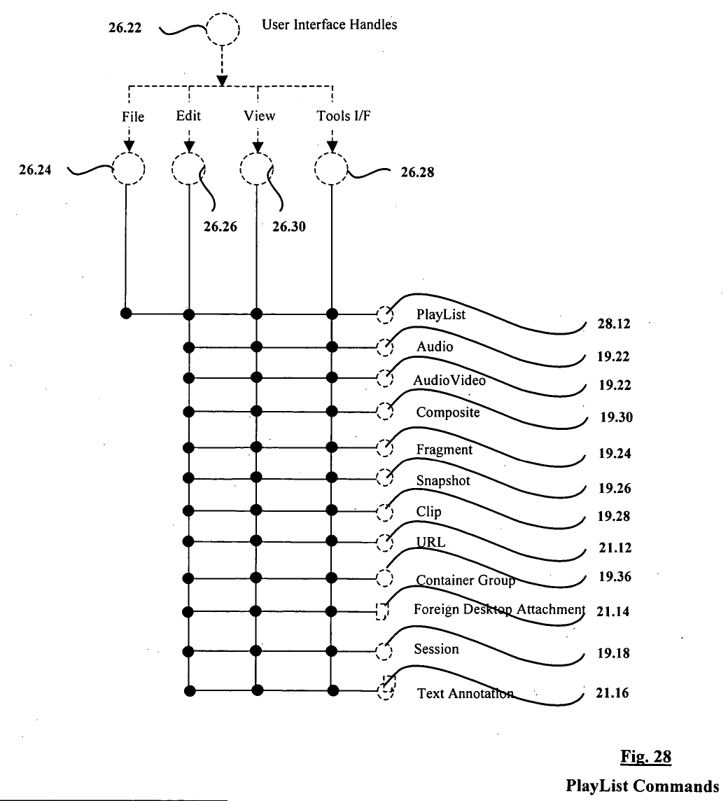

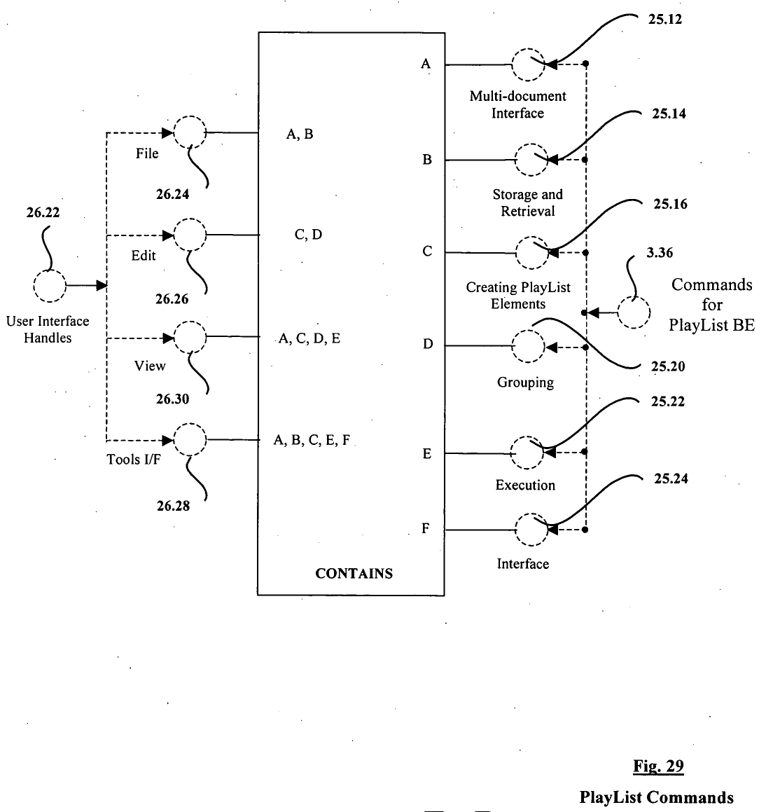

The FIG. 28 shows the relationships between the PlayList User Interface Handles and the EdUti objects in a matrix form. It describes which operations (User Interface Handles) with respect to the PlayList are permitted on different EdUti objects. The File operations can only be performed on the PlayList objects. All other operations including Edit, View and Tools (I/F) can be performed on all of the following EdUti objects including PlayLists, Audio, AudioVideo, Composite, Fragment, Snapshot, Clip, URL, Container Group, Foreign Desktop Attachment, Session and Text Annotation and E-Book (including any or all of its contained objects).

The FIG. 29 maps the PlayList User Interface Handles and PlayList Commands. It describes the categories of commands such as File, Edit, View and Tools(I/F) that are applicable to Multi-document Interface, Storage and Retrieval, Creating PlayList Elements, Grouping, or Execution and Interface. These commands are labeled A through F and the categories refer to them.

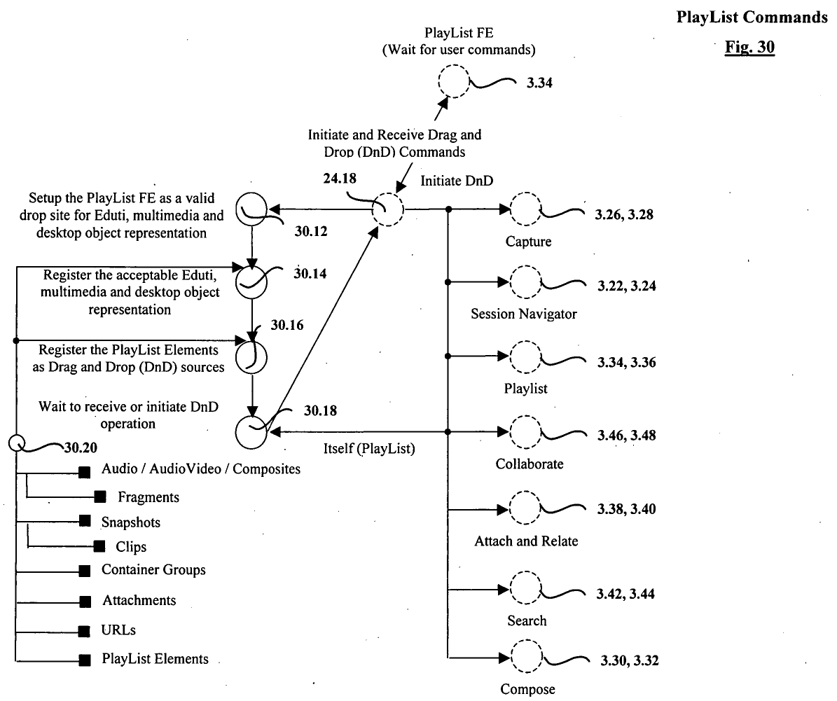

The File operations can only be performed on A and B categories. The Edit operations can only be performed on C and D categories. The View operations can only be performed on A, C, D and E categories. And finally, the Tools (I/F) operations can only be performed on A, B, C, E and F. In the FIG. 30, the PlayList Frontend after initiating the Drag and Drop (DnD) commands, waits for user commands. The Initiate and Receive Drag and Drop (DnD) commands sets up the PlayList Frontend as a valid drop site for EdUti, multimedia and desktop object representation, registers the acceptable EdUti, multimedia and desktop object representation, registers the PlayList Elements as Drag and Drop (DnD) sources and waits to initiate or receive DnD operations. The EdUti, multimedia and desktop objects (files[that will be executed by their respective applications]/folders) can be of several types including Audio/AudioVideo/Composite or their fragments, Snapshots including Clips, Container Groups, Attachments, E-Book and all its contained elements, URLs and PlayList themselves. The user can drap and drop objects (the Playlist will receive and store object identifiers only) among any opened PlayLists or from other applications such as Capture, Session Navigator, PlayList, communicate and Collaborate, Attach and Relate, Search, E-Book and Compose.

Admin and Access Application

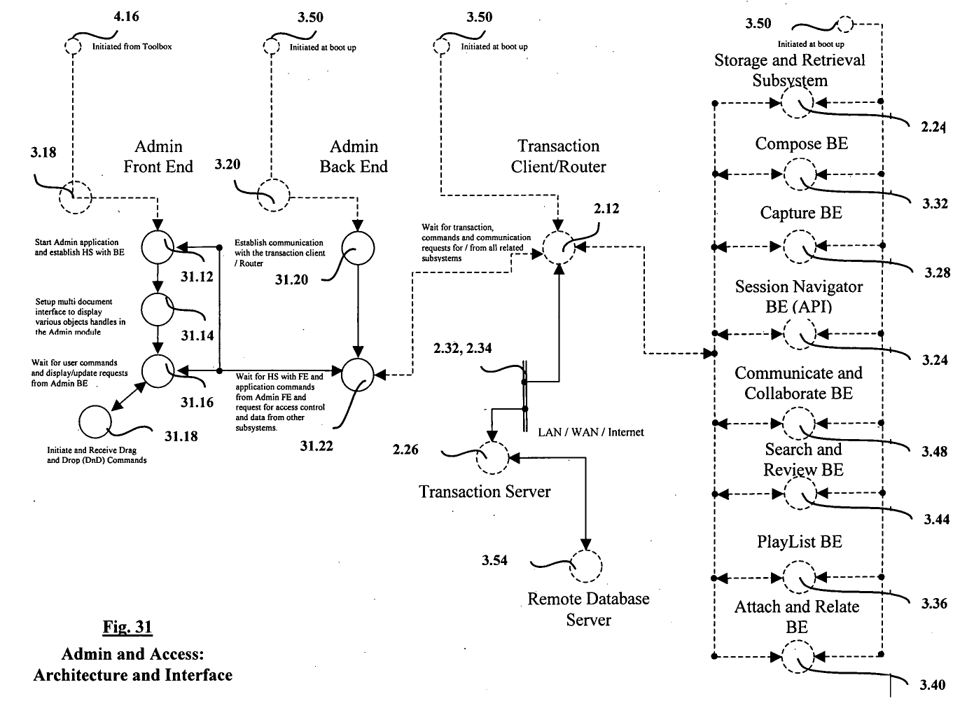

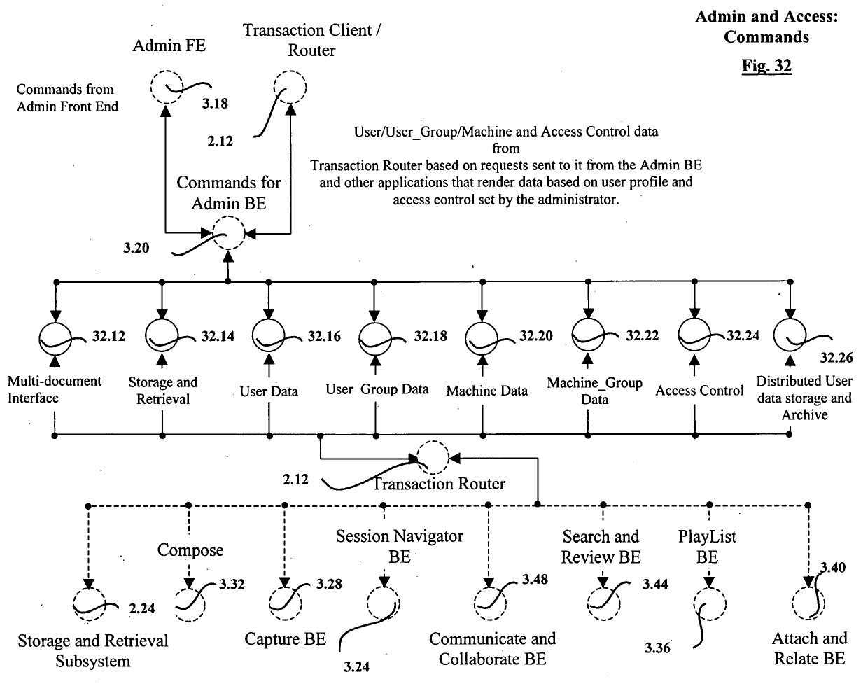

FIGS. 31 through 36 describe the client server architecture and the functional implementation of the Admin and Access application. These figures also describe the commands and the operational flow of the functionality of the Admin and Access application. The Admin and Access application Front End (the client side modules) is started from the ToolBox (FIG. 31). The Back End of the Admin and Access application (the client side modules) is started at the bootup time of the client PC along with the back ends of all other applications that comprise the EdUti suite of applications.

The Front-End modules of the Admin and Access application, at the beginning establish a handshake with the Back-End modules of the Admin and Access application. Following this process these modules set up the multi document to display various object handles in the Admin module. Subsequently, representation structures are created to register valid user interface objects that can be considered as drag and drop source objects or drag and drop destination objects for the Admin and Access application Front-End module.

Once all the Admin and Access application user interface components are built and a handshake is established with the Admin and Access Back-End modules, the Admin and Access Front-End goes into a steady state waiting for any requests from the user. The Admin and Access application's Front-End may also get a display/update request from the Admin and Access Back-End.

The Back-End process of the Admin and Access application, at its startup, first establishes a communication handshake with the Transaction Client/Router process. All applications, through their Back-End modules, communicate via the Transaction Client/Router process. All the objects in the EdUti system have the functionality to describe themselves. Whenever the Transaction Client/Router process gets a message regarding an object, it is able to query the object to determine the target application that can address the object. Based on this information the Transaction Client/Router routes the request, the object/s and the data to the appropriate application. Similarly the Transaction Client/Router process also delivers the status or returning data back to the requestor.

Finally the Admin and Access application Back-End waits for a handshake request from the Admin and Access Front and request for access control and data from other subsystems via the Transaction Client/Router. If the Admin and Access application Back-End receives a request via the Transaction Client/Router to execute a Admin and Access command or data from another application, (and at that time if it has not already established a handshake with the Admin and Access application Front-End), it first starts up the Admin and Access application Front-End and then delivers it the access control command and data for execution, association or display in the Admin and Access application. Following each such request or command, either by the Admin and Access Front-End or by the Transaction Client/Router, it attempts to fulfill such request and then goes back into a wait state for subsequent requests or commands.

Admin and Access application Back-End also sends all the communications to the Storage and Retrieval subsystem, or to the Remote Database Server via the LAN/WAN/Internet, through the Transaction Client/Router. It also communicates via LAN/WAN and the Internet to the Remote Database Server via the Transaction Server. All the User, Static and Dynamic Group data and properties are maintained at the Remote database, including all the access and privileges associated with the Users, Static and Dynamic Groups with respect to the Content collated and organized in the Sessions and the E-Book.

The commands delivered to the Admin and Access Application Front-End (FIG. 32), by the Transaction Client/Router for the Admin and Access Application Back-End and the commands executed by the Admin and Access application Back-End are categorized as follows: Multi-document Interface, Storage and Retrieval, User Data, User_Group Data, Machine Data, Machine_Group Data, Access Control, and, Distributed User data, Content and Archives.

All commands including Mult-document Interface, Storage and Retrieval, User Data, User_Group Data, Machine Data, Machine Group Data, Access Control and Distributed User data storage and Archive are routed through the Transaction Client Router to the appropriate application backend and/or to the Storage and Retrieval Subsystem. All User/User Group/Machine and access control data requests that are delivered to the Admin and Access application Back-End from the Transaction Client/Router are based on requests from the Admin and Access Backend and other applications that render data based on user profile and access control set by the administrator.

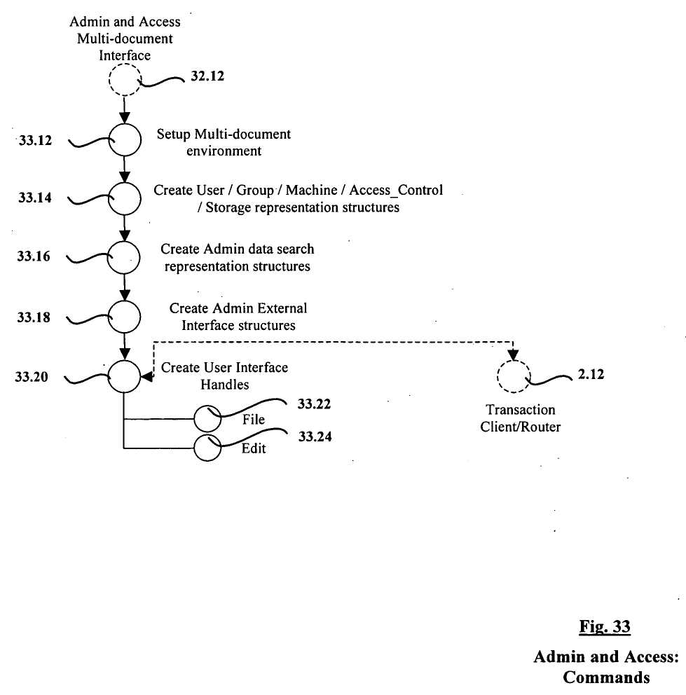

The Multi-document Interface as shown in FIG. 33, sets up the Multi-document environment by creating User/Group/Machine/Access_Control/Storage representation structures, by creating: Admin data, Search representation structures, Admin and Access External Interface Structures and finally User Interface Handles. The User Handle Interface communicates to the admin and Access back end and to the back ends of other applications to send and receive User/User Group/Machine and access control data via the Transaction Client/Router. The User Interface Handles sets up user commands for File and Edit operation categories.

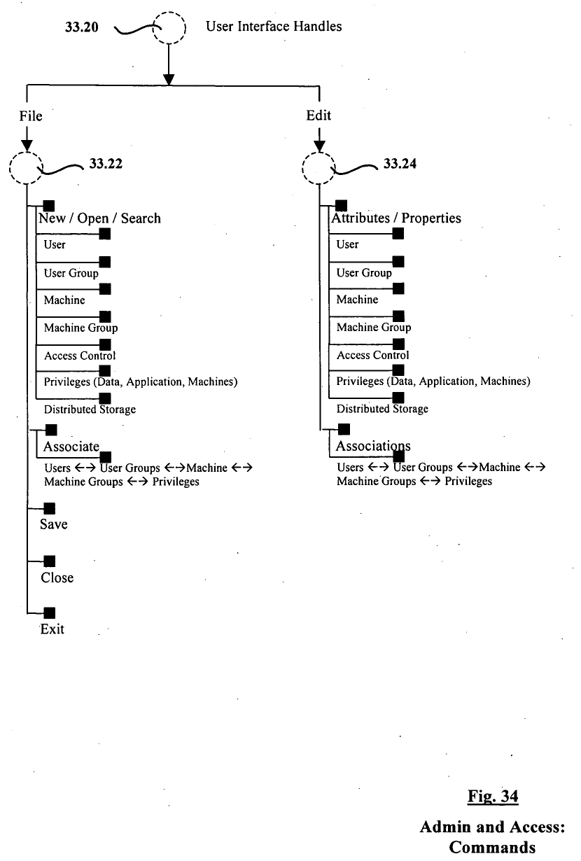

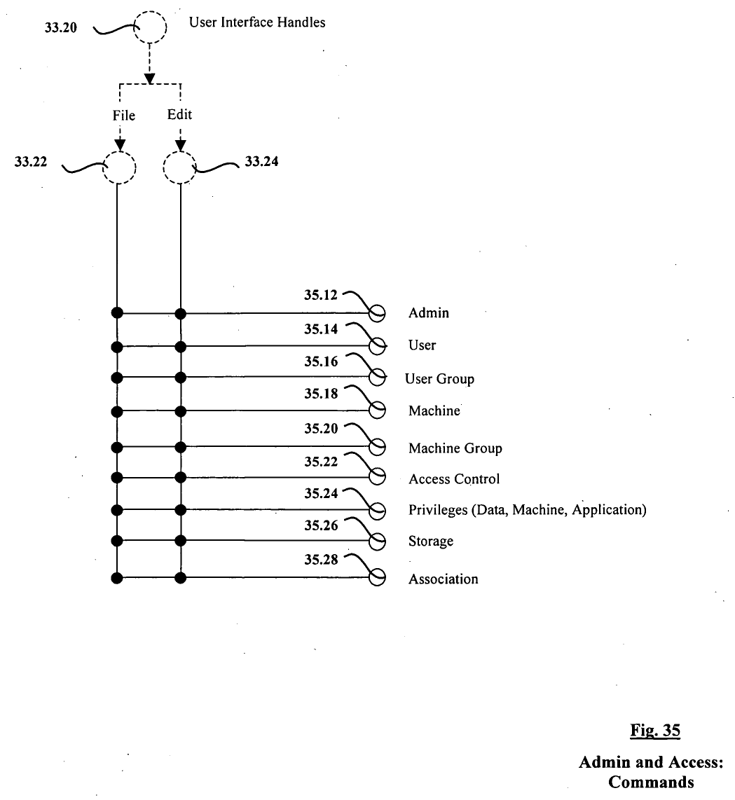

The FIG. 34 describes the details of the User Interface Handles for File and Edit categories of operations. The File User Interface Handles include New/Open/Search, Associate, Save, Close and Exit. These operations allow the administrator to create initial place holders for users, user groups, machine, machine groups, the distributed storage locations and initial access and control for the for the users, machines and their storage. The New/Open/Search handles include User, User Group, Machine, Machine Group, Access Control, Privileges (Data, Application, Machines) and Distributed Storage. The Associate user handle enables setting up relationships and access structures among Users, User Groups, Machines, Machine Groups and Privileges.

Each user and the owner of the group, from this point onwards can grant read/write access to the content created by them to any of the users and the groups defined in the system. Such information is available throughout the system and it is used to efficiently transmit objects between peers or from the remote storage. Each of the users has the ability to store the data (objects) on their local storage or at the remote storage assigned to them by the administrator. This provides the means for the users to store the data for access by other users and groups that have the privilege, to access the data from the remote storage even if the owner of the data is not online.

The Edit User Interface Handles include Attribute/Properties and Associations. The Attributes/Properties include User, User Group, Machine, Machine group, Access Control, Privileges (Data, Application, Machines) and Distributed Storage. The Associations include Users, User Groups, Machine, Machine Groups and Privileges.

The FIG. 35 shows the relationships between the Admin and Access User Interface Handles and the Admin Structures or Commands categories in a matrix form. It describes which operations (User Interface Handles) are permitted on different Admin Structures or Commands categories. The File and Edit operations can be performed on all of the Admin and Access Structures or Commands categories including Admin, User. Group, Machine, Machine Group, Access Control, Privileges (Data, Machine, and Applications), Storage and Associations.

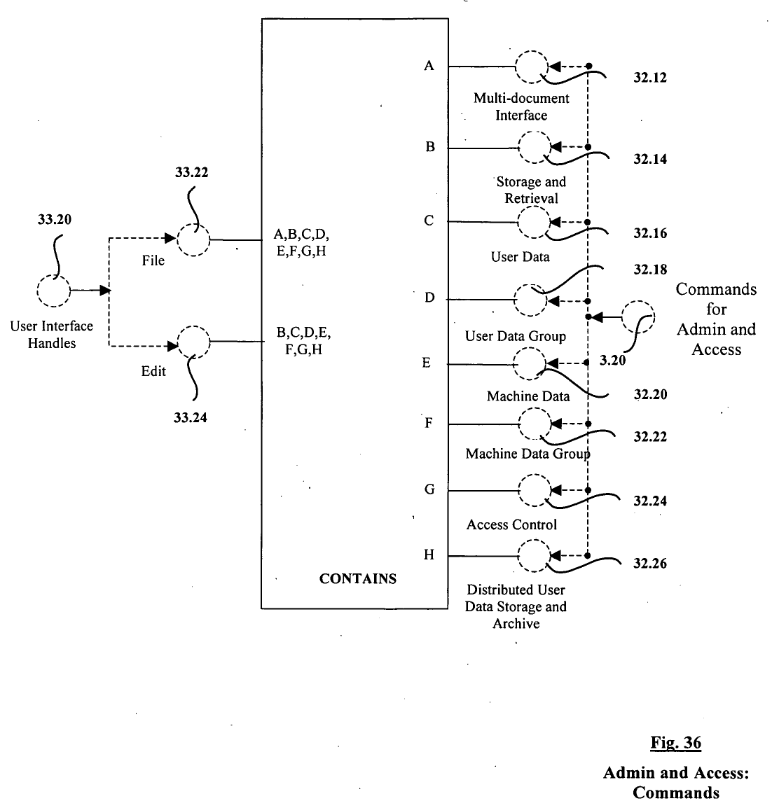

The FIG. 36 maps the Admin and Access User Interface Handles and Admin and Access Structures or Commands categories. It describes which operations such as File and Edit are applicable to various structures or Commands categories like Multi-document Interface, Storage and Retrieval, User Data, User Data Group, Machine Data, Machine Data Group, Access Control and Distributed User Data Storage and Archive. These commands categories are labeled A through H. These commands can be received from the Admin and Access Backend or from other application via the Transaction client Router where users or groups may create further levels of abstractions of Dynamic groups and further associate access and Priviliges to the Dynamic Groups. The File operations can be performed on all A through H command categories. The Edit operations can only be performed on B through H commands categories.

Attach and Relate Application

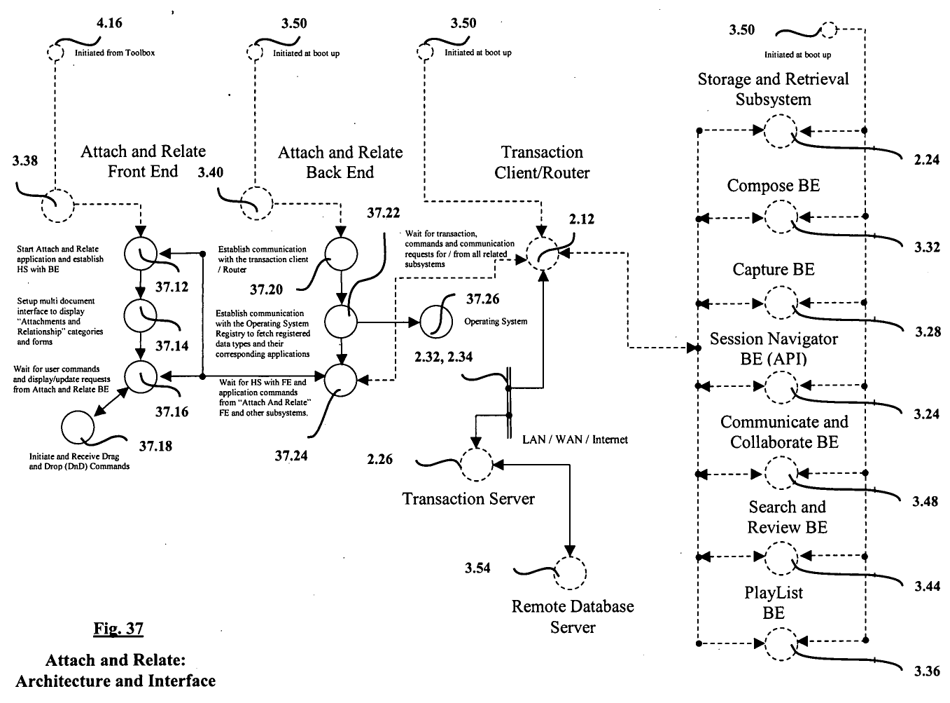

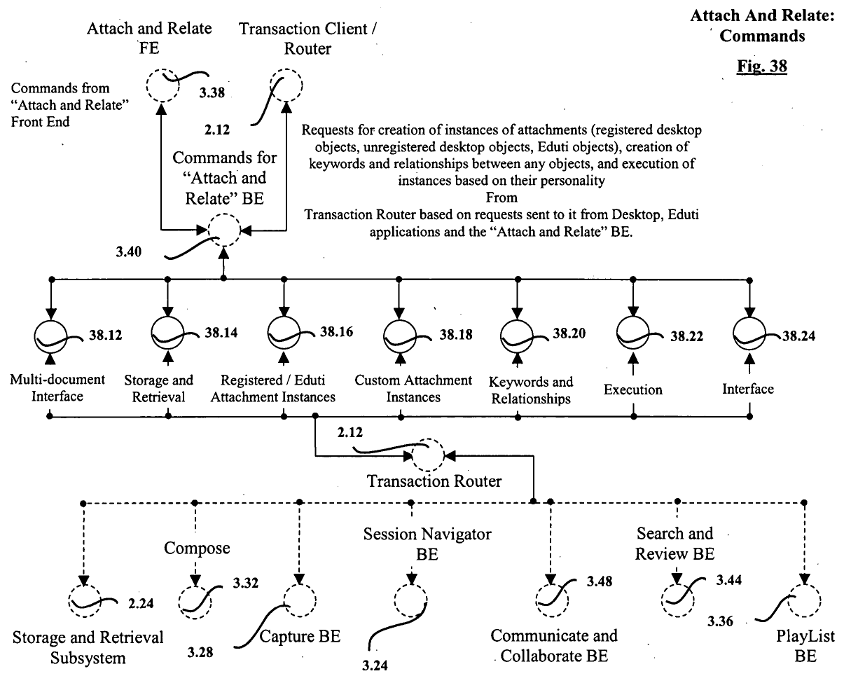

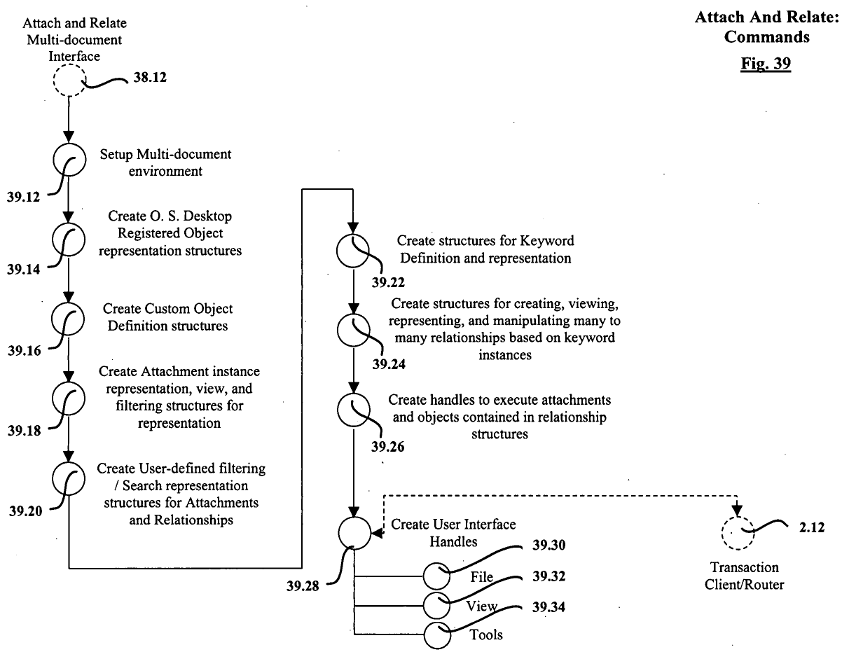

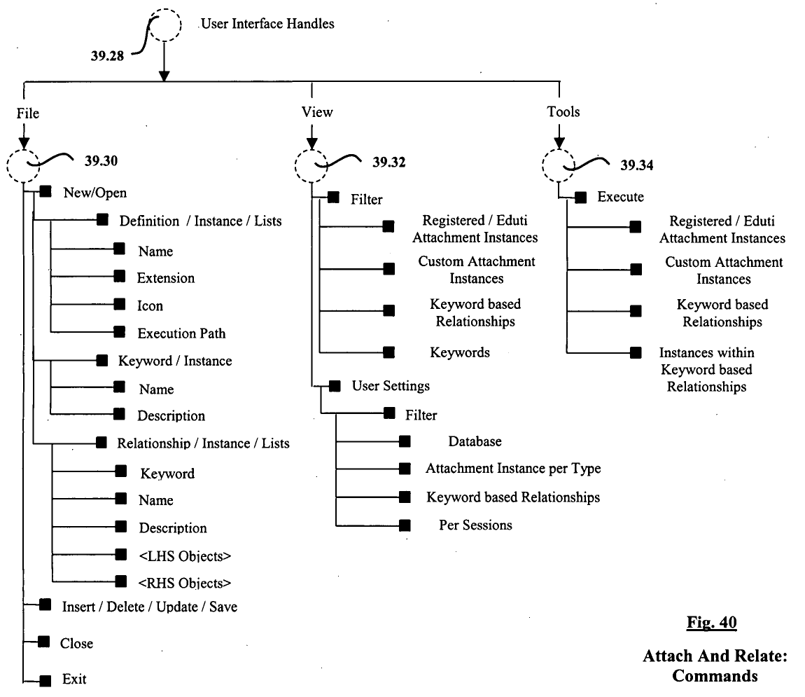

FIGS. 37 through 43 describe the client server architecture and the functional implementation of the Attach and Relate application. These figures also describe the commands and the operational flow of the functionality of the Attach and Relate application. The Attach and Relate application Front End (the client side modules) is started from the ToolBox (FIG. 37). The Back End of the Attach and Relate application (the client side modules) is started at the bootup time of the client PC along with the back ends of all other applications that comprise the EdUti suite of applications.

The Front-End modules of the Attach and Relate application, at the beginning establish a handshake with the Back-End modules of the Attach and Relate application. Following this process these modules set up the multi document interface to display “Attachment and Relationship” categories and forms. Subsequently, representation structures are created to register valid user interface objects that can be considered as drag and drop source objects or drag and drop destination objects for the Attach and Relate application Front-End module.

Once all the Attach and Relate application user interface components are built and a handshake is established with the Attach and Relate Back-End modules, the Attach and Relate Front-End goes into a steady state waiting for any requests from the user. The Attach and Relate application's Front-End may also get a display/update request from the Attach and Relate Back-End.

The Attach and Relate Back End is also setup to receive attachment and relationships requests from other application. If any attachment or relationship is made in the Compose application or in the Capture application or in the E-Book/Communicate and Collaborate application, the complete information regarding the source (the attachment/s), the target where the attachment/s are being made, the object member/s in a relationship and the form of the relationship are delivered to the Attach and Relate backend for processing. The Attach and Relate Back End sets up this information in the local and/or remote storage and then fires a display request to the Attach and Relate Front End. If the Attach and Relate Front End is not up and running, such a request is dropped. If the user executes the Attach and Relate Front End at any time, the most current state of Attachments, their hosts and relationships are made available to search and review. All the attachments and the relationships are also live objects with their unique identifiers and they are all available for anyone with the access and privileges to search and access.

The Back-End process of the Attach and Relate application, at its startup, first establishes a communication handshake with the Transaction Client/Router process. All applications, through their Back-End modules, communicate via the Transaction Client/Router process. All the objects in the EdUti system have the functionality to describe themselves. Whenever the Transaction Client/Router process gets a message regarding an object, it is able to query the object to determine the target application that can address the object. Based on this information the Transaction Client/Router routes the request, the object/s and the data to the appropriate application. Similarly the Transaction Client/Router process also delivers the status or returning data back to the requester.

Next, the Attach and Relate Backend establishes communications with the operating system registry to fetch registered data type and their corresponding applications. This provides the capability to understand the execution environment of all the Desktop objects and the ability to attach and relation EdUti as well as any desktop object with each other.

Finally the Attach and Relate application Back-End waits for a handshake request from the Attach and Relate Front and application commands from “Attach and Relate” front end and other subsystems via the Transaction Client/Router. If the Attach and Relate application Back-End receives a request via the Transaction Client/Router to execute a Attach and Relate command from another application, (and at that time if it has not already established a handshake with the Attach and Relate application Front-End), it first starts up the Attach and Relate application Front-End and then delivers it the command for execution. Following each such request or command, either by the Attach and Relate Front-End or by the Transaction Client/Router, it attempts to fulfill such request and then goes back into a wait state for subsequent requests or commands.

Attach and Relate application Back-End sends all the communications to the Remote Database Server via the LAN/WAN/Internet, through the Transaction Client/Router. It also communicates via LAN/WAN and the Internet to the Remote Database Server via the Transaction Server. The commands delivered by the Attach and Relate Application Front-End (FIG. 38), by the Transaction Client/Router for the Attach and Relate Application Back-End and the commands executed by the Attach and Relate application Back-End are categorized as follows: Multi-document Interface, Storage and Retrieval, Registered/EdUti Attachments Instances, Custom Attachment Instances, Keywords and Relationships, Execution, and Interface.

All commands including Mult-document Interface, Storage and Retrieval, Registered/EdUti Attachments Instances, Custom Attachment Instances, Keyword and Relationships, Execution and Interface are routed through the Transaction Router to the appropriate application backend and/or to the Storage and Retrieval Subsystem.

The Attach and Relate Backend processes requests for creation of instances of attachments (registered desktop objects, unregistered desktop objects, EdUti objects), creation of keywords and relationships between any objects, and execution of instances based on their personality from the Transaction Router based on requests sent to it from Desktop, EdUti application and the “Attach and Relate” Backend.

The Multi-document Interface as shown in FIG. 39, sets up the Multi-document environment by creating Operating System (O.S) Desktop Registered Object representation structures, creating custom Object Definition structures, creating Attachment instance representation, view and filtering structures for representation, creating User-defined filtering/Search representation structures for Attachments and Relationships, creating structures for Keyword Definition and representation, creating structures for creating, viewing, representing, and manipulating many to many relationships based on keyword instances, creating handles to execute attachments and objects contained in relationship structures and creating User Interface Handles.

The User Handle Interface communicates to the appropriate application to send and receive requests via the Transaction Client/Router. The User Interface Handles sets up user commands for File, View and Tools operations. FIG. 40 describes the details of the User Interface Handles for File, View and Tools operations.

The File User Interface Handles include New/Open, Insert/Delete/Update/Save, Close and Exit. These commands create, edit and modify attachments and relationships. The New/Open user handle includes “Relationship Definitions/Instances/Lists”, “Keyword/Instance” and “Relationship/Instance/Lists”. The Definition/Instances/Lists provides the functionality to include Name, Extension, Icon and Execution Path of an application that may not have registered with the operating system. For those applications that have registered with the Operating System, this information is picked up from the System registry. For others the Attach and Relate application provides the functionality to define such information.

Once this information is known to Attach and Relate, the users can treat the application as any other registered with the Operating System and include it and its data to create and use for attachments and relationships. The users can create any number of instances based on a definition and then giving then names as they see fit. The “Keyword/Instance” includes Name and Description. Many relationships can be created based on few templates. For example a keyword “Must review” may have many objects created on both sides of the keyword and by giving it a name the users can create many “Must Review” relationships. Each such relationship therefore becomes unique by its data and the instance name. The “Realtionship/Instance/Lists” further includes Keyword, Name, Description, <LHS Objects> and <RHS Objects> Each such relationship or instance is uniquely identifiable across the system and there it is also a candidate for Search.

The View User Handles include Filter and User Settings. These commands enable the user to set filters for custom viewing of the Attach and Relate objects. The Filter User Handle includes Registered/EdUti Attachment Instances, Custom Attachment Instances, Keyword based Relationships and Keywords. The User Setting Handle includes the Filter which further includes Database, Attachment Instance per Type, Keyword based Relationships and Per Sessions. This provides the users with complete flexibility to search for any domain of objects based on objects themselves or based on relationships.

The Tools User Handle includes Execute. These commands enable the user to execute Attach and Relate Objects. The Execute User Handle includes Registered/EdUti Attachment Instances, Custom Attachment Instances, Keyword based Relationships and Instances within Keyword based Relationships. Since each object has all the information regarding its context, the execution process becomes as simple as sending the object to the Transaction client Router and the object finds its way to the application that can execute it. Same is true for all the desktop objects included in the relationships. The relationships themselves are treated as objects so they can be included in sessions to further annotate the captured or organized content.

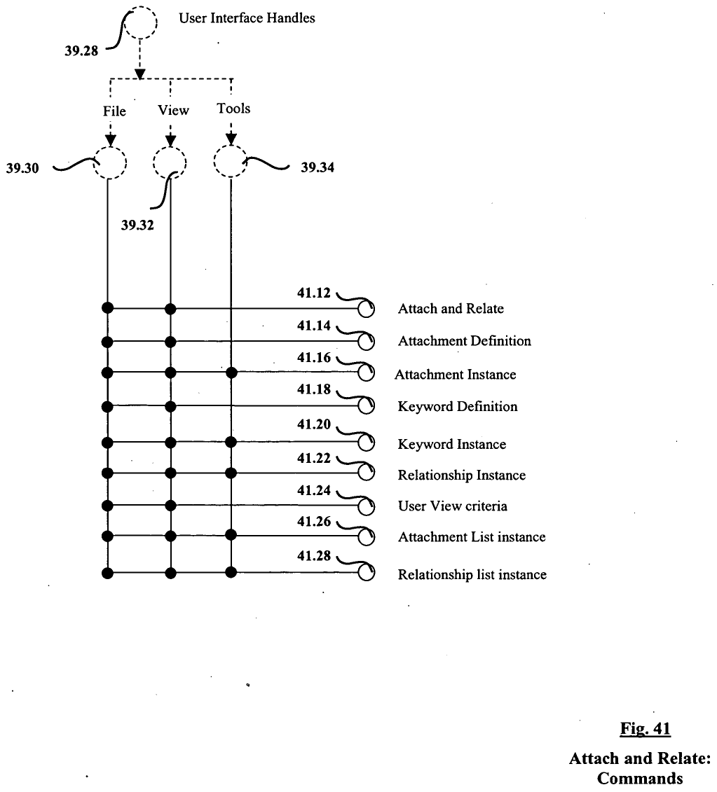

FIG. 41 shows the relationships between the Attach and Relate User Interface Handles and the Attach and Relate command categories in a matrix form. It describes which operations (User Interface Handles) are permitted on different Attach and Relate objects based on the command categories. The File and View operations can be performed on all of the Attach and Relate Command categories including Attach and Relate, Attachment Definition, Attachment Instance, Keyword Definition, Keyword Instance, Relationship Instance, User View criteria, Attachment List instance and Relationship List instance. The Tools operations can only be performed on Attachment Instance, Keyword Instance, Relationship Instance, Attachment List instance and Relationship List instance.

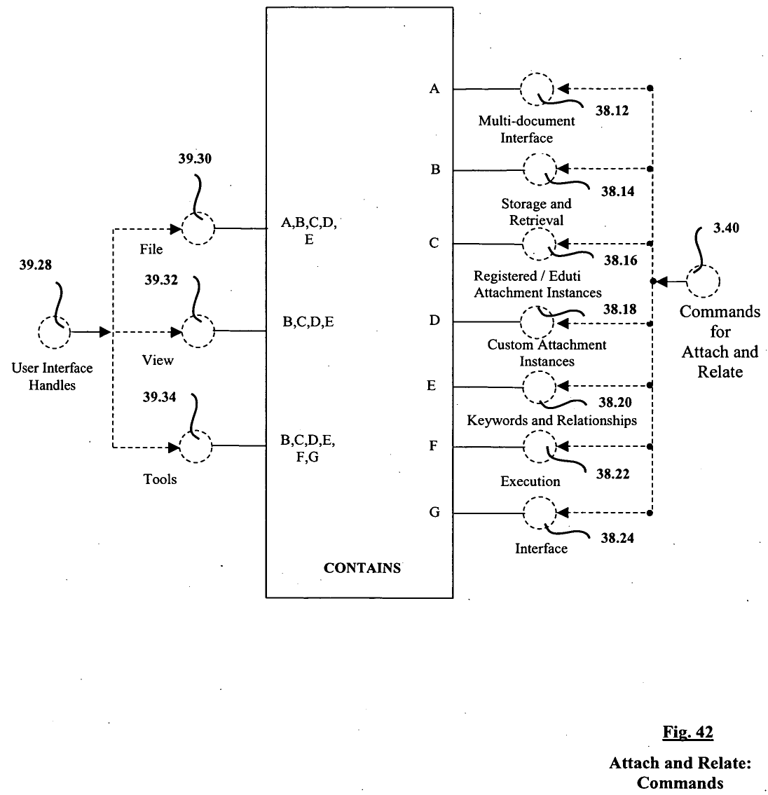

FIG. 42 maps the Attach and Relate User Interface Handles and Attach and Relate Commands categories. It describes which operations such as File, View and Tools are applicable to various Commands categories like Multi-document Interface, Storage and Retrieval, Registered/EdUti Attachment Instances, Custom Attachment Instances, Keywords and Relationships, Execution and Interface. These command categories are labeled A through G. All these commands are received from the Attach and Relate Backend. The File operations can be performed on A, B, C, D and E. The View operations can be performed on B, C, D and E. The Tools operations can be performed on B, C, D, E, F and G.

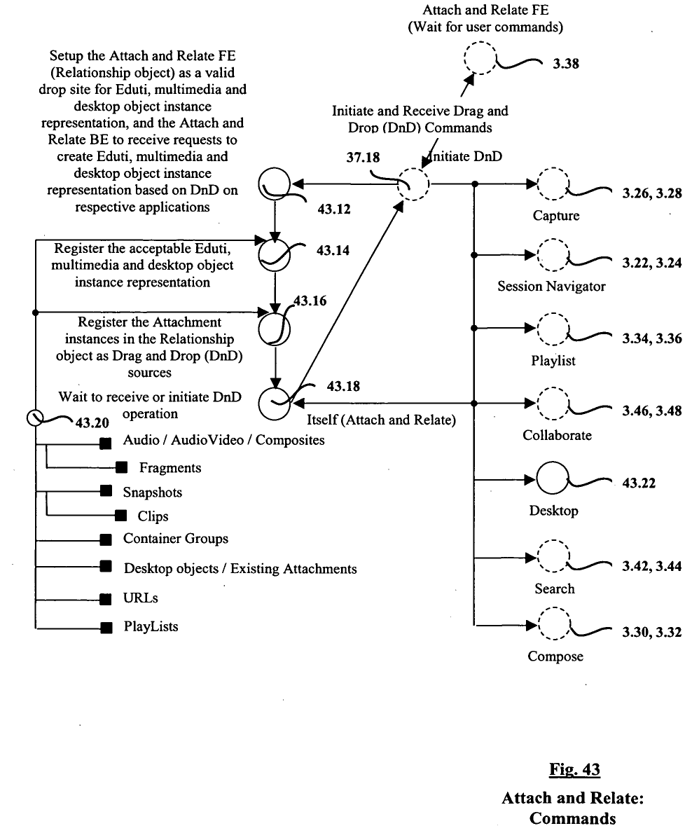

FIG. 43, the Attach and Relate Front-end after initiating the Drag and Drop (DnD) commands, waits for user commands. The Initiate and Receive Drag and Drop (DnD) commands sets up the Attach and Relate Front-end (Relationship Object) as a valid drop site for EdUti, multimedia and desktop object instance representation and the Attach and Relate Backend (BE) to receive requests to create EdUti, multimedia and desktop object instance representation based on DnD on respective applications. It registers the acceptable EdUti, multimedia and desktop object instance representation, registers the Attachment instances in the Relationship object as Drag and Drop (DnD) sources, and waits to receive or initiate DnD operations. The EdUti, multimedia and desktop objects can be of several types including Audio/AudioVideo/Composite or their fragments, Snapshots including Clips, Container Groups, Desktop objects/Existing Attachments, URLs, PlayLists and E-Book including all the objects created in the E-Book. The user can drag and drop objects among and within any of the EdUti applications such as Capture, Session Navigator, PlayList, Collaborate, Desktop, Search, E-Book and Compose.

Search and Review Application

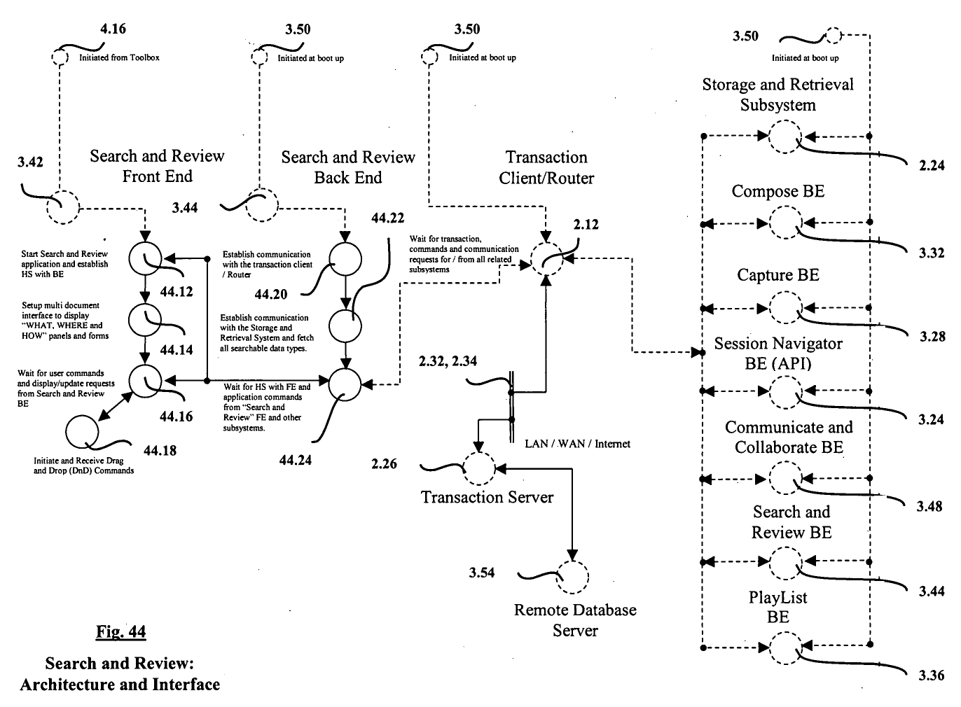

FIGS. 44 through 50 describe the client server architecture and the functional implementation of the Search and Review application. These figures also describe the commands and the operational flow of the functionality of the Search and Review application. The Search and Review application Front End (the client side modules) is started from the ToolBox (FIG. 44). The Back End of the Search and Review application (the client side modules) is started at the boot up time of the client PC along with the back ends of all other applications that comprise the EdUti suite of applications.

The Front-End modules of the Search and Review application, at the beginning establish a handshake with the Back-End modules of the Search and Review application. Following this process these modules set up the multi document interface to display “WHAT, WHERE and HOW” panels and forms. Subsequently, representation structures are created to register valid user interface objects that can be considered as drag and drop source objects or drag and drop destination objects for the Search and Review application Front-End module.

Once all the Search and Review application user interface components are built and a handshake is established with the Search and Review Back-End modules, the Search and Review Front-End goes into a steady state waiting for any requests from the user. The Search and Review application's Front-End may also get a display/update request from the Search and Review Back-End.

The Back-End process of the Search and Review application, at its startup, first establishes a communication handshake with the Transaction Client/Router process. All applications, through their Back-End modules, communicate via the Transaction Client/Router process. All the objects in the EdUti system have the functionality to describe themselves. Whenever the Transaction Client/Router process gets a message regarding an object, it is able to query the object to determine the target application that can address the object. Based on this information the Transaction Client/Router routes the request, the object/s and the data to the appropriate application. Similarly the Transaction Client/Router process also delivers the status or returning data back to the requestor. Next, the Search and Review Backend establishes communications with the Storage and Retrieval System and fetches all searchable data types.

Finally the Search and Review application Back-End waits for a handshake request from the Search and Review Front and application commands from “Search and Review” front end and other subsystems via the Transaction Client/Router. If the Search and Review application Back-End receives a request via the Transaction Client/Router to execute a Search and Review command from another application, (and at that time if it has not already established a handshake with the Search and Review application Front-End), it first starts up the Search and Review application Front-End and then delivers it the command for execution. Following each such request or command, either by the Search and Review Front-End or by the Transaction Client/Router, it attempts to fulfill such request and then goes back into a wait state for subsequent requests or commands.

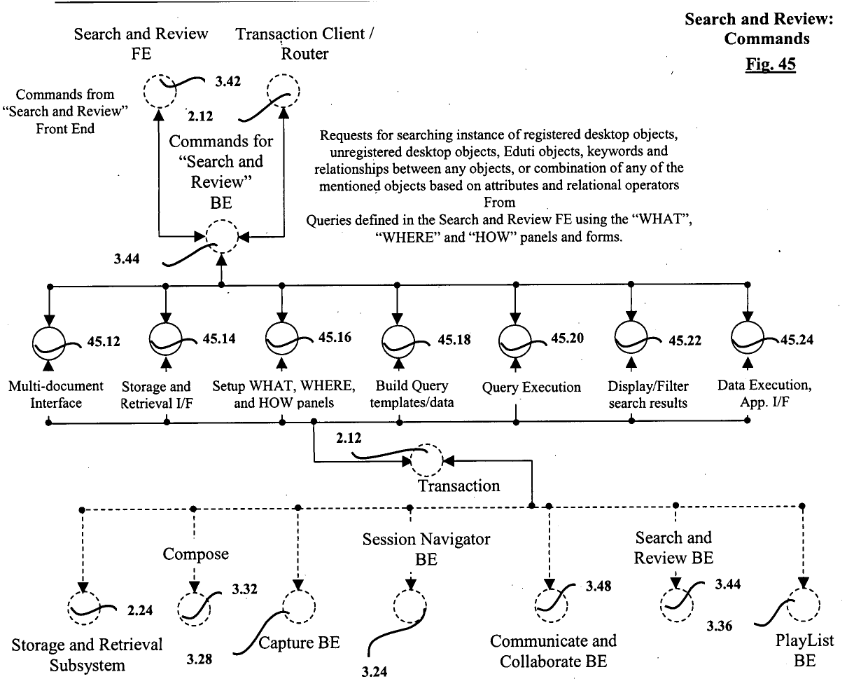

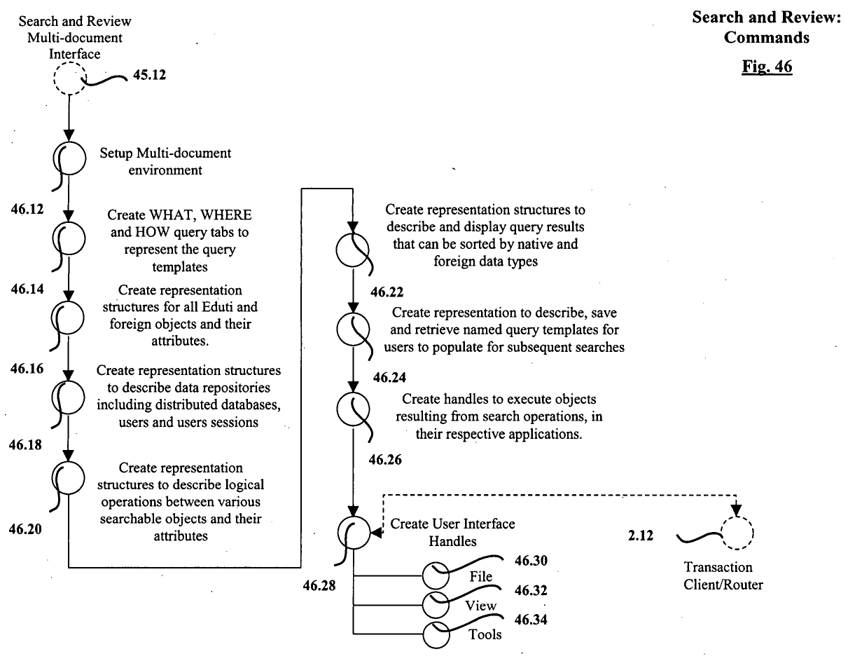

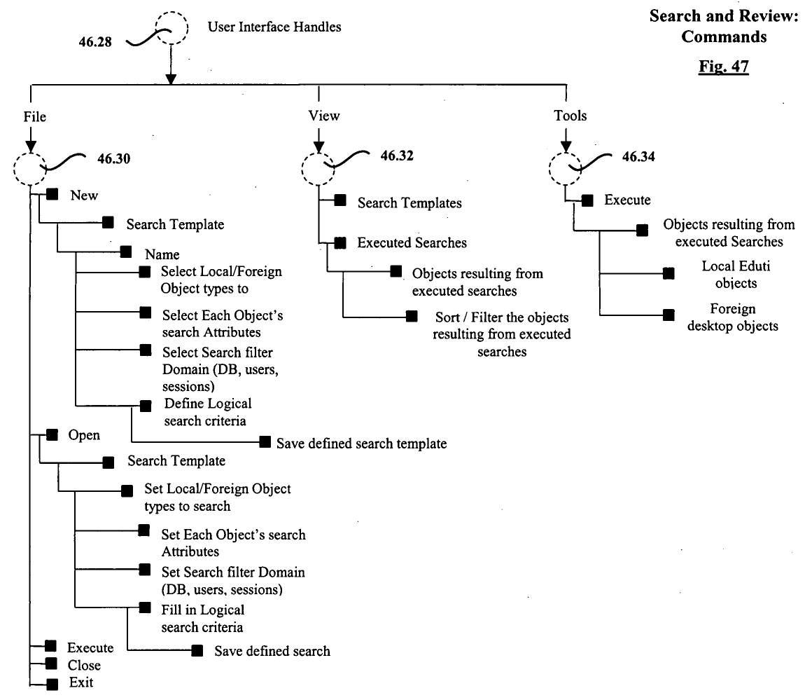

Search and Review application Back-End sends all the communications to the Remote Database Server via the LAN/WAN/Internet, through the Transaction Client/Router and the Transaction Server. The commands delivered by the Search and Review Application Front-End (FIG. 45), by the Transaction Client/Router for the Search and Review Application Back-End and the commands executed by the Search and Review application Back-End are categorized as follows: Multi-document Interface, Storage and Retrieval I/F, Setup WHAT, WHERE and HOW panels, Build Query templates/data, Query Execution, Display/Filter search results, and Data Execution, Application (App) interface (I/F).

All commands including Multi-document Interface, Storage and Retrieval I/F, Setup WHAT, WHERE and HOW panels, Build Query templates/data, Query Execution, Display/Filter search results, and Data Execution, Application I/F are routed through the Transaction Client/Router to the appropriate application backend and/or to the Storage and Retrieval Subsystem. The Search and Review Backend receives requests for searching instances of registered desktop objects, unregistered desktop objects, EdUti objects, keywords and relationships between any objects, or combination of any of the mentioned objects based on attributes and relational operators from queries defined in the Search and Review Front-end using the “WHAT”, ‘WHERE’, and ‘HOW’ panels and forms.

The Multi-document Interface as shown in FIG. 46, sets up the Multi-document environment by creating: WHAT, WHERE and HOW query tabs to represent the query templates, representation structures for all EdUti and foreign objects and their attributes, representative structures to describe data repositories including distributed databases, users and users sessions, representation structures to describe logical operations among various searchable objects and their attributes, representation structures to describe and display query results that can be sorted by native and foreign data types, representative to describe, save and retrieve named query templates for users to populate for subsequent searches, and handles to execute objects resulting from search operations in their respective applications and creating User Interface Handles. The User Interface Handles communicates to the appropriate application to send and receive requests via the Transaction Client/Router. The User Interface Handles set up user commands defined in the File, View and Tools command categories.

FIG. 47 describes the details of the User Interface Handles for File, View and Tools operations. The File User Interface Handles include New, Open, Execute, Close and Exit commands. These commands allow the user to create, edit, execute, close and exit Search templates that can be used subsequently to rapidly generate queries by simple drag and drop operations from any of the EdUti applications. The New User Interface Handle includes Search Template. The Search Template includes Name which further includes Select Local/Foreign Objects types; Select each object's search Attributes, Select Search filter Domain (DB, Users, Sessions) and Define Logical Search Criteria. The Define Logical Search Criteria includes Save that allows the users to save a template for subsequent use.

The View User Interface Handles include Search Templates and Executed Searches. The View commands enable the user to customize the display of Search Templates, Forms and the results of executed searches. The Executed Searches includes Objects resulting from executed searches and Sort/Filter the objects resulting from executed searches. These objects can be executed directly from the results of the Search and the user can then follow the object thread from its respective application or further refine the search by using the objects resulting from the search.

The Tools User Handle includes Execute. These commands enable the user to execute Objects received as a result of a “Search and Review” query execution. The Execute User Handle includes Objects resulting from executed Searches which further include Local EdUti objects and foreign desktop objects.

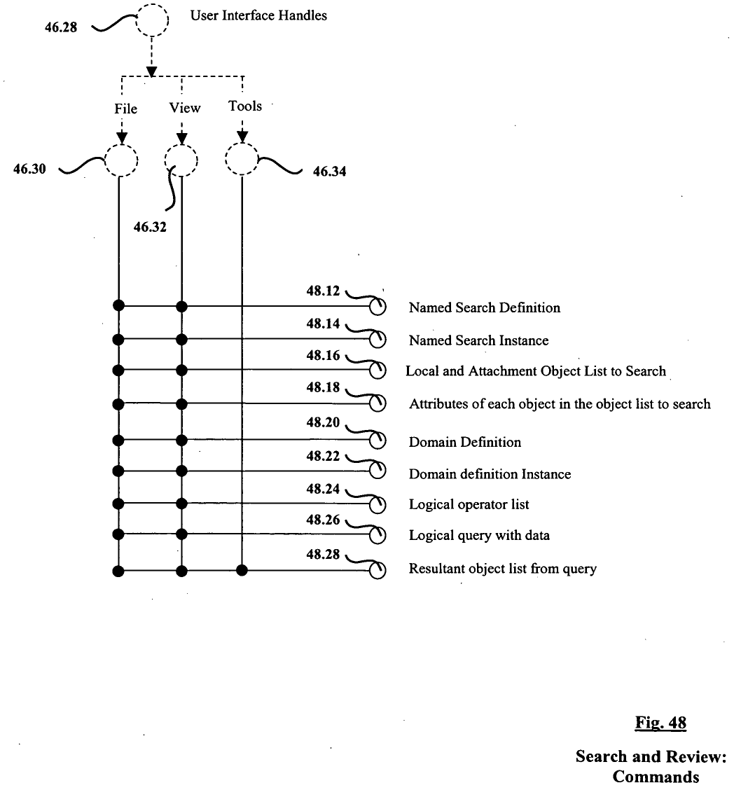

FIG. 48 shows the relationships between the Search and Review User Interface Handles and the Search and Review objects in a matrix form. It describes which operations (User Interface Handles) are permitted on different Search and Review objects. The File and View operations can be performed on all of the Search and Review Objects including Named Search Definition, Named Search Instance, Local and Attachment Object List to Search, Attributes of each object in the object list to search, Domain Definition, Domain Definition Instance, Logical operator list, Logical query with data and Resultant object list from query. The Tools operations can only be performed on Resultant object list from the query.

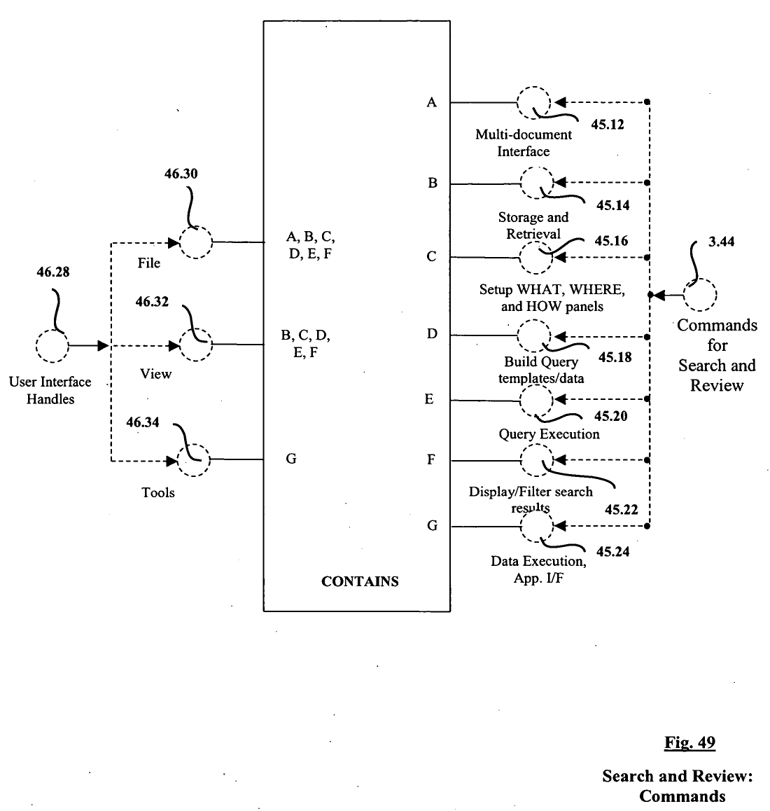

FIG. 49 maps the Search and Review User Interface Handles and Search and Review Commands. It describes which operations such as File, View and Tools are applicable to various Command categories like Multi-document Interface, Storage and Retrieval, Setup WHAT, WHERE and HOW panels, Build Query templates/data, Query Execution, Display/Filter search results and Data Execution Application I/F. These commands are labeled A through G. The commands are received from the Search and Review Backend and then passed ob to specific applications with an interface to the query engine. The File operations can be performed on A, B, C, D and E. The View operations can be performed on B, C, D, E and F. The Tools operations can be performed on only G.

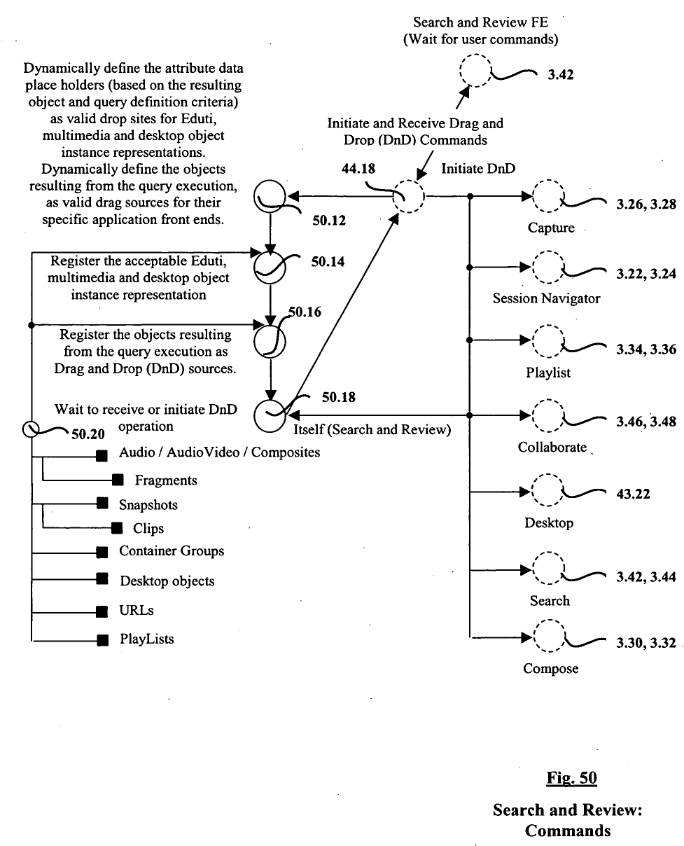

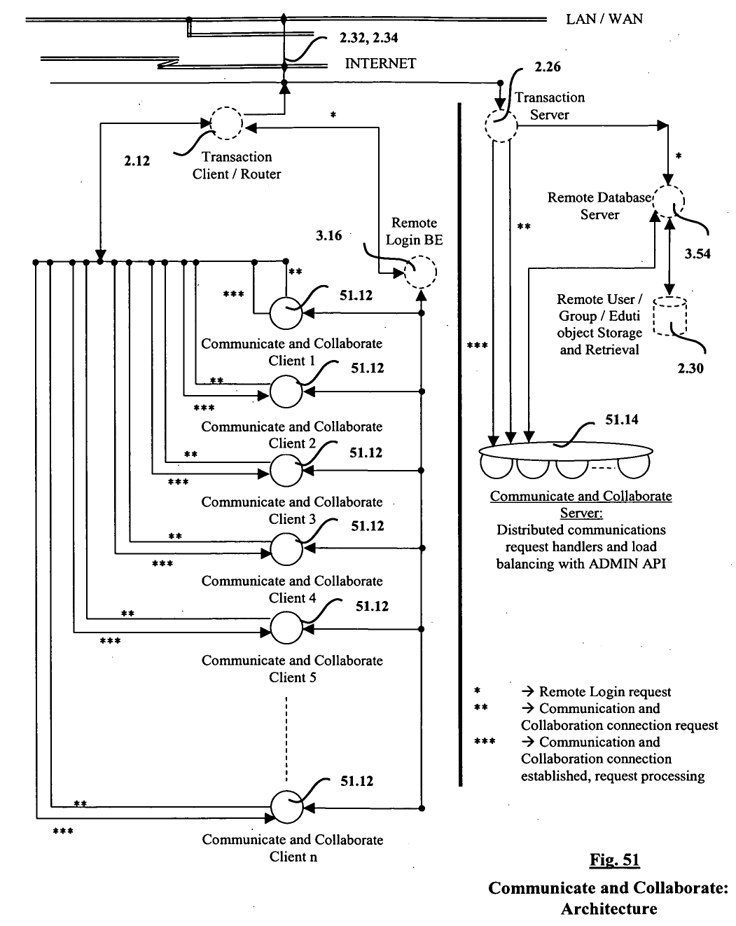

In FIG. 50, the Search and Review Front-end after initiating the Drag and Drop (DnD) commands, waits for user commands. The Initiate and Receive Drag and Drop (DnD) commands dynamically defines the attribute data place holders (based on the resulting object and query definition criteria) as a valid drop site for EdUti, multimedia and desktop object instance representations, registers the acceptable EdUti, multimedia and desktop object instance representations, registers the objects resulting from the query execution as Drag and Drop (DnD) sources, and waits to receive or initiate DnD operations. The EdUti, multimedia and desktop objects can be of several types including Audio/AudioVideo/Composite or their fragments, Snapshots including Clips, Container Groups, Desktop objects, URLs, E-Books and its contained objects and PlayLists. The user can drag and drop objects among any opened Search and Review template instances and from other applications such as Capture, Session Navigator, PlayList, Communicate and Collaborate, Desktop, E-Book, Search itself and Compose.

Communicate and Collaborate Application

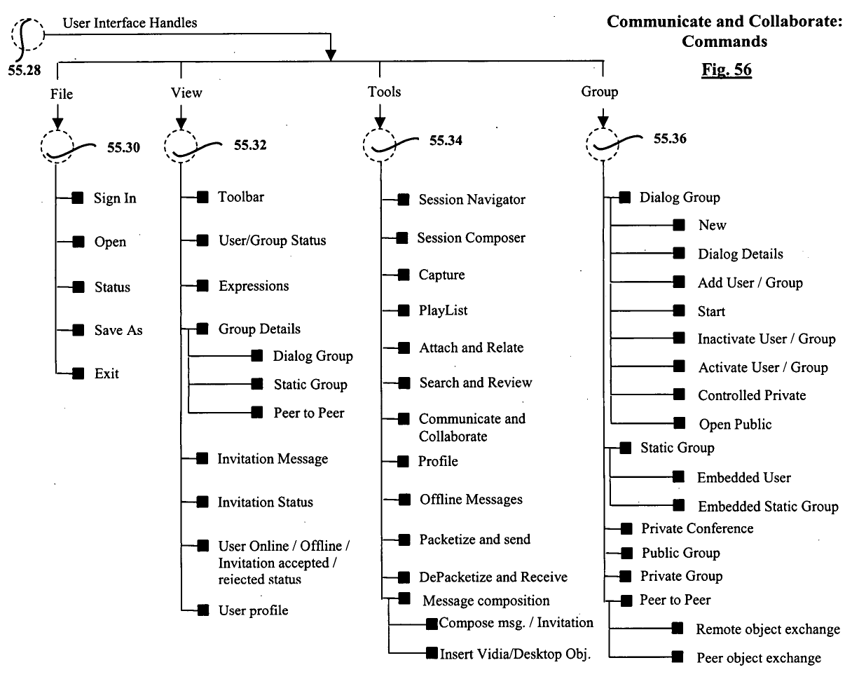

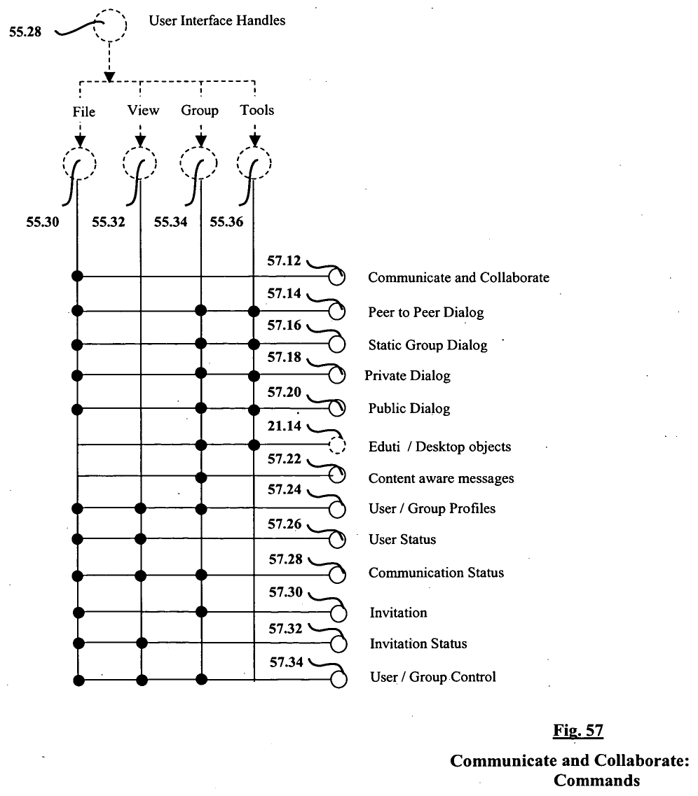

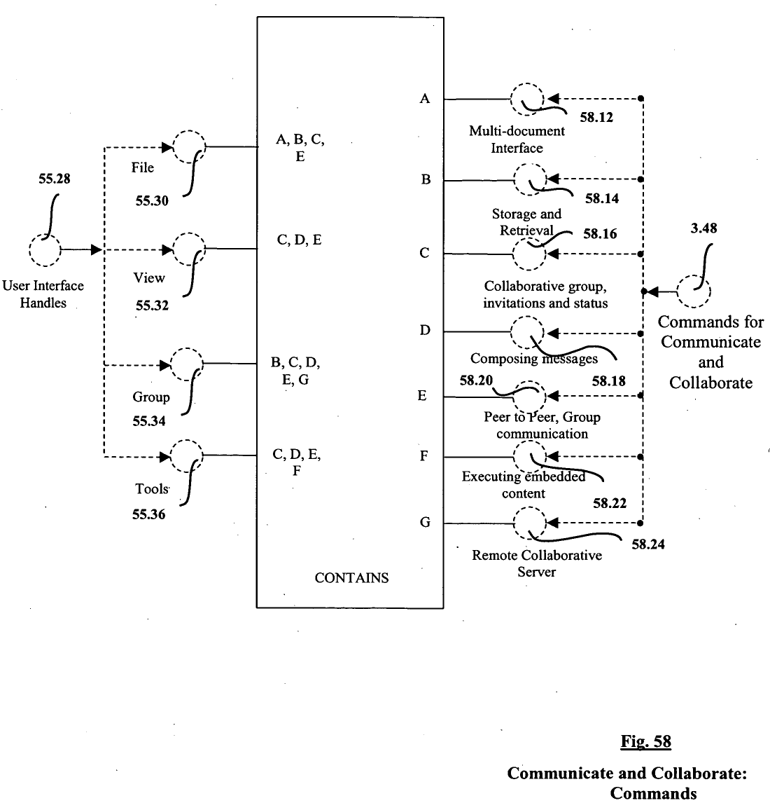

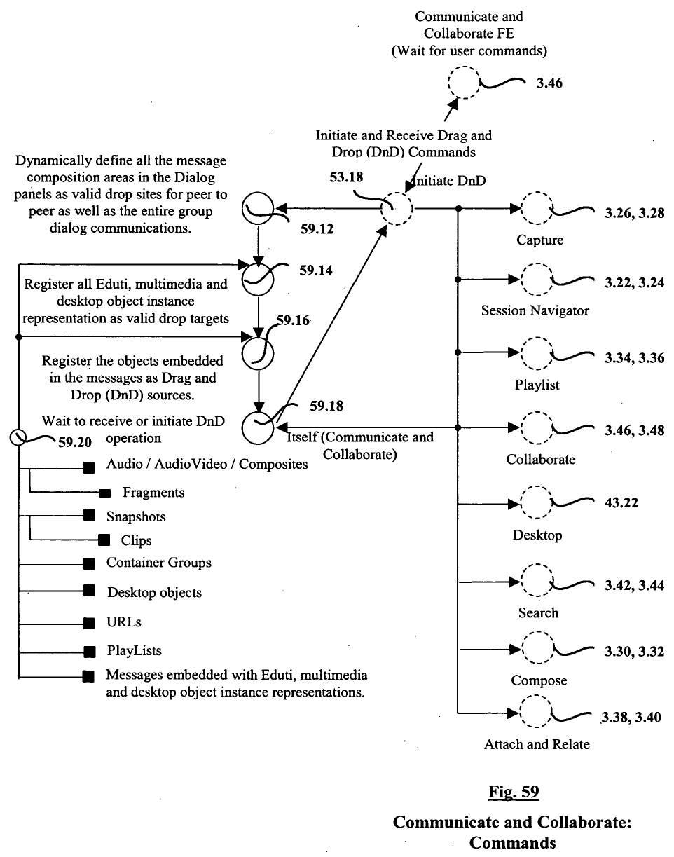

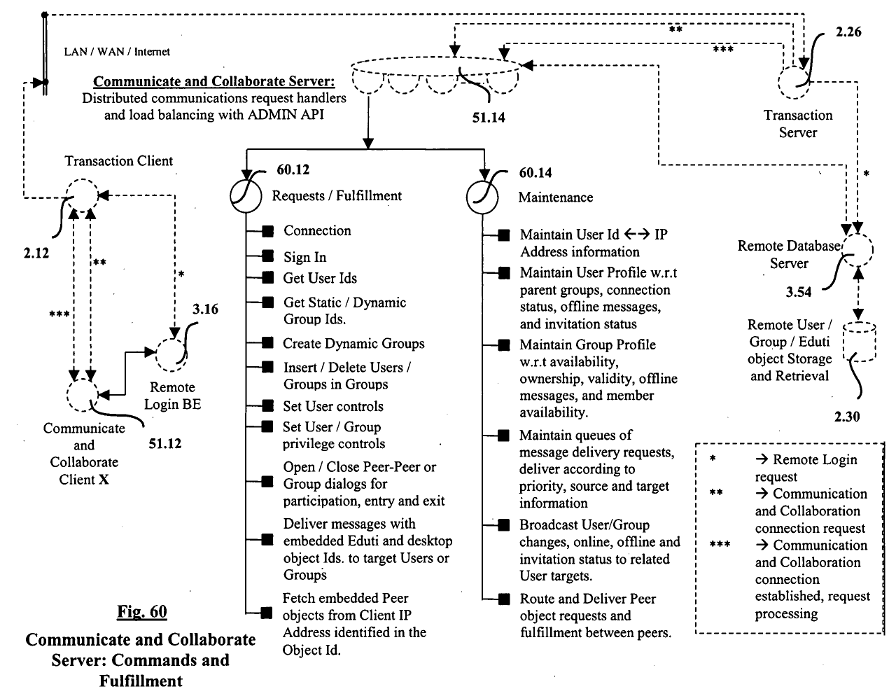

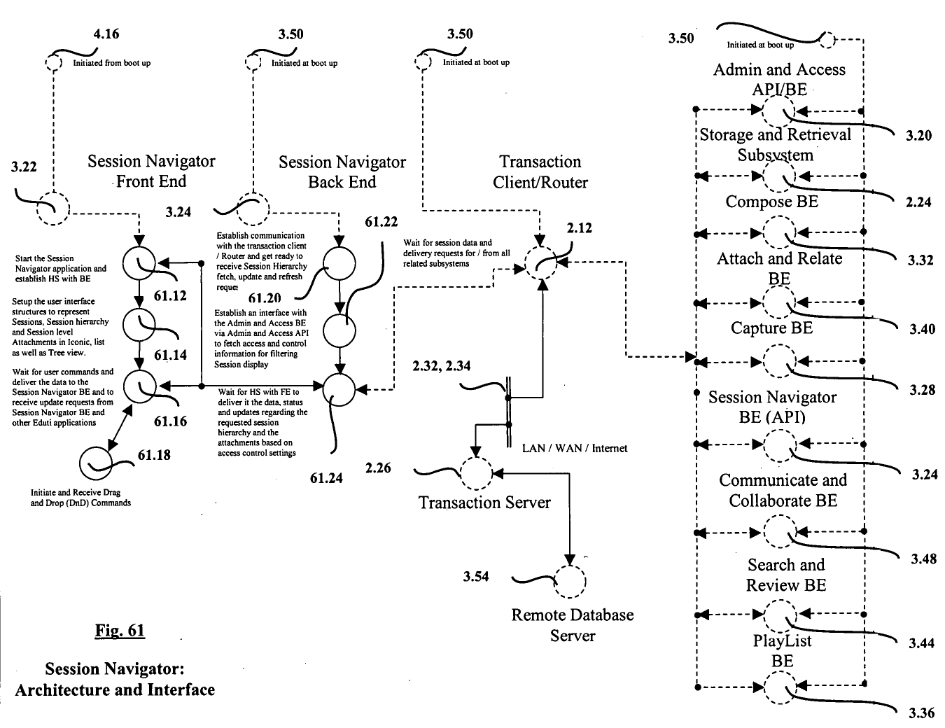

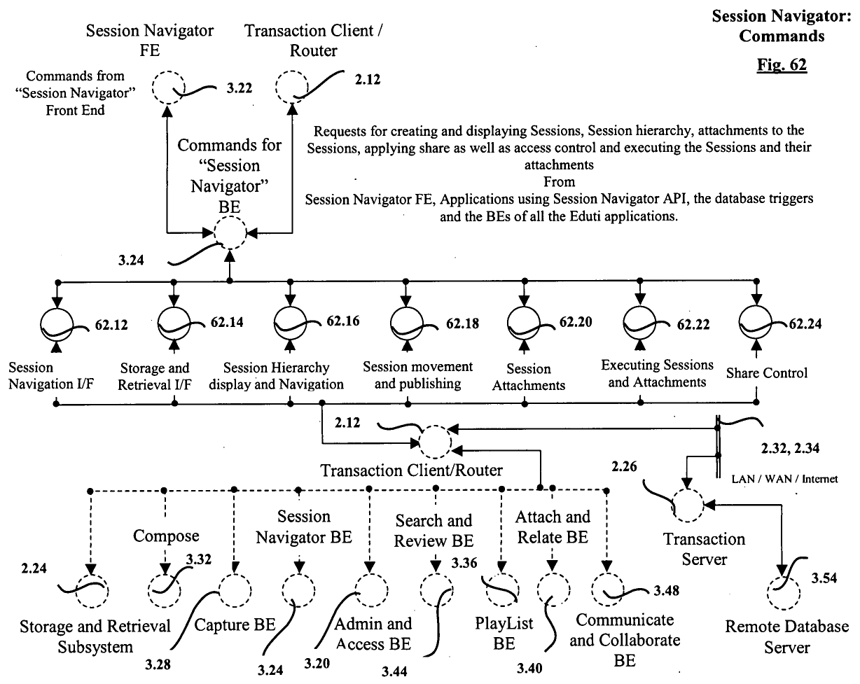

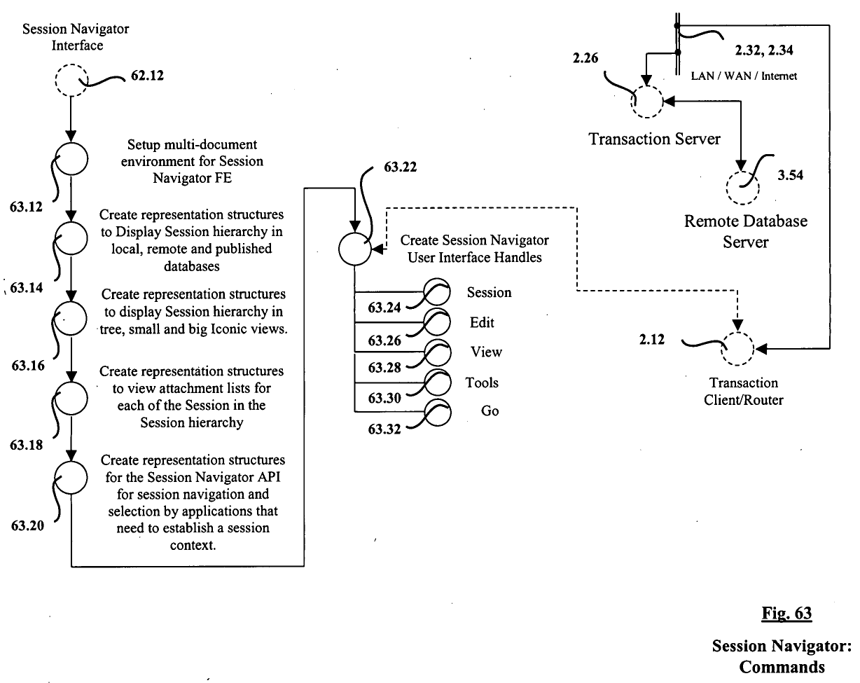

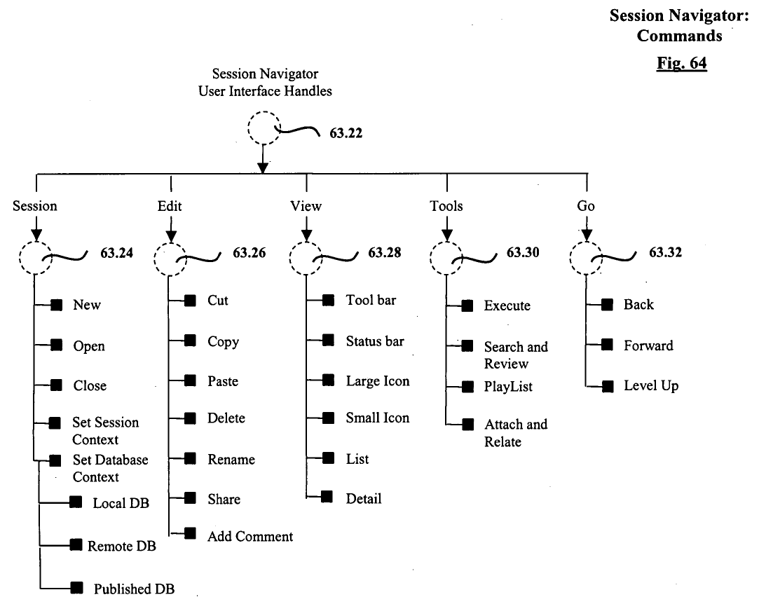

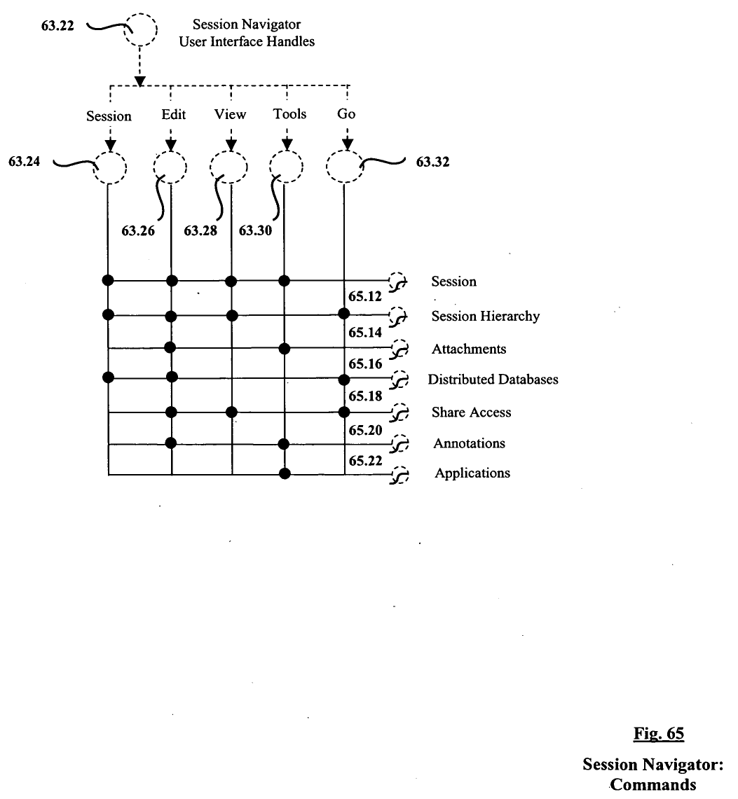

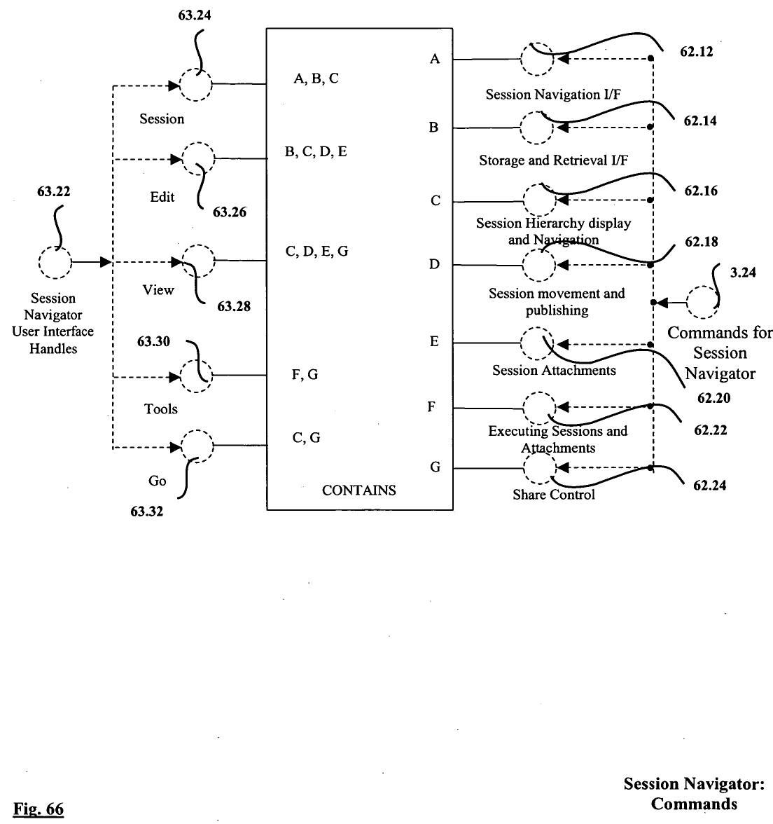

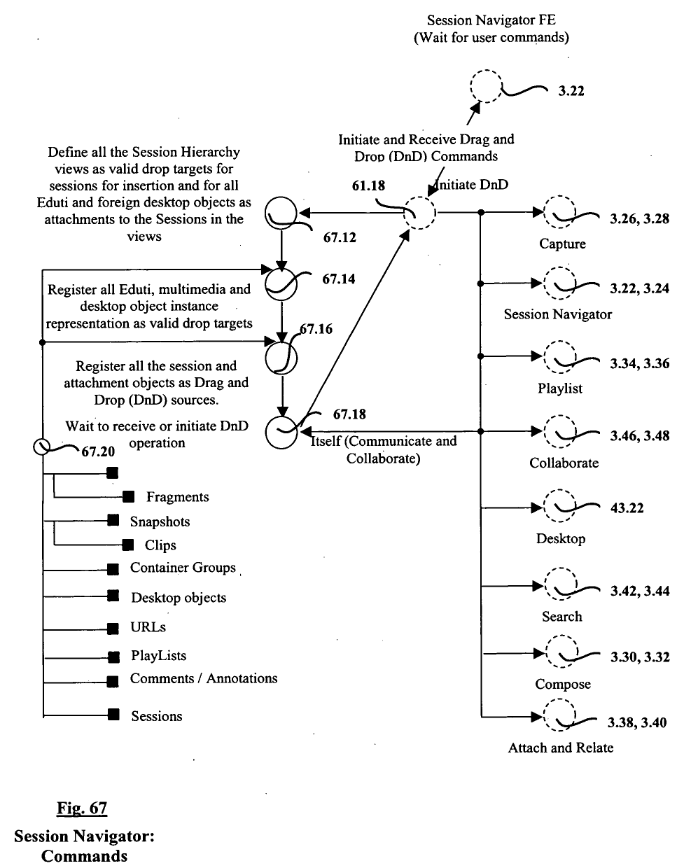

FIGS. 51 through 60 describe the client server architecture and the functional implementation of the Communicate and Collaborate application. These figures also describe the commands and the operational flow of the functionality of the Communicate and Collaborate application. The Communicate and Collaborate application Architecture (FIG. 51) describes the overall architecture of the Communicate and Collaborate application. The Communicate and Collaborate application can operate independently or it can operate in conjunction with the rest of the applications of the EdUti suite of applications. The Communicate and Collaborate applications are made up of the Server side of the applications and the Client side of the applications.

The Server side of the Communicate and Collaborate application is composed of one or more Communicate and Collaborate Servers that maintain a complete set of information with respect to the Users, User Groups (Static or Dynamic), the complete presence information of the users and the groups in terms of their hosts, login status, membership in the dynamically or statically created groups, and availability. The Server side of the Communicate and Collaborate application is also made up of one or more FTP servers that facilitate desktop data transfers between users and user groups. FTP servers are also located on the Client side of the application to facilitate peer to peer desktop data transfers between those machines that have public IP addresses.

In addition to these server modules, the Communicate and Collaborate application is also made up of one or more Voice Proxy servers that facilitate a handshake and voice stream communication between the peers. The voice servers are also maintained on each client machine to facilitate voice stream communication between those machines that have public or reachable IP addresses. All the machines that are behind a proxy server or those that are behind a router (NATed) communicate the voice and desktop data via the FTP servers and the voice proxy servers located on the Server side of the Communicate and Collaborate application.

The Communicate and Collaborate clients communicate to the Communicate and Collaborate servers via the Transaction Client Router on the client machines and the Remote Login BE on the client machines. All the communication to the Server side of the Communicate and Collaborate application is done via the Transaction Server located on the Server side of the Communicate and Collaborate application. The Communicate and Collaborate server communicate with the Remote Storage sub-systems to authenticate the user and group details and all the details regarding the presence information of the users and their static or dynamic groups.

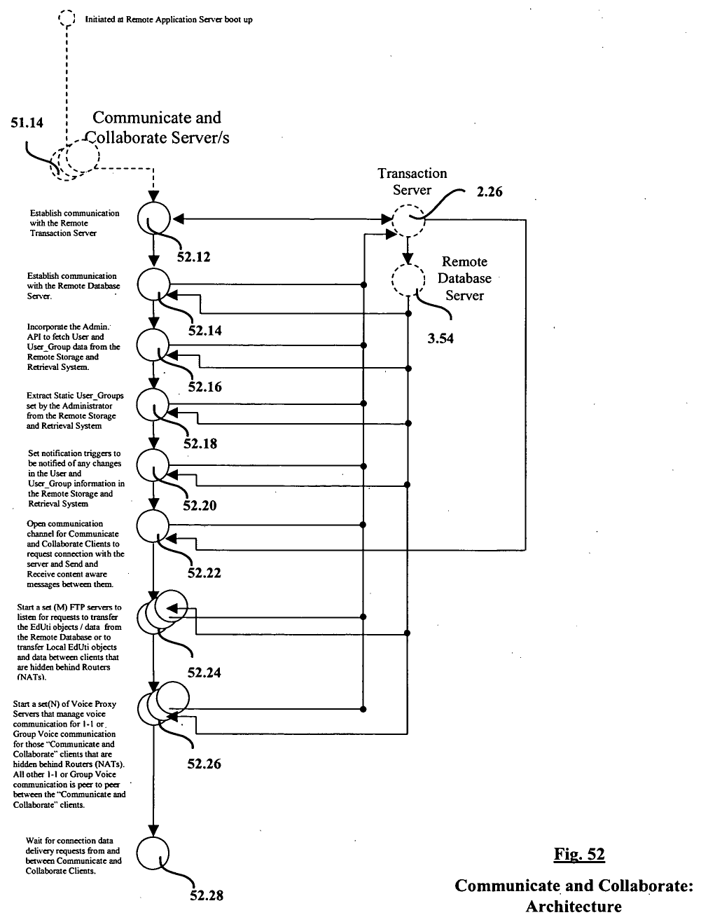

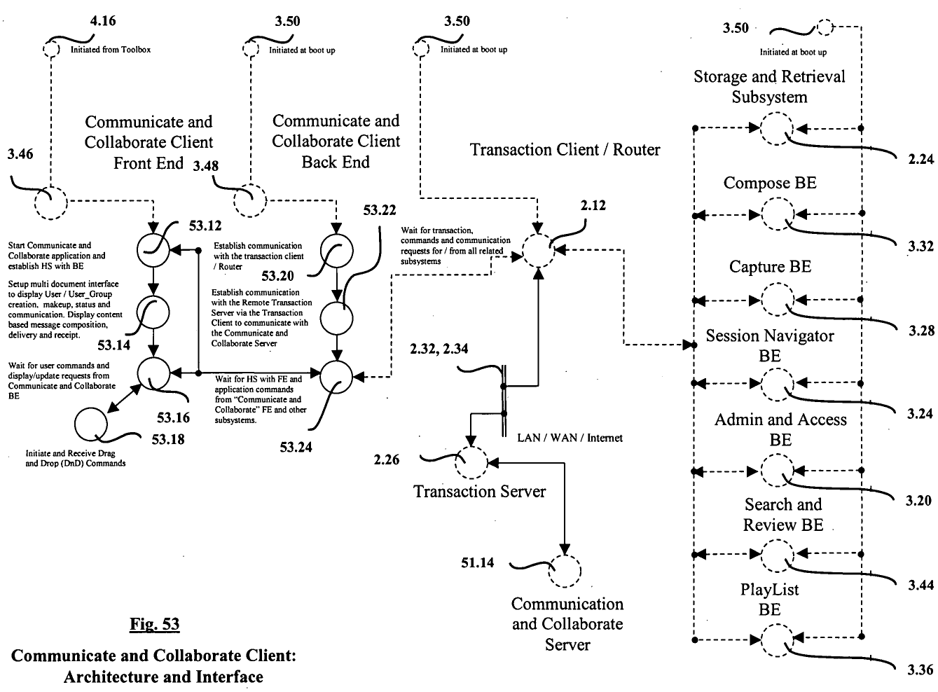

The Communicate and Collaborate Servers (FIG. 52) first establish a handshake with the Remote Transaction Server and the Remote Database Server. Each Communicate and Collaborate server incorporates the Admin API in order to fetch the User, User Group and the presence information from the Remote storage and Retrieval system. The Communicate and Collaborate server then sets all the notification triggers to be notified of any change in the User, User Group status and the presence information regarding them. Subsequently it opens a communication channel to solicit connection and data communication requests from the Communication and Collaborate Clients.

Next, the Communicate and Collaborate server initiates a set of FTP servers that solicit and fulfill data transfer requests from all those clients that cannot reach the peers directly. Next, the Communicate and Collaborate server initiates a set of Voice Proxy Servers that solicit and fulfill voice stream transfer requests from all those clients that cannot reach the peers directly. These Voice Proxy Servers also maintain information regarding all the voice communication that is occurring between the Communicate and Collaborate Clients, regardless of whether the voice communication is peer to peer or via the Voice Proxy Server. All of the Communication and Collaborate servers then wait for voice, data and communication solicitations from the Communicate and Collaborate Clients that are logged into the system. All the Communicate and Collaborate servers communicate to the Remote database via the Transaction Server.

The Communicate and Collaborate application Front End (FIG. 53) (the client side modules), the Back End of the Communicate and Collaborate application (the client side modules) is started at the boot up time of the client PC along with the back ends of all other applications that comprise the EdUti suite of applications. The Front-End modules of the Communicate and Collaborate application, at the beginning establish a handshake with the Back-End modules of the Communicate and Collaborate application.

Once all the Communicate and Collaborate application user interface components are built and a handshake is established with the Communicate and Collaborate Back-End modules, the Communicate and Collaborate Front-End goes into a steady state waiting for any requests from the user. The Communicate and Collaborate application's Front-End may also get a display/update request from the Communicate and Collaborate Back-End.

The Back-End process of the Communicate and Collaborate application, at its startup, first establishes a communication handshake with the Transaction Client/Router process. It then establishes a communication with the Communicate and Collaborate Server subsystems. All applications, through their Back-End modules, communicate via the Transaction Client/Router process. All the objects in the EdUti system have the functionality to describe themselves. Whenever the Transaction Client/Router process gets a message regarding an object, it is able to query the object to determine the target application that can address the object. Based on this information the Transaction Client/Router routes the request, the object/s and the data to the appropriate application. Similarly the Transaction Client/Router process also delivers the status or returning data back to the requester. The Transaction Client Router communicates to the Communicate and Collaborate server subsystems via the Transaction Server.

Finally the Communicate and Collaborate application Back-End waits for a handshake request from the Communicate and Collaborate Front-end and application commands from “Communicate and Collaborate” front end and other subsystems via the Transaction Client/Router. If the Communicate and Collaborate application Back-End receives a request via the Transaction Client/Router to execute a Communicate and Collaborate command from another application, (and at that time if it has not already established a handshake with the Communicate and Collaborate application Front-End), it first starts up the specific front end component of the Communicate and Collaborate application Front-End and then delivers it the command for execution. Following each such request or command, either by Communicate and Collaborate Front-End or by the Transaction Client/Router, it attempts to fulfill such request and then goes back into a wait state for subsequent requests or commands.

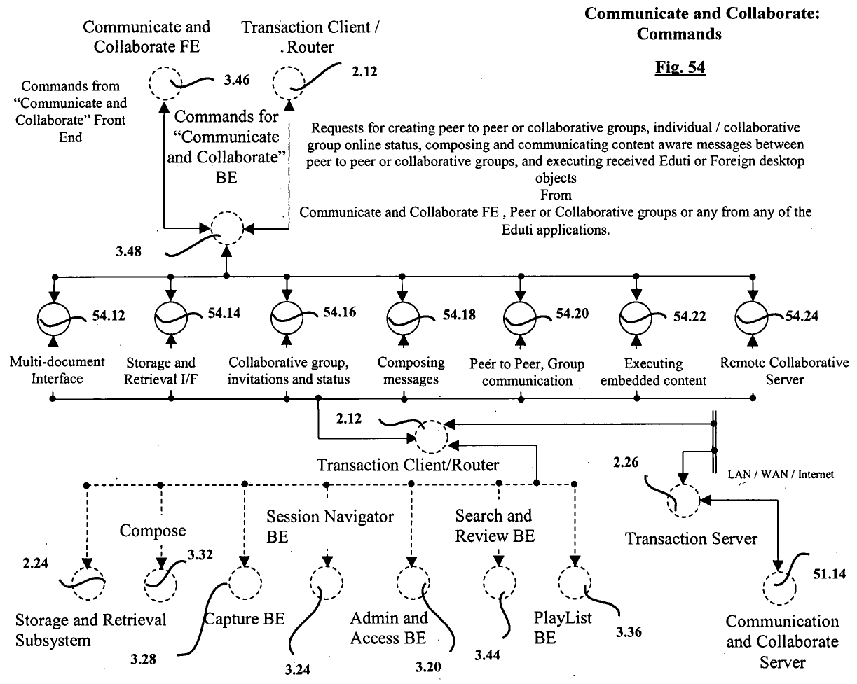

Communicate and Collaborate application Back-End sends all the communications to the Communication and Collaborate Server and the Remote Database Server via the LAN/WAN/Internet, through the Transaction Client/Router and the Transaction Server. The commands delivered by the Communication and Collaborate Application Front-End (FIG. 54), by the Transaction Client/Router for the Communication and Collaborate Application Back-End and the commands executed by the Communication and Collaborate application Back-End are categorized as follows: Multi-document Interface, Storage and Retrieval I/F, Collaborative groups, Invitations and Status, Composing messages, Peer to Peer, Group Messages, Executing Embedded content, and Remote collaborative Server.

All commands including Multi-document Interface, Storage and Retrieval I/F, Collaborative groups, Invitations and Status, Composing messages, Peer to Peer, Group Messages, Executing Embedded content, and Remote collaborative Server are routed through the Transaction Client/Router to the appropriate application backend and/or to the Storage and Retrieval Subsystem. Requests for creating peer to peer or collaborative groups, individual/collaborative group online status, composing and communicating content aware messages between peer to peer or collaborative groups, and executing received EdUti or Foreign desktop objects from Communicate and Collaborate FE, Peer or Collaborative groups or any commands from any of the EdUti applications are also routed via the Transaction Client Router.

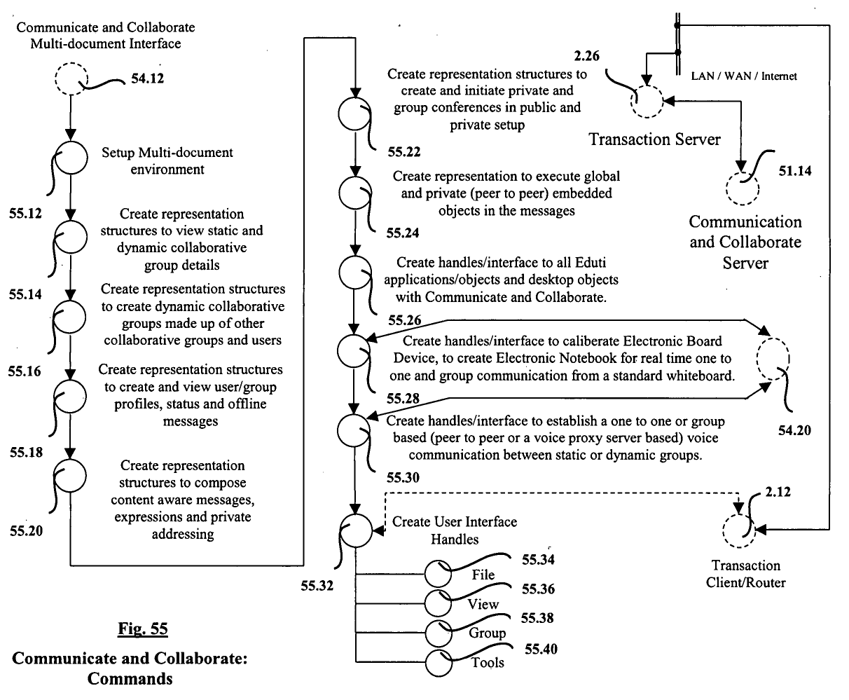

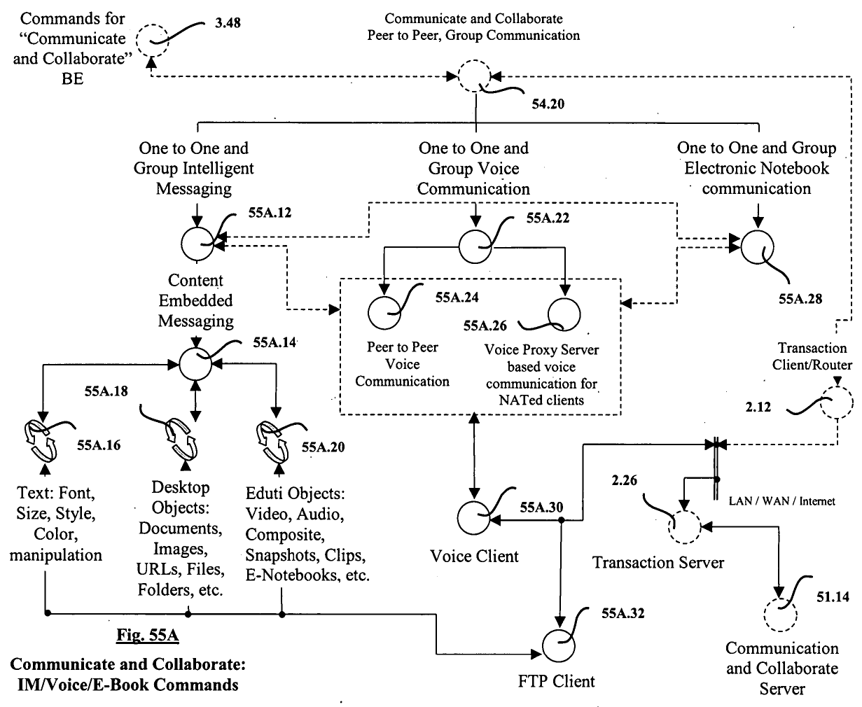

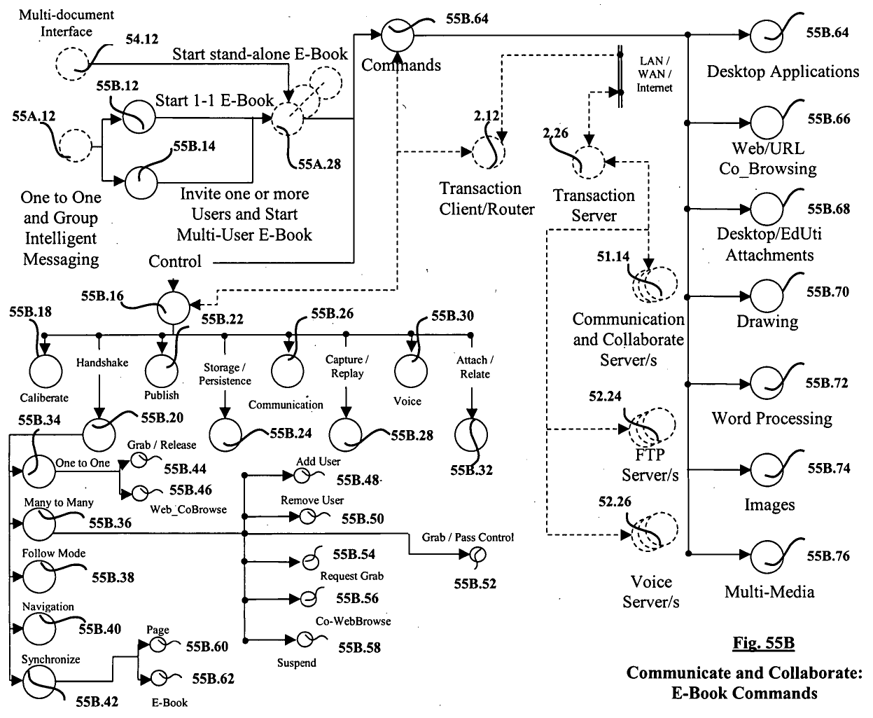

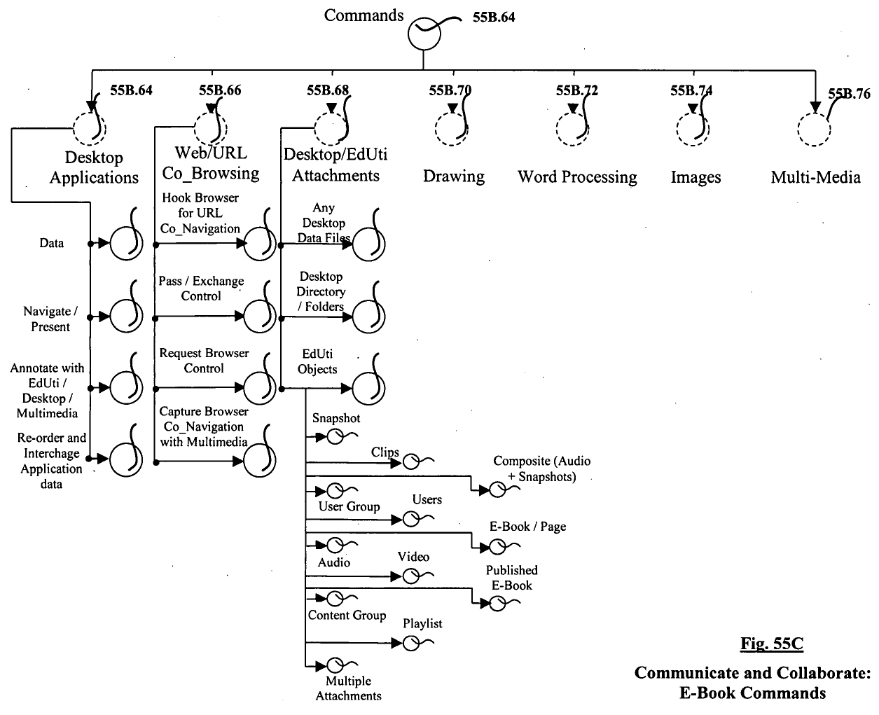

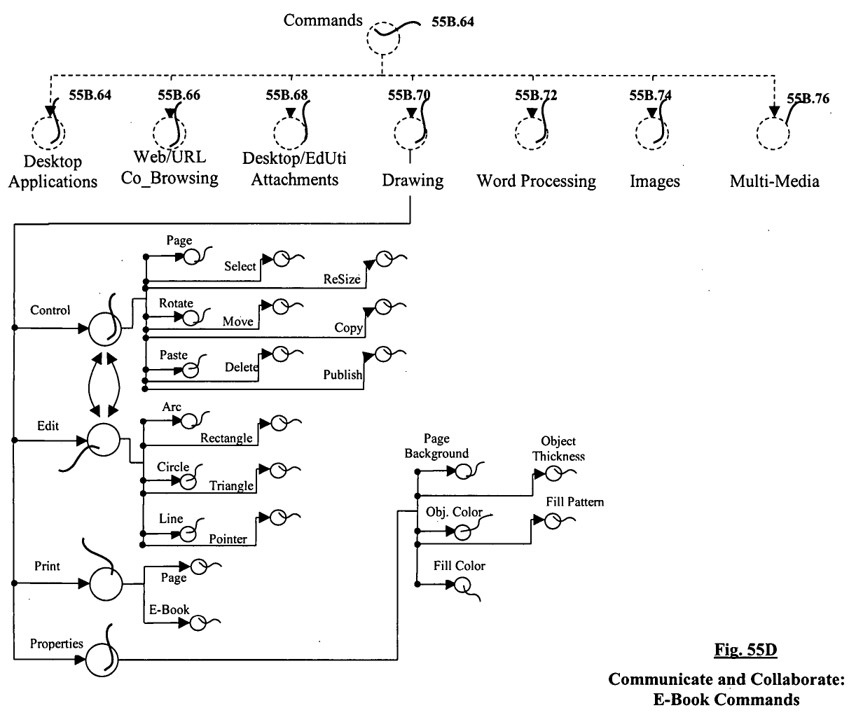

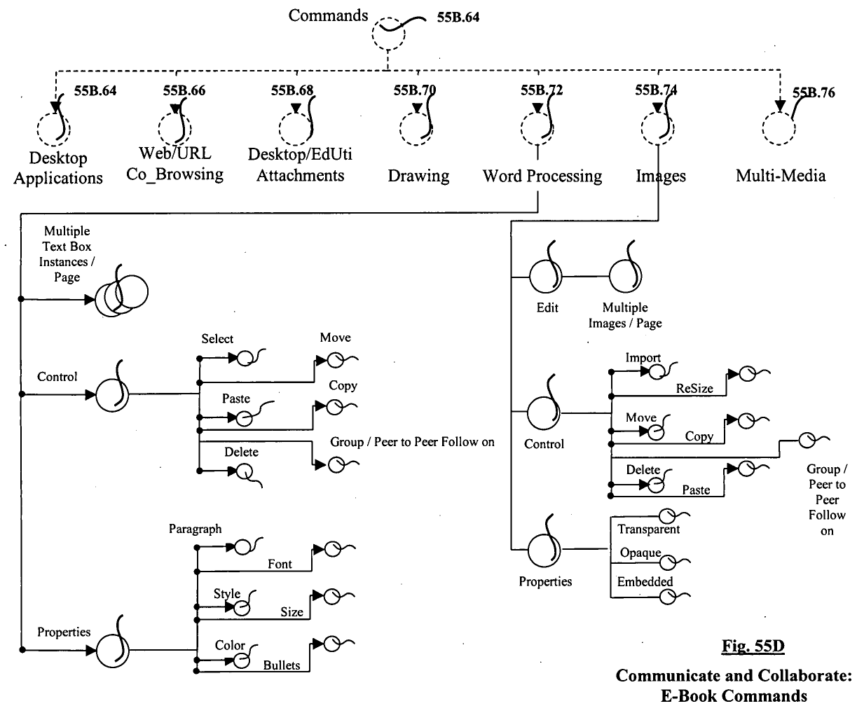

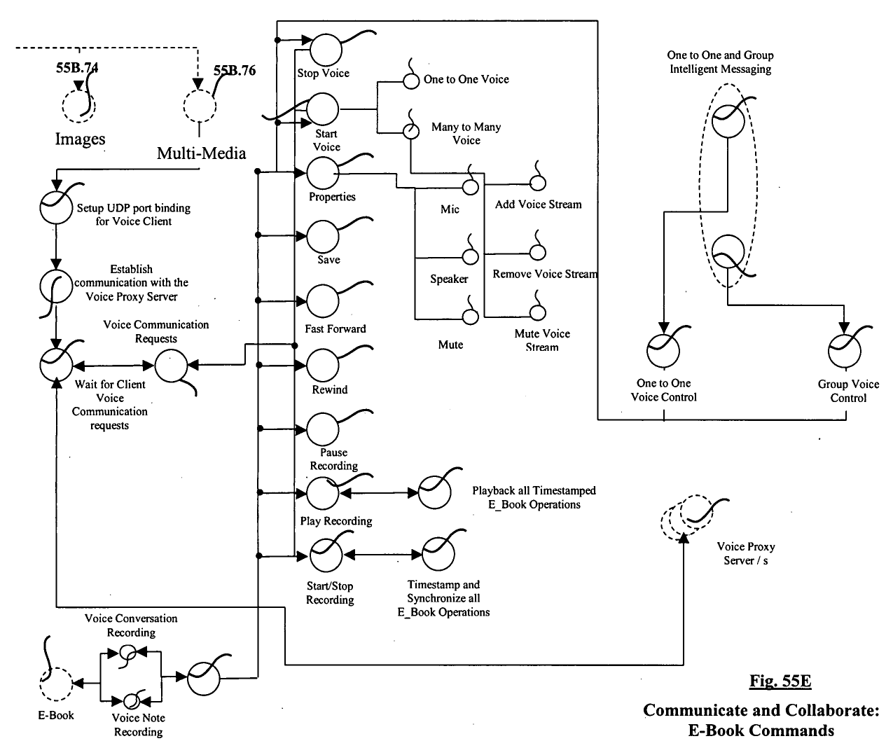

Further the communications to the Communicate and Collaborate Server and the Remote Database Server are accomplished over the LAN/WAN and Internet via the Transaction Server. The Communicate and Collaborate Interface as shown in FIG. 55, sets up the Multi-document environment for Communicate and Collaborate Front-end by creating: representation structures to view and manipulate static and dynamic collaborative groups; representation structures to create and manipulate dynamic groups made up of other groups and users; representative structures to create and view user/group profiles, status and offline messages; representation structures to compose content aware messages, expressions, private addressing and composing real time handwritten, text, geometries, attachments and URL content via an Electronic-Book, representation structures to create and initiate public and group conferencing; representation to execute global and private (peer to peer) embedded objects in the communication message; handles/interfaces to all EdUti applications/objects; handles/interface to calibrate Electronic Board device, and to create Electronic notebook for real time one to one and group communication from a standard room whiteboard; and handles/interface to establish a one to one or group based (peer to peer or a voice proxy server based) communication between static or dynamic groups.

The User Interface Handle communicates to the communicate and Collaborate Server and the Remote Database via the Transaction Client/Router, LAN/WAN and Internet and the Transaction Server. The User Interface Handles sets up user commands for File, view, Group, and Tools operations. The Communicate and Collaborate Interface, as shown in FIG. 55A, sets up the application for Peer to Peer and Group communication. The Peer to Peer and the Group Communication is made up of three major components. One to One and Group Intelligent Messaging; One to One and Group voice Communication; and One to One and Group Electronic Notebook Communication.

In One to One and Group Intelligent messaging, the Communicate and Collaborate application provides the means for a user identify a user or a group that he/she would like to participates in, and start the communication in that context. The user is able to embed any of the EdUti objects (Audio, Vidio, AudioVideo, Audio Fragments, Clips, Desktop attachments, E-Book and any of its content, etc.) within the text during these communications. A data structure is prepared that is able to recognize the text and embedded EdUti object identifiers and this structure is sent via the Transaction Client Router to the Communicate and Collaborate Server. The Communicate and Client Server recognizes the context of the content by looking it up in the Remote database and then delivers the content in real time to the member in the communication group. The data associated with the embedded objects is not sent to the recipients. Each recipient of the message has the ability to fetch the data associated with the embedded object from its owner. The ownership and access rights are always maintained with the object and its respective data, regardless of where the data is.

One to One or Group Voice communication can be either Peer to Peer or Via the Voice Proxy server. In the cases where the Communicate and Communicate Clients are not residing on an IP address that can be seen by other clients, these clients expose themselves to the Voice Proxy server and all the communications to and from the hidden clients are done via the voice Proxy server. It is possible that in a group voice communication environment, a user is communicating to one member as a Peer to Peer and to another via the Voice Proxy Server.

The Voice communication can be initiated and controlled from the Messaging as well as the E-Book components. All the communications except the Voice are done via the Transaction Server. The voice clients and the servers communicate independently of the Transaction Server.

FIG. 55B describes the E-Book operations and its interaction with the other modules in the Communicate and Collaborate application as well as the rest of EdUti applications. The E-Book can be initiated by the Messaging component or as a stand alone application from the EdUti toolbox. The E-Book can also be initiated in a One to One mode or in a Group communication environment.

Following control operations are applicable to the E-Book: Calibrate a infrared device from the E-Book to capture mouse strokes from any flat surface to drive the E-Book application. Establish a handshake in a one to one mode or in a many to many mode for group communication. The control allows for one user in the Communication setup to use and communicate the content of the e-Book at any time. In a one to one scenario the E-Book grab is available for any one of the users to take. Other users can take a grab once it is released by the current user. The contents of the E-Book are available to all the participants in the Communication. In a many to many case the control of the E-Book is based on the moderator. The other participants can request for a “Grab” from the moderator but it is up to the moderator to accept or reject the request. The E-Book can be set up in a Follow mode such that the other participants are locked to view everything that the current E-Book grab holder is doing. An electronic pointer provides all the members in a E-Book communication to point to any location or object in the E-Book for other to see. Finally, any member can request a Synchronize of a page or the entire E-Book at any time.

Session Navigator Application

FIGS. 61 through 67 describe the client server architecture and the functional implementation of the Session Navigator application. These figures also describe the commands and the operational flow of the functionality of the Session Navigator application. The Session Navigator application Front End (FIG. 61) (the client side modules), the Back End of the Session Navigator application (the client side modules) is started at the boot up time of the client PC along with the back ends of all other applications that comprise the EdUti suite of applications.

The Front-End modules of the Session Navigator application, at the beginning establish a handshake with the Back-End modules of the Session Navigator application. Following this process these modules set up the user interface structures to represent Sessions, Session hierarchy and Session level Attachments in Iconic, list as well as Tree view. Subsequently, representation structures are created to register valid user interface objects that can be considered as drag and drop source objects or drag and drop destination objects for the Session Navigator application Front-End module.

Once all the Session Navigator application user interface components are built and a handshake is established with the Session Navigator Back-End modules, the Session Navigator Front-End goes into a steady state waiting for any requests from the user. The Session Navigator application's Front-End may also get a display/update request from the Session Navigator Back-End.

The Back-End process of the Session Navigator application, at its startup, first establishes a communication handshake with the Transaction Client/Router process and gets ready to receive Session Hierarchy fetch, update and refresh requests. All applications, through their Back-End modules, communicate via the Transaction Client/Router process. All the objects in the EdUti system have the functionality to describe themselves. Whenever the Transaction Client/Router process gets a message regarding an object, it is able to query the object to determine the target application that can address the object. Based on this information the Transaction Client/Router routes the request, the object/s and the data to the appropriate application. Similarly the Transaction Client/Router process also delivers the status or returning data back to the requester. Next, the Session Navigator Backend establishes an interface with the Admin and Access Backend via the Admin and Access API to fetch access and control information for filtering the Session display.

Finally the Session Navigator application Back-End waits for a handshake request from the Session Navigator Front-end and application commands from “Session Navigator” front end (FE) and other subsystems via the Transaction Client/Router. If the Session Navigator application Back-End (BE) receives a request via the Transaction Client/Router to execute a Session Navigator command from another application, (and at that time if it has not already established a handshake with the Session Navigator application Front-End), it first starts up the Session Navigator application Front-End and then delivers it the command for execution. Following each such request or command, either by the Session Navigator Front-End or by the Transaction Client/Router, it attempts to fulfill such request and then goes back into a wait state for subsequent requests or commands. Session Navigator application Back-End sends all the communications to the Remote Database Server via the LAN/WAN/Internet, through the Transaction Client/Router and the Transaction Server.

The commands delivered by the Session Navigator Application Front-End (FIG. 62), by the Transaction Client/Router for the Session Navigator Application Back-End and the commands executed by the Session Navigator application Back-End are categorized as follows: Session Navigation Interface, Storage and Retrieval I/F, Session Hierarchy display and Navigation, Session movement and publishing, Session Attachments, Executing Sessions and Attachments, and Share Control.

All commands including Session Navigation Interface, Storage and Retrieval I/F, Session Hierarchy display and Navigation, Session movement and publishing, Session Attachments, Executing Sessions and Attachments, and Share Control are routed through the Transaction Client/Router to the appropriate application backend and/or to the Storage and Retrieval Subsystem. Further the communications to the Remote Database Server are accomplished over the LAN/WAN and Internet via the Transaction Server. The Session Navigator also exports an API to applications such as Compose, Capture and E-Book to allow them to save the Objects, Sessions, and the E-Books in specific Session hierarchy.

The Session Navigator Backend receives requests for creating and displaying Sessions, Session Hierarchy, attachments to the Sessions, applying share as well as access control and executing the Sessions and other attachments from Session Navigator Front-end, Applications using the Session Navigator API, the database triggers and the Backbends of all the EdUti applications.

The Session Navigator Interface as shown in FIG. 63, sets up the Multi-document environment for Session Navigator Front-end by creating: representation structures to Display Session hierarchy in local, remote and published databases, representation structures to display Session hierarchy in tree, small and big Iconic views, representative structures to view attachment lists for each of the Sessions in the Session hierarchy, and representation for the Session Navigator API for session navigation and selection by applications that need to establish a session context and creating Session Navigator User Interface Handles. The User Interface Handle communicates to the Remote Database via the Transaction Client/Router, LAN/WAN and Internet and the Transaction Server. The User Interface Handles sets up user commands for Session, Edit, View, Tools and Go operations.

FIG. 64 describes the details of the User Interface Handles for Session, View, Tools and Go operations. The Session User Interface Handles include New, Open, Close, Set Session Context and Set Database Context. These commands allow the user to perform operations on the Session object. The Set Database Context handle includes Local DB, Remote. DB and Published DB.

The Edit Handles include Cut, Copy, Paste, Delete, Rename, Share and Add Comments. The Edit commands enable the user to create the sessions in horizontal as well as vertical hierarchy, and setup the access and privileges for the users and the groups. The View User Handles include Tool bar, Status bar, Large Icon, Small Icon, List and Detail. The View commands enable the user to customize the display of the Sessions in the Session Navigator. The Tools User Handle includes Execute, Search and Review, PlayList and Attach and Relate. These commands give the user access to execute or switch to other applications mentioned above. The Go User Handles include Back, Forward and Level up. These commands enable the user to traverse the Session Hierarchy.

FIG. 65 shows the relationships between the Session Navigator User Interface Handles and the Session Navigator command categories in a matrix form. It describes which operations (User Interface Handles) are permitted on different Session Navigator command categories. The Session operations can be performed on Session, Session Hierarchy and Distributed Databases. The Edit operations can be performed on Session, Session Hierarchy, Attachments, Distributed Databases, Share Access and Annotations. The View operations can be performed on Session, Session Hierarchy and Share Access. The Tools operation can be performed on Session, Attachments, Annotations and Application. The Go operations can be performed on Session Hierarchy, Distributed Databases and Share Access.

FIG. 66 maps the Session Navigator User Interface Handles and Session Navigator Command categories. It describes which operations such as Session, Edit, View, Tools and Go are applicable to various structures or Command categories like Session Navigation I/F, Storage and Retrieval I/F, Session Hierarchy display and Navigation, Session movement and publishing, Session attachments, Executing Sessions and Attachments and Share Control. These command categories are labeled A through G and they are received from the Session Navigator Backend. The Session operations can be performed on A, B and C. The Edit operations can be performed on B, C, D and E. The View operations can be performed on C, D, E and G. The Tools operations can be performed on F and G. The Go operations can be performed on C and G.

Upon reading this disclosure, those of skill in the art will appreciate still additional alternative structural and functional designs for a system and a process for a learning system based on a metadata framework and indexed, distributed and fragmented content through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

1. A method for collaborative learning, the method comprising:
receiving a plurality of content captured from a plurality of sources;
breaking the each captured content into a plurality of content parts;
generating a composed content, the generating step including
selecting of at least one of a plurality of content parts and a plurality of meta-data, and
defining a relationship between the selected composed content;
storing the transmitted composed content in storage;
recalling the composed content from the storage;
generating revised composed content, the generating step including
editing the composed content, and
defining a relationship between the edited composed content and the selected composed content; and
storing the revised composed content in the storage.

2. The method of claim 1, wherein the meta-data comprises text.

3. The method of claim 1, wherein the step of editing further comprised adding one of a content part of the plurality of content parts and a meta-data from the plurality of meta-data.

4. The method of claim 1, further comprising executing instructions within the revised composed content in response to retreiving the revised composed content from the storage.

5. A system for collaborative learning, the system comprising:
a transaction router configured to receive requests to attach and relate applications in a content file;
a back-end module configured to process for the content file requests for creation of instances, creation of keywords and relationships between object from a plurality of objects, and execution of instances based on personality in response to the transaction router; and

6. The system of claim 5, further comprising a front-end module configured to establish a connection with the back-end module and configured to allow selection of objects from the plurality of objects for inclusion in the content file.
